(19) United States
(12) Patent Application Publication
(10) Pub. No.: US 2004/0148232 A1
(43) Pub. Date: Jul. 29, 2004

(54) Electronic catalog aggregation apparatus for realizing fast and efficient electronic catalog system

(76) Inventors: Osamu Fushimi, Tokyo (JP); Ryoichi Kasuga, Tokyo (JP); Susumu Kakuta, Tokyo (JP)

Correspondence Address: KILPATRICK STOCKTON LLP, JOHN S. PRATT, 1100 PEACHTREE STREET, ATLANTA, GA, 30309, US

(21) Appl. No.: 09/766,775

(22) Filed: Jan. 22, 2001

(51) Int. Cl. G06F 17/60

(52) U.S. Cl. 705/27

(57) ABSTRACT

An electronic catalog aggregation apparatus is provided between catalog provider devices and catalog user devices in an electronic catalog system, where the electronic catalog aggregation apparatus processes electronic catalog data received from registered catalog providers through networks into a prescribed common format and stores them in an electronic catalog database, extracts at least one of the electronic catalog data corresponding to a catalog request received from each registered catalog user, from the electronic catalog database, converts each extracted electronic catalog data into an electronic catalog in a format specified by the catalog request, and delivers the extracted and converted electronic catalogs to respective registered catalog users through networks.

### BACKGROUND OF THE INVENTION

1. Field of the Invention

The present invention relates to an electronic catalog aggregation apparatus for receiving catalog information regarding products from a plurality of catalog providers through networks, aggregating a plurality of received catalog information, and delivering an aggregated catalog information to a plurality of catalog users through networks.

2. Description of the Background Art

Conventionally, when there are a plurality of catalog providers and a plurality of catalog users as shown in FIG. 1, each catalog provider needs to carry out a catalog extraction operation for extracting a catalog of products requested by a catalog user, an editing operation for editing a catalog into a format requested by a catalog user, and a delivery operation in a scheme requested by a catalog user, with respect to each catalog user separately, while each catalog user needs to carry out a catalog receiving operation and an accounting operation to account a catalog in a system of the catalog user, with respect to each catalog provider separately. As a result, there has been a problem that these required operations are quite tedious.

Also, when there are a plurality of scattered sources for a catalog information requested by a catalog user for some product as shown in FIG. 2, the catalog provider needs to collect the catalog information from the plurality of scattered sources and merge them. Namely, as shown in FIG. 2, there can be cases where a catalog provider owns a product description information and a sales price information for a product A, but an image information of this product A is owned by a contents owner. In such a case, when the catalog provider wishes to provide the catalog information of this product A to the catalog user, the catalog provider needs to collect the image information of the product A owned by the contents owner from the contents owner and merge it with the product description information and the sales price information of the product A owned by the catalog provider. As a result, there has been a problem that this required operation is also quite tedious.

Note here that, in the case where the catalog is produced for the purpose of sales in an EC (Electronic Commerce) system, the catalog provider can be a wholesale dealer who owns information on sales price and brief product description of the product, the contents owner can be a maker (manufacturer) who owns information on product image, CM video, etc. of the product, and the catalog user can be a retail dealer who utilizes the electronic catalog in the EC system. Also, in the case where the catalog is produced for the purpose of promoting sales, the catalog provider can be a sales support department which owns information on advertisement, price, etc. of the product, the contents owner can be a design department which owns information on a design plan, three side views, detailed specification, etc. of the product, and the catalog user can be a sales department which utilizes the electronic catalog for sales promotion papers or CD-ROMs.

On the other hand, in the EC system, a product purchaser, that is a buyer, generally wishes to purchase a product from a trustworthy product provider, that is a supplier, by judging whether a supplier of the product to be purchased is a trustworthy company or not before actually purchasing the product, and for this purpose there is a need to acquire the company credit information of the supplier. However, conventionally, in order to acquire this company credit information of the supplier, the buyer himself needs to extract information on the supplier in the course of purchasing the product and directly access a credit standing investigation company or the like using the extracted supplier information separately. As a result, there has been a problem that this company credit information acquisition processing is quite tedious and time-consuming so that it is inefficient.

### SUMMARY OF THE INVENTION

It is therefore an object of the present invention to provide an electronic catalog aggregation apparatus capable of eliminating the catalog extraction, editing and delivery operations required for the catalog provider with respect to each catalog user and the catalog receiving and accounting operations required for the catalog user with respect to each catalog provider, so as to realize a fast and efficient electronic catalog system.

It is another object of the present invention to provide an electronic catalog aggregation apparatus capable of providing credit information of trade participants including a product provider and a product purchaser in relation to the catalog information such that a creditability of each trade participant can be judged efficiently and quickly, so as to realize a safe electronic commerce system.

According to one aspect of the present invention there is provided an electronic catalog aggregation apparatus provided between catalog provider devices and catalog user devices in an electronic catalog system, the apparatus comprising: a processing unit configured to process electronic catalog data received from registered catalog providers through networks into a prescribed common format; an electronic catalog database configured to store the electronic catalog data as processed by the processing unit; an extraction and conversion unit configured to extract at least one of the electronic catalog data corresponding to a catalog request received from each registered catalog user, from the electronic catalog database, and convert each extracted electronic catalog data into an electronic catalog in a format specified by the catalog request; and a delivery unit configured to deliver electronic catalogs as extracted and converted by the extraction and conversion unit to respective registered catalog users through networks.

According to another aspect of the present invention there is provided a method of electronic catalog aggregation between catalog provider devices and catalog user devices in an electronic catalog system, the method comprising the steps of: processing electronic catalog data received from registered catalog providers through networks into a prescribed common format; storing the electronic catalog data as processed by the processing step in an electronic catalog database; extracting at least one of the electronic catalog data corresponding to a catalog request received from each registered catalog user, from the electronic catalog database, and converting each extracted electronic catalog data into an electronic catalog in a format specified by the catalog request; and delivering electronic catalogs as extracted and converted by the extracting step to respective registered catalog users through networks.

According to another aspect of the present invention there is provided a computer usable medium having computer readable program codes embodied therein for causing a computer to function as an electronic catalog aggregation apparatus provided between catalog provider devices and catalog user devices in an electronic catalog system, the computer readable program codes include: a first computer readable program code for causing said computer to process electronic catalog data received from registered catalog providers through networks into a prescribed common format; a second computer readable program code for causing said computer to store the electronic catalog data as processed by the first computer readable program code in an electronic catalog database; a third computer readable program code for causing said computer to extract at least one of the electronic catalog data corresponding to a catalog request received from each registered catalog user, from the electronic catalog database, and convert each extracted electronic catalog data into an electronic catalog in a format specified by the catalog request; and a fourth computer readable program code for causing said computer to deliver electronic catalogs as extracted and converted by the third computer readable program code to respective registered catalog users through networks.

According to another aspect of the present invention there is provided a catalog user device in an electronic catalog system, the device comprising: a catalog unit configured to store electronic catalogs with company codes of product providers attached thereto, and provide an electronic catalog to a product purchaser in response to a catalog viewing request from the product purchaser; and a company credit information providing unit configured to enable the product purchaser to view a company credit information of a product provider corresponding to a company code attached to the electronic catalog of a product selected by the product purchaser by viewing the electronic catalog.

According to another aspect of the present invention there is provided a catalog user device in an electronic catalog system, the device comprising: a catalog unit configured to store electronic catalogs with company codes of product providers attached thereto, and provide an electronic catalog to a product purchaser in response to a catalog viewing request from the product purchaser; and a product search unit configured to carry out a search of a product matching with a search condition indicating a company credit information of a desired product provider as specified by the product purchaser in order to select a product by viewing the electronic catalog, according to a company credit information of a product provider corresponding to a company code attached to the electronic catalog.

According to another aspect of the present invention there is provided a catalog user device in an electronic catalog system, the device comprising: a catalog unit configured to store electronic catalogs with company codes of product providers attached thereto, and provide an electronic catalog to a product purchaser in response to a catalog viewing request from the product purchaser; a product purchaser condition registration unit configured to register a condition on credit information of a desired product purchaser as specified by a product provider in order to limit product purchasers who are permitted to view the electronic catalog provided by the product provider; and a catalog viewing permission unit configured to permit viewing of the electronic catalog of the product provider by the product purchaser in response to a catalog viewing request from the product purchaser only when credit information of the product purchaser satisfies the condition on credit information of a desired product purchaser registered by the product purchaser condition registration unit.

According to another aspect of the present invention there is provided a method for operating a catalog user device in an electronic catalog system, the method comprising the steps of: storing electronic catalogs with company codes of product providers attached thereto, and providing an electronic catalog to a product purchaser in response to a catalog viewing request from the product purchaser; and enabling the product purchaser to view a company credit information of a product provider corresponding to a company code attached to the electronic catalog of a product selected by the product purchaser by viewing the electronic catalog.

According to another aspect of the present invention there is provided a method for operating a catalog user device in an electronic catalog system, the method comprising the steps of: storing electronic catalogs with company codes of product providers attached thereto, and providing an electronic catalog to a product purchaser in response to a catalog viewing request from the product purchaser; and carrying out a search of a product matching with a search condition indicating a company credit information of a desired product provider as specified by the product purchaser in order to select a product by viewing the electronic catalog, according to a company credit information of a product provider corresponding to a company code attached to the electronic catalog.

According to another aspect of the present invention there is provided a method for operating a catalog user device in an electronic catalog system, the method comprising the steps of: storing electronic catalogs with company codes of product providers attached thereto, and providing an electronic catalog to a product purchaser in response to a catalog viewing request from the product purchaser; registering a condition on credit information of a desired product purchaser as specified by a product provider in order to limit product purchasers who are permitted to view the electronic catalog provided by the product provider; and permitting viewing of the electronic catalog of the product provider by the product purchaser in response to a catalog viewing request from the product purchaser only when credit information of the product purchaser satisfies the condition on credit information of a desired product purchaser registered by the registering step.

According to another aspect of the present invention there is provided a computer usable medium having computer readable program codes embodied therein for causing a computer to function as a catalog user device in an electronic catalog system, the computer readable program codes include: a first computer readable program code for causing said computer to store electronic catalogs with company codes of product providers attached thereto, and provide an electronic catalog to a product purchaser in response to a catalog viewing request from the product purchaser; and a second computer readable program code for causing said computer to enable the product purchaser to view a company credit information of a product provider corresponding to a company code attached to the electronic catalog of a product selected by the product purchaser by viewing the electronic catalog.

According to another aspect of the present invention there is provided a computer usable medium having computer readable program codes embodied therein for causing a computer to function as a catalog user device in an electronic catalog system, the computer readable program codes include: a first computer readable program code for causing said computer to store electronic catalogs with company codes of product providers attached thereto, and provide an electronic catalog to a product purchaser in response to a catalog viewing request from the product purchaser; and a second computer readable program code for causing said computer to carry out a search of a product matching with a search condition indicating a company credit information of a desired product provider as specified by the product purchaser in order to select a product by viewing the electronic catalog, according to a company credit information of a product provider corresponding to a company code attached to the electronic catalog.

According to another aspect of the present invention there is provided a computer usable medium having computer readable program codes embodied therein for causing a computer to function as a catalog user device in an electronic catalog system, the computer readable program codes include: a first computer readable program code for causing said computer to store electronic catalogs with company codes of product providers attached thereto, and provide an electronic catalog to a product purchaser in response to a catalog viewing request from the product purchaser; a second computer readable program code for causing said computer to register a condition on credit information of a desired product purchaser as specified by a product provider in order to limit product purchasers who are permitted to view the electronic catalog provided by the product provider; and a third computer readable program code for causing said computer to permit viewing of the electronic catalog of the product provider by the product purchaser in response to a catalog viewing request from the product purchaser only when credit information of the product purchaser satisfies the condition on credit information of a desired product purchaser registered by the second computer readable program code.

Other features and advantages of the present invention will become apparent from the following description taken in conjunction with the accompanying drawings.

### BRIEF DESCRIPTION OF THE DRAWINGS

FIG. 1 is a schematic diagram showing a conventional electronic catalog system formed by catalog providers and catalog users.

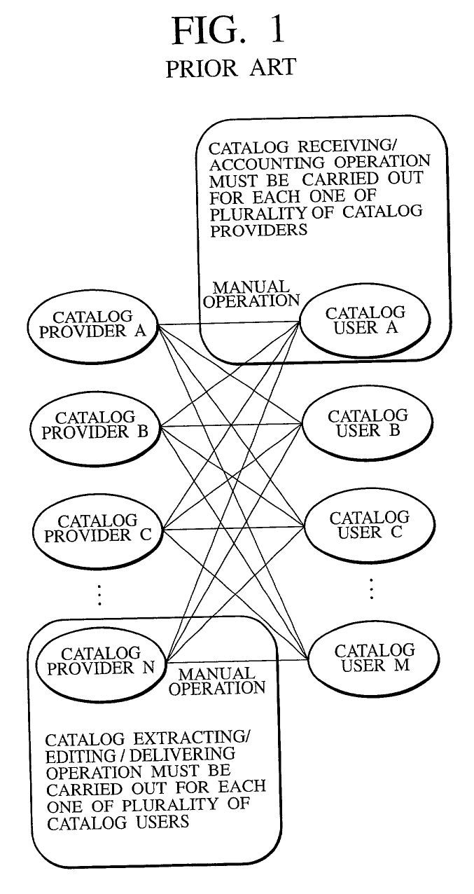

FIG. 2 is a schematic diagram for explaining a processing required for a catalog provider in a conventional electronic catalog system.

FIG. 3 is a block diagram showing a configuration of an electronic catalog system using an electronic catalog aggregation apparatus according to the first embodiment of the present invention.

FIG. 4 is a sequence chart of an overall processing in the electronic catalog system of FIG. 3.

FIG. 5 is a sequence chart for a registration processing at a time of admission of a catalog provider in the electronic catalog system of FIG. 3.

FIG. 6 is a sequence chart of a registration processing at a time of admission of a catalog user in the electronic catalog system of FIG. 3.

FIG. 7 is a flow chart of an admission processing at a time of admission of a catalog provider or a catalog user in the electronic catalog system of FIG. 3.

FIG. 8 is a sequence chart of a processing for collecting catalog information from a catalog provider, processing catalog information at a catalog aggregator and providing catalog information to a catalog user in the electronic catalog system of FIG. 3.

FIG. 9 is a sequence chart of a processing for acquiring missing catalog data of catalog data provided by a catalog provider from a contents provider in the electronic catalog system of FIG. 3.

FIG. 10 is a schematic diagram for explaining a processing for acquiring missing catalog data of catalog data provided by a catalog provider from a contents provider in the electronic catalog system of FIG. 3.

FIG. 11 is a sequence chart of a product list registration or updating in the electronic catalog system of FIG. 3.

FIG. 12 is a sequence chart of a processing in which a catalog user selects a catalog provider/product in the electronic catalog system of FIG. 3.

FIG. 13 is a sequence chart of a processing by a catalog aggregator in a course of the processing shown in FIG. 12.

FIG. 14 is a schematic diagram showing a configuration of an electronic catalog system using an electronic catalog aggregation apparatus according to the second embodiment of the present invention.

FIG. 15 is a sequence chart of an overall processing in the electronic catalog system of FIG. 14.

FIG. 16 is a block diagram showing a detailed configuration of each device the electronic catalog system of FIG. 14.

FIG. 17 is a schematic diagram showing a configuration of an electronic catalog system using an electronic catalog aggregation apparatus according to the third embodiment of the present invention.

FIG. 18 is a sequence chart of an overall processing in the electronic catalog system of FIG. 17.

FIG. 19 is a schematic diagram showing a configuration of an electronic catalog system using an electronic catalog aggregation apparatus according to the fourth embodiment of the present invention.

FIG. 20 is a sequence chart of an overall processing in the electronic catalog system of FIG. 19.

FIG. 21 is a block diagram showing a detailed configuration of each device in the electronic catalog system of FIG. 19.

FIG. 22 is a schematic diagram showing a configuration of an electronic catalog system using an electronic catalog aggregation apparatus according to the fifth embodiment of the present invention.

FIG. 23 is a sequence chart of an overall processing in the electronic catalog system of FIG. 22.

FIG. 24 is a schematic diagram showing a configuration of an electronic catalog system using an electronic catalog aggregation apparatus according to the sixth embodiment of the present invention.

FIG. 25 is a sequence chart of an overall processing in the electronic catalog system of FIG. 24.

FIG. 26 is a block diagram showing a detailed configuration of each device in the electronic catalog system of FIG. 24.

FIG. 27 is a schematic diagram showing a configuration of an electronic catalog system using an electronic catalog aggregation apparatus according to the seventh embodiment of the present invention.

FIG. 28 is a sequence chart of an overall processing in the electronic catalog system of FIG. 27.

FIG. 29 is a schematic diagram showing a configuration of an electronic catalog system using an electronic catalog aggregation apparatus according to the eighth embodiment of the present invention.

FIG. 30 is a sequence chart of an overall processing in the electronic catalog system of FIG. 29.

FIG. 31 is a block diagram showing a detailed configuration of each device in the electronic catalog system of FIG. 29.

FIG. 32 is a schematic diagram showing a configuration of an electronic catalog system using an electronic catalog aggregation apparatus according to the ninth embodiment of the present invention.

FIG. 33 is a sequence chart of an overall processing in the electronic catalog system of FIG. 32.

FIG. 34 is a block diagram showing a detailed configuration of each device in the electronic catalog system of FIG. 32.

FIG. 35 is a schematic diagram showing a configuration of an electronic catalog system using an electronic catalog aggregation apparatus according to the tenth embodiment of the present invention.

FIG. 36 is a sequence chart of an overall processing in the electronic catalog system of FIG. 35.

FIG. 37 is a block diagram showing a detailed configuration of each device in the electronic catalog system of FIG. 35.

FIG. 38 is a schematic diagram showing a configuration of an electronic catalog system using an electronic catalog aggregation apparatus according to the eleventh embodiment of the present invention.

FIG. 39 is a sequence chart of an overall processing in the electronic catalog system of FIG. 38.

FIG. 40 is a schematic diagram showing a configuration of an electronic catalog system using an electronic catalog aggregation apparatus according to the twelfth embodiment of the present invention.

FIG. 41 is a sequence chart of an overall processing in the electronic catalog system of FIG. 40.

FIG. 42 is a block diagram showing a detailed configuration of each device in the electronic catalog system of FIG. 40.

FIG. 43 is a schematic diagram showing a configuration of an electronic catalog system using an electronic catalog aggregation apparatus according to the thirteenth embodiment of the present invention.

FIG. 44 is a sequence chart of an overall processing in the electronic catalog system of FIG. 43.

FIG. 45 is a schematic diagram showing a configuration of an electronic catalog system using an electronic catalog aggregation apparatus according to the fourteenth embodiment of the present invention.

FIG. 46 is a sequence chart of an overall processing in the electronic catalog system of FIG. 45.

FIG. 47 is a block diagram showing a detailed configuration of each device in the electronic catalog system of FIG. 45.

FIG. 48 is a schematic diagram showing a configuration of an electronic catalog system using an electronic catalog aggregation apparatus according to the fifteenth embodiment of the present invention.

FIG. 49 is a sequence chart of an overall processing in the electronic catalog system of FIG. 48.

FIG. 50 is a block diagram showing a detailed configuration of each device in the electronic catalog system of FIG. 48.

FIG. 51 is a schematic diagram showing a configuration of an electronic catalog system using an electronic catalog aggregation apparatus according to the sixteenth embodiment of the present invention.

FIG. 52 is a sequence chart of an overall processing in the electronic catalog system of FIG. 51.

FIG. 53 is a block diagram showing a detailed configuration of each device in the electronic catalog system of FIG. 51.

### DETAILED DESCRIPTION OF THE PREFERRED EMBODIMENTS

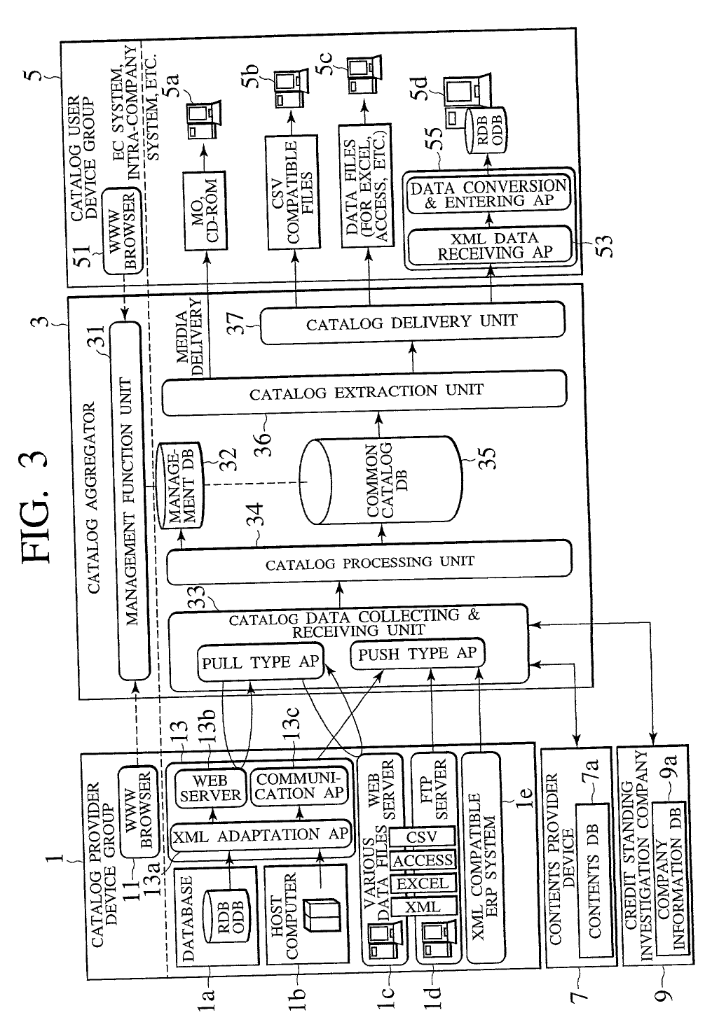

Referring now to FIG. 3 to FIG. 13, the first embodiment of an electronic catalog aggregation apparatus according to the present invention will be described in detail.

FIG. 3 shows a configuration of an electronic catalog system using an electronic catalog aggregation apparatus according to this embodiment. This electronic catalog system generally comprises a catalog provider device group 1 containing a plurality of catalog provider devices 1a, 1b, 1c, 1d and le, a catalog user device group 5 containing a plurality of catalog user devices 5a, 5b, 5c and 5d, a catalog aggregator 3 connected between the catalog provider device group 1 and the catalog user device group 5 through networks including the Internet, and a contents provider device 7 and a credit standing investigation company 9 connected with the catalog aggregator 3 through networks including the Internet.

In this electronic catalog system of FIG. 3, the catalog aggregator 3 receives the catalog information from a plurality of catalog provider devices through networks, aggregates a plurality of received catalog information, and delivers the aggregated catalog information to a plurality of catalog user devices through networks. Each catalog provider device has its own catalog information and provides its own catalog information to the catalog aggregator 3. The catalog aggregator aggregates a plurality of the catalog information. Each catalog user device receives the catalog information from the catalog aggregator 3 and utilizes the received catalog information.

The contents provider device 7 has contents information for the catalog information such as image information that is missing at the catalog provider device group 1, and is a device of a maker (manufacturer) or a design department, for example. The contents provider device 7 has a contents database (DB) 7a for storing the contents information.

The credit standing investigation device 9 has credit information of companies to which the catalog provider devices 1a, 1b, 1c, 1d and 1e and the catalog user devices 5a, 5b, 5c and 5d belong. The credit standing investigation company 9 has a company information database (DB) 9a for storing various company information such as reputation, financial information, clients, affiliated circles, etc. of each company.

Note that a plurality of catalog provider devices 1a, 1b, 1c, 1d and le will be collectively referred to as the catalog provider device group 1 in the case of addressing a representative catalog provider device, and a plurality of catalog user devices 5a, 5b, 5c and 5d will be collectively referred to as the catalog user device group 5 in the case of addressing a representative catalog user device.

The catalog provider devices having the catalog information can be provided in a variety of forms such as those equipped with computers and those having files only, so that the catalog provider device group 1 is shown in FIG. 3 as containing the plurality of catalog provider devices 1a, 1b, 1c, 1d and 1e. Namely, in the catalog provider device group 1 shown in FIG. 3, the catalog provider device 1a has databases (RDB, ODB), and the catalog provider device 1b has a host computer. Also, the catalog provider devices 1c and 1d have computer systems for adapting various data files constituting the catalog information to XML and converting the catalog information produced by using Excel or Access into the CSV format, where the catalog provider device 1c provides the catalog information to the catalog aggregator 3 by using a Web server while the catalog provider device 1d provides the catalog information to the catalog aggregator 3 by using an FTP server. Also, the catalog provider device 1e is formed by an XML compatible ERP system.

The catalog aggregator 3 receives the catalog information provided by the catalog provider devices in such a variety of forms, and the catalog provider device group 1 is provided with a unit 13 including an XML adaptation AP 13a, a Web server 13b and a communication AP 13c for adapting the catalog information from the catalog provider devices 1a and 1b to XML and transmitting them to the catalog aggregator 3.

The catalog aggregator 3 has a catalog data collecting and receiving unit 33 with built-in PULL type AP and PUSH type AP for receiving the catalog information from each catalog provider device. When the catalog data from each catalog provider device is collected using this catalog data collecting and receiving unit 33, the catalog aggregator 3 converts the collected catalog information into a prescribed common format and processes them into the electronic catalog of a prescribed style by applying normalization and the like at a catalog processing unit 34, and stores the processed electronic catalog into a common catalog database (DB) 35.

After a plurality of electronic catalogs collected from the catalog provider device group 1 and processed by the catalog processing unit 34 are stored in the common catalog database 35 of the catalog aggregator 3, when an electronic catalog request is made by the catalog user device group 5 with respect to the catalog aggregator 3, a catalog extraction unit 36 of the catalog aggregator 3 searches out and extracts the electronic catalog that matches with this electronic catalog request from the common catalog database 35, and converts this extracted electronic catalog into a desired format of the catalog user device group 5, and a catalog delivery unit 37 of the catalog aggregator 3 delivers the converted electronic catalog to the catalog user device group 1.

Note that the plurality of catalog user devices 5a, 5b, 5c and 5d contained in the catalog user device group 5 receive the electronic catalogs in different forms from the catalog aggregator 3, such that the catalog user device 5a receives the electronic catalog in a form of MO or CD-ROM directly from the catalog extraction unit 36 without utilizing the catalog delivery unit 37 of the catalog aggregator 3, the catalog user device 5b receives the electronic catalog in a form of CSV compatible files, the catalog user device 5c receives the electronic catalog in a form of data files for Excel or Access, and the catalog user device 5d is formed by an ERP system or the like which receives the electronic catalog by receiving the XML adapted electronic catalog data from the catalog delivery unit 37 of the catalog aggregator 37 at an XML data receiving AP 53 and then converting them at a data conversion and entering AP 55.

In addition, the catalog aggregator 3 has a management function unit 31 for realizing a management function such as a system management, a management of admission/withdrawal of the catalog providers and the catalog users, and a catalog checking. This management function unit 31 receives respective company information, i.e. catalog provider information and catalog user information, from WWW browsers 11 and 51 of the catalog provider device group 1 and the catalog user device group 5, carries out the admission examination of each catalog provider and each catalog user according to the received company information, and stores and manages that information.

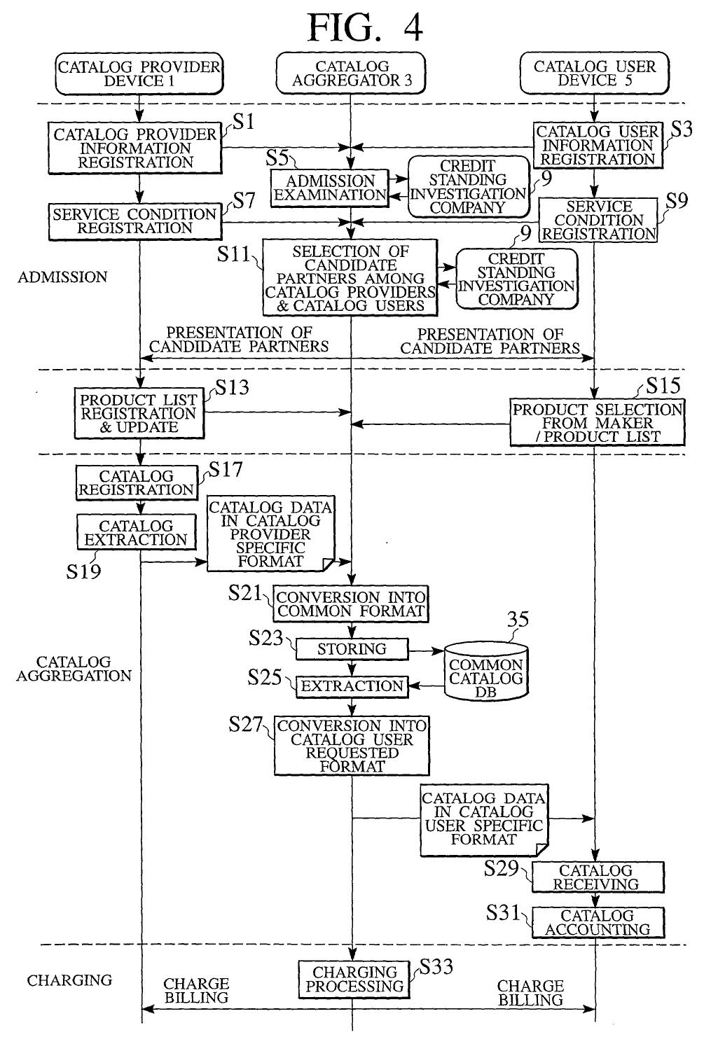

In this electronic catalog system of FIG. 3, the overall processing as shown in FIG. 4 is carried out to realize the registration of the catalog providers and the catalog users, the admission examination, and the extraction, collection, editing processing, storing, delivery and accounting of the catalog information, automatically under the centralized management.

More specifically, as shown in FIG. 4, the catalog aggregator 3 carries out the registration of a basic information such as a company name of each catalog provider given from the catalog provider device group 1 (step S1), and the registration of a basic information such as a company name of each catalog user given from the catalog user device group 5 (step S3), and stores these information in a management database (DB) 32. Also, the catalog aggregator 3 carries out the admission examination of each catalog provider and each catalog user according to each registered information, by referring to credit information of each catalog provider and each catalog user obtained from the credit standing investigation company 9 (step S5).

Then, the catalog aggregator 3 carries out the presentation of information and the registration of service condition information with respect to the catalog providers and the catalog users who passed the admission examination (steps S7 and S9). With respect to each catalog provider, this service condition registration involves the registration of a catalog presentation method such as a presentation form (files, papers, etc.), a type (XML, CSV, etc.), item names in provided data, a format such as arrangement order, a processing level such as use or non-use of rationalization and categorizaton, a selection of pull/push protocol, and an update frequency, and the registration of a payment method such as a service line. Also, with respect to each catalog user, this service condition registration involves the registration of a catalog utilization method such as a presentation form (files, papers, etc.), type (XML, CSV, etc.), item names of requested data, a format such as arrangement order, an extraction level such as image compression level, a selection of pull/push protocol, and an update frequency, and the registration of a payment method such as a service line.

The completion of the service condition registration completes the admission processing, and the catalog aggregator 3 next carries out a selection of candidate partners among the catalog providers and the catalog users according to information from the credit standing investigation company 9 (step 11). The selected candidate partners are presented to respective catalog providers and catalog users. In particular, a list of catalog users who share the same handling field is provided to the catalog provider, while a list of catalog providers who share the same handling field is provided to the catalog user.

Next, the catalog aggregator 3 carries out various initial settings. With respect to each catalog provider, these initial settings involve settings of a catalog information type, a format conversion definition such as arrangement order of items, a categorization, a normalization definition such as terminology coordination, a file format, an image editing definition such as compression level, etc. Also, with respect to each catalog user, these initial settings involve settings of a format conversion definition of the electronic catalog, a word-code conversion definition, an image editing definition, etc.

Then, the catalog provider carries out the registration and update of a product list (step S13), and the catalog user carries out a selection of a product from a maker/product list (step S15).

When these processings are finished, next at the catalog provider device group 1, a catalog registration is carried out (step S17), a catalog information is extracted (step S19), and this extracted catalog information is transmitted in the catalog provider specific format from the catalog provider device group 1 to the catalog aggregator 3. Upon receiving this catalog information at the catalog data collecting and receiving unit 33, the catalog aggregator 3 converts it into the electronic catalog of a prescribed common format at the catalog processing unit 34 (step S21), and stores it into the common catalog database 35 (step 23).

After the catalog information from the catalog provider device group 1 is processed into the electronic catalog in the prescribed common format and stored into the common catalog database 35, when the catalog aggregator 3 receives an electronic catalog request information from the catalog user device group 5, the catalog aggregator 3 extracts the electronic catalog that matches the request information from the common catalog database 35 at the catalog extraction unit 36 (step S25), and converts this extracted electronic catalog into a catalog user requested format (step S27).

Then, the electronic catalog so converted into the catalog user requested format is transmitted from the catalog aggregator 3 to the catalog user device group 5, and the catalog user device group 5 receives this electronic catalog (step S29). Also, the catalog user accounts this received electronic catalog in the own system (step S31).

When the electronic catalog is given to the catalog user, a charging processing for the above described processings is carried out and the charges are billed to the catalog provider and the catalog user (step S33). Note that, in this charging processing, the catalog provider is charged for a primary processing including the receiving processing at the catalog data collecting and receiving unit 33 and the processing at the catalog processing unit 34 with respect to the catalog information provided by the catalog provider, and the catalog user is charged for a secondary processing including the extraction and conversion processing at the catalog extraction unit 36 with respect to the electronic catalog requested by the catalog user, for example. Here, the execution log of the primary processing and the secondary processing is preserved as a log information in the management database 32, and the charging is carried out by referring to this log information.

By carrying out the charging as described above, it becomes possible to charge according to a quality of the catalog provided by the catalog provider, so that the charge corresponding to the cost can be collected. More specifically, the error processing occurrence frequency can be different in the case where the catalog data provided by catalog provider are perfectly filled and in the case where the catalog data has many missing data or errors, and in the latter case the catalog provider can be charged for the extra error processing.

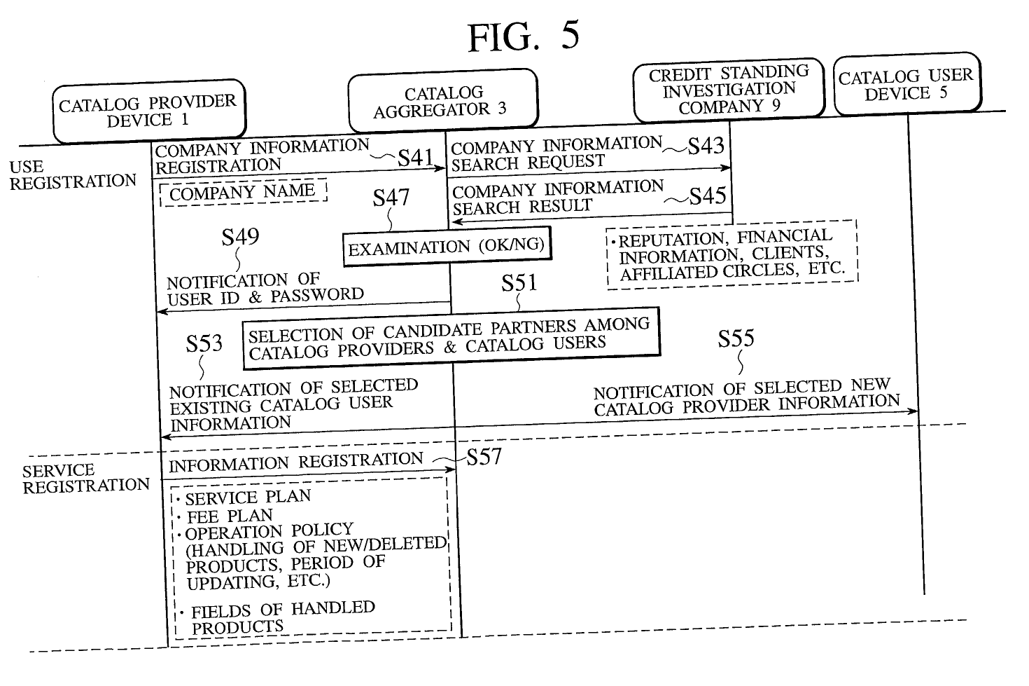

Now, with references to FIG. 5 to FIG. 13, each of the above described processings will be described in further detail.

First, with reference to FIG. 5, the registration processing at a time of the admission of a catalog provider will be described.

The registration processing at a time of the admission of a catalog provider shown in FIG. 5 includes the user registration and the service registration, where the user registration is to be carried out first in this processing.

In the user registration, a catalog provider who wishes to be admitted to this system registers a company information such as own company name into the catalog aggregator 3 from the catalog provider device group 1 (step S41). Upon receiving the company information of the catalog provider from the catalog provider device group 1, the catalog aggregator 3 makes a company information search request by accessing the company information database 9a of the credit standing investigation company 9 (step S43), and receives information such as reputation, financial information, clients information, affiliated circles information of the catalog provider which is necessary in the admission examination as a company information search result from the credit standing investigation company 9 (step S45). Then, the catalog aggregator 3 carries out the admission examination of the catalog provider by utilizing the received information to judge whether the catalog provider is admissible or not (OK/NG) (step S47). In the case where the catalog provider is to be admitted as a result of this admission examination, the catalog aggregator 3 notifies a user ID and a password to the catalog provider (step S49).

Next, the catalog aggregator 3 selects candidate partners among the catalog provider and the catalog users by utilizing the information used in the above described admission examination (step S51), and notifies the company information of the selected existing catalog users to the catalog provider as the candidate partners (step S53) while notifying the company information of the selected new catalog provider to the catalog users as the candidate partner (step S55)

When the user registration is completed in this way, the service registration is carried out next. In this service registration, the catalog provider carries out the registration of information on services that can be provided by the catalog provider with respect to the catalog aggregator 3 (step S57). In this information registration, information such as service plan, fee plan, operation policy such as handling of new/deleted products and period of updating, and fields of handled products that can be provided by the catalog provider is notified to the catalog aggregator 3, and stored into the management database 32 under the management of the management function unit 31 at the catalog aggregator 3.

As described, in this embodiment, the catalog aggregator 3 automatically carries out the admission and the registration of the catalog provider, so that the operation related to the admission examination can be reduced and the registered parties can acquire information on the candidate partners without carrying out any special operation.

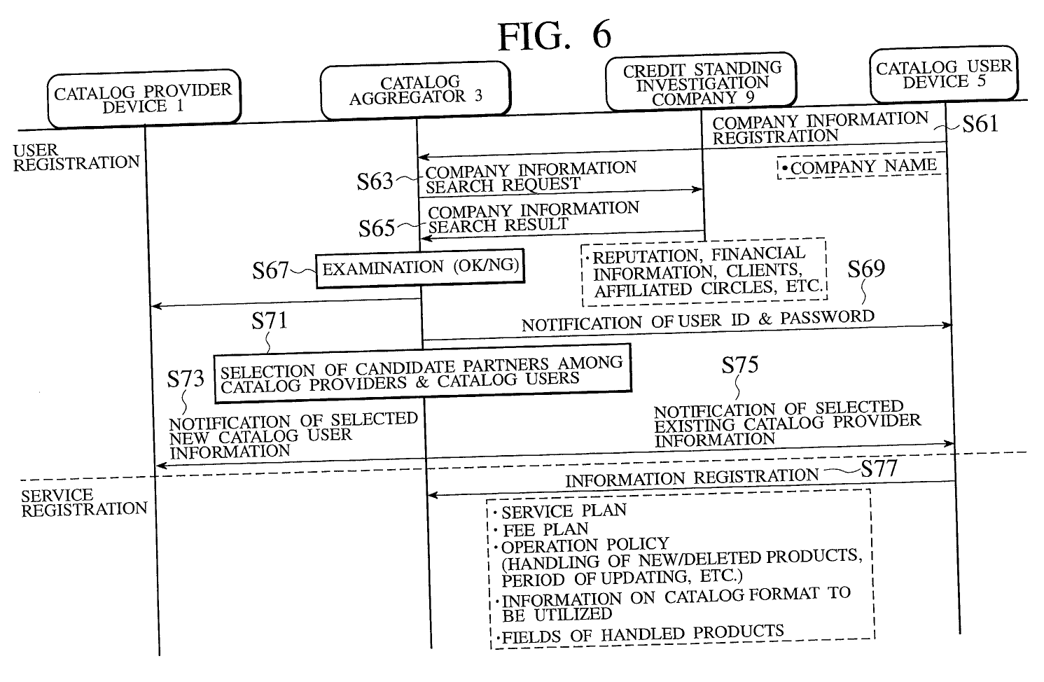

Next, with reference to FIG. 6, the registration processing at a time of the admission of a catalog user will be described.

Similarly as the processing for the catalog provider shown in FIG. 5, the registration processing at a time of the admission of a catalog user shown in FIG. 6 includes the user registration and the service registration, where the user registration is to be carried out first in this processing.

In the user registration, a catalog user who wishes to be admitted to this system registers a company information such as own company name into the catalog aggregator 3 from the catalog user device group 5 (step S61). Upon receiving the company information of the catalog user from the catalog user device group 5, the catalog aggregator 3 makes a company information search request by accessing the company information database 9a of the credit standing investigation company 9 through a network (step S63), and receives information such as reputation, financial information, clients information, affiliated circles information of the catalog provider which is necessary in the admission examination as a company information search result from the credit standing investigation company 9 (step S65). Then, the catalog aggregator 3 carries out the admission examination of the catalog user by utilizing the received information to judge whether the catalog user is admissible or not (OK/NG) (step S67). In the case where the catalog user is to be admitted as a result of this admission examination, the catalog aggregator 3 notifies a user ID and a password to the catalog provider (step S69).

Next, the catalog aggregator 3 selects candidate partners among the catalog providers and the catalog user by utilizing the information used in the above described admission examination (step S71), and notifies the company information of the selected new catalog user to the catalog provider as the candidate partner (step S73) while notifying the company information of the selected existing catalog providers to the catalog user as the candidate partners (step S75)

When the user registration is completed in this way, the service registration is carried out next. In this service registration, the catalog user carries out the registration of information that the catalog user wishes to utilize with respect to the catalog aggregator 3 (step S77). In this information registration, information such as service plan, fee plan, operation policy such as handling of new/deleted products and period of updating, and fields of handled products that is desirable to the catalog user is notified to the catalog aggregator 3, and stored into the management database 32 under the management of the management function unit 31 at the catalog aggregator 3.

As described, in this embodiment, the catalog aggregator 3 automatically carries out the admission and the registration of the catalog user, so that the operation related to the admission examination can be reduced and the registered parties can acquire information on the candidate partners without carrying out any special operation. Note that the admission examination of this embodiment is not necessarily limited to that for the admission to the electronic catalog system, and equally applicable to the admission examination for the admission to any kind of service on the network.

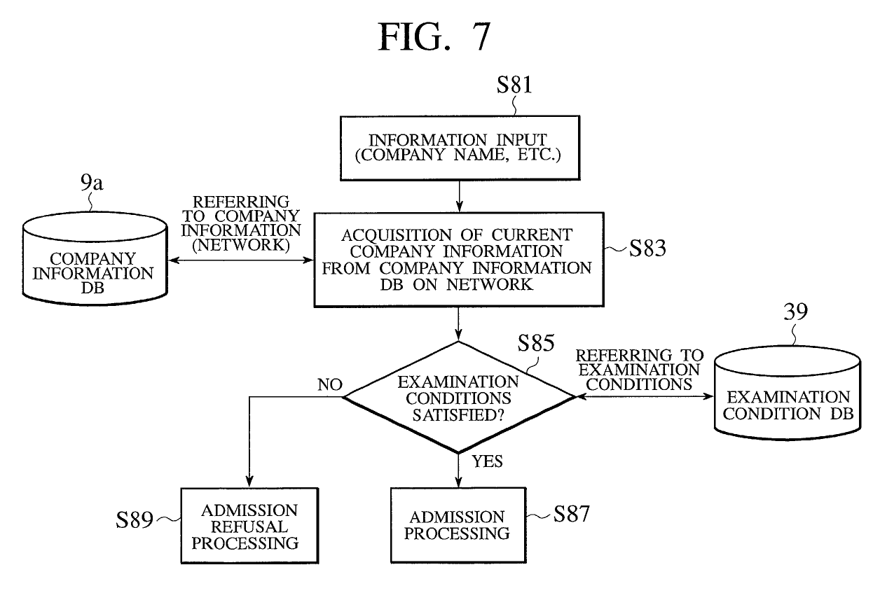

FIG. 7 shows an alternative procedure for the above described admission processing, which is basically similar to the processing described above and proceeds as follows. First, a company information such as own company name of a catalog provider or a catalog user who wishes to be admitted to this system is entered (step S81), and the catalog aggregator 3 acquires the company information such as reputation, financial information, clients information, affiliated circles information from the company information database 9a by accessing the company information database 9a of the credit standing investigation company 9 through a network according to the entered company information (step S83). Then, whether the catalog provider or the catalog user satisfies an examination condition or not is judged by referring to the examination condition stored in an examination condition database 39 that is provided as a part of the management database 32 according to the acquired information (step S85). When the examination condition is satisfied the catalog provider or the catalog user is admitted and the admission processing is carried out (step S87), whereas when the examination condition is not satisfied the admission refusal processing is carried out to refuse the admission (step S89).

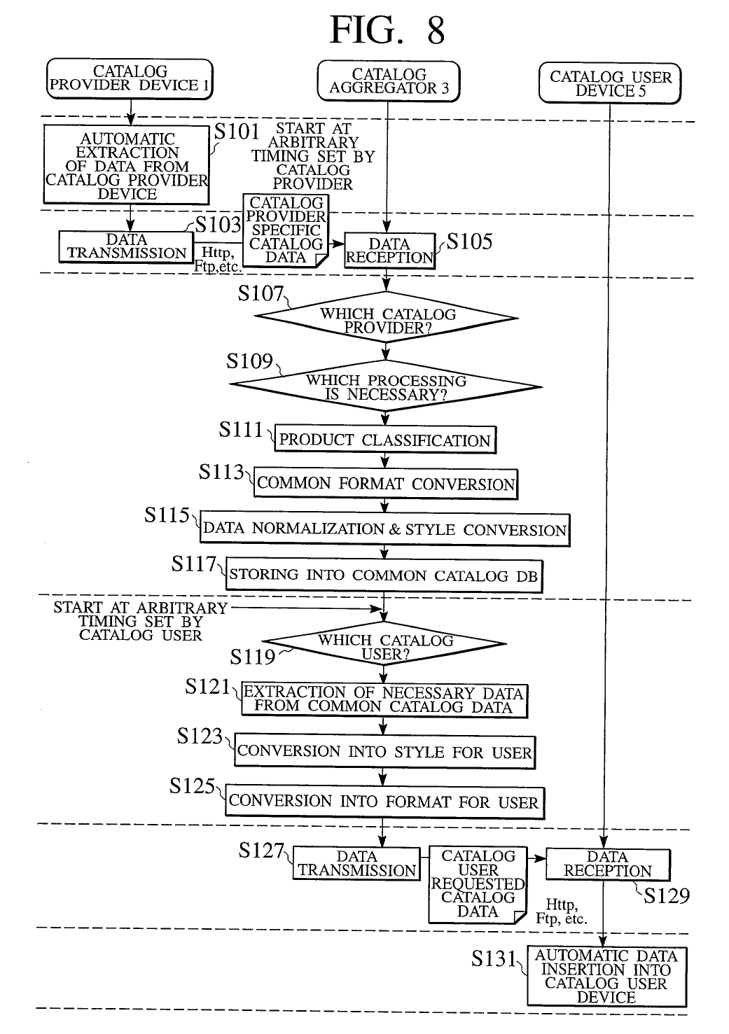

Next, with reference to FIG. 8, the processing for collecting catalog information from the catalog providers, and receiving this catalog information, processing this catalog information into the prescribed format, storing this catalog information into the common catalog database 35, and providing this catalog information to the catalog users at the catalog aggregator 3 will be described.

In FIG. 8, the catalog data is automatically extracted from the catalog provider device group 1 first (step S101), and this extracted catalog provider specific catalog data is transmitted to the catalog aggregator 3 through a network (step S103) and received by the catalog data collecting and receiving unit 33 at the catalog aggregator 3 (step S105).

Upon receiving the catalog data, the catalog aggregator 3 judges the catalog provider who provided this catalog data (step S107). Here, the catalog provider device group 1 may provide an identification information of the catalog provider along with the catalog data in order to make it easier for the catalog aggregator 3 to judge the catalog provider who provided the catalog data, or the catalog provider may be judged by some other method.

Next, when the catalog provider is judged, the catalog aggregator 3 analyzes the catalog data provided from the catalog provider to analyze what kind of conversion processing is necessary in order to process this catalog data into the prescribed common format suitable for storing into the common catalog database 35 and extracts items necessary for the processing, because the quality of the catalog data can vary for different catalog providers and different occasions of the catalog data providing (step S109). Note that this analysis processing may be realized by storing the catalog data providing format for each catalog provider in advance at the management database 32 for example, analyzing the catalog data according to this catalog data providing format of each catalog provider, and judges the processing necessary for converting this catalog data into the electronic catalog in the prescribed common format according to this analysis.

Also, when what kind of processing is necessary is ascertained as a result of the above described analysis, a product classification of a product to which this catalog data is directed is judged, and a common product classification code is assigned to the judged product classification (step S111).

In addition, appropriate processing is automatically executed with respect to a portion that requires processing by referring to the processing rules suitable for the ascertained catalog provider such as format rule, notation rule, character code rule and image rule, so as to realize the conversion into the prescribed common format determined by the catalog aggregator 3 (step S113). Note that this conversion includes the file format conversion, the item conversion, the item attribute conversion, and the item structure conversion. Then, the catalog data normalization processing is carried out to realize the style conversion (step S115). This conversion includes the character code conversion and the notation coordination. After being converted into the electronic catalog in the prescribed common format in this way, it is stored into the common catalog database 35 (step S117). Here, the electronic catalog can be converted into a common format defined for each product classification and then stored into the common catalog database 35.

As described, the catalog data is processed automatically so that the manual operation becomes unnecessary for the processing of the catalog data provided from the catalog provider, and in addition a common format is defined for each product classification so that the catalog data can be managed in a format that retains some features of each product classification and that can be handled relatively easily.

The processing of the next step S119 and on is a processing in which the catalog user requests the electronic catalog and then receives the electronic catalog. In this processing, when the catalog user accesses the catalog aggregator 3 at arbitrary timing through the catalog user device group 5 and transmits an electronic catalog request information to the catalog aggregator 3, the catalog aggregator 3 judges the catalog user who made this access (step S119). When the catalog user is ascertained as a result, a format into which the electronic catalog is to be converted is determined. Then, the catalog aggregator 3 searches through the common catalog database according to the electronic catalog request information from the catalog user and extracts the electronic catalog data that matches with the electronic catalog request information of the catalog user from the common catalog database (step S121).

The electronic catalog data extracted from the common catalog database 35 in this way is then converted into a desired style requested by the catalog user (step S123). This conversion includes the notation processing, the character code conversion, and the catalog user product classification code assignment. Them, the format conversion suitable for the catalog user is carried out (step S125). In this format conversion, appropriate conversion processing such as the item conversion, the item attribute conversion, the item structure conversion, and the file format conversion is carried out by referring to the processing rules suitable for the catalog user such as format rule, notation rule, character code rule and image rule, so as to realize the conversion into the desired format requested by the catalog user. Here, the necessary electronic catalog data can be extracted from the common catalog database 35 in which it is stored in a format defined for each product classification, and then converted into a format requested by the catalog user.

The electronic catalog data that is converted as described above is transmitted from the catalog aggregator 3 to the catalog user device group 5 (step S127), received by the catalog user device group 5 (step S129), and automatically inserted into the catalog user device group 5 (step S131).

As described, the processing of the electronic catalog data requested from the catalog user is carried out completely automatically so that the manual operation becomes unnecessary, and in addition, the electronic catalog data stored in a common format defined for each product classification is utilized so that the catalog data can be managed in a format that retains some features of each product classification and that can be handled relatively easily.

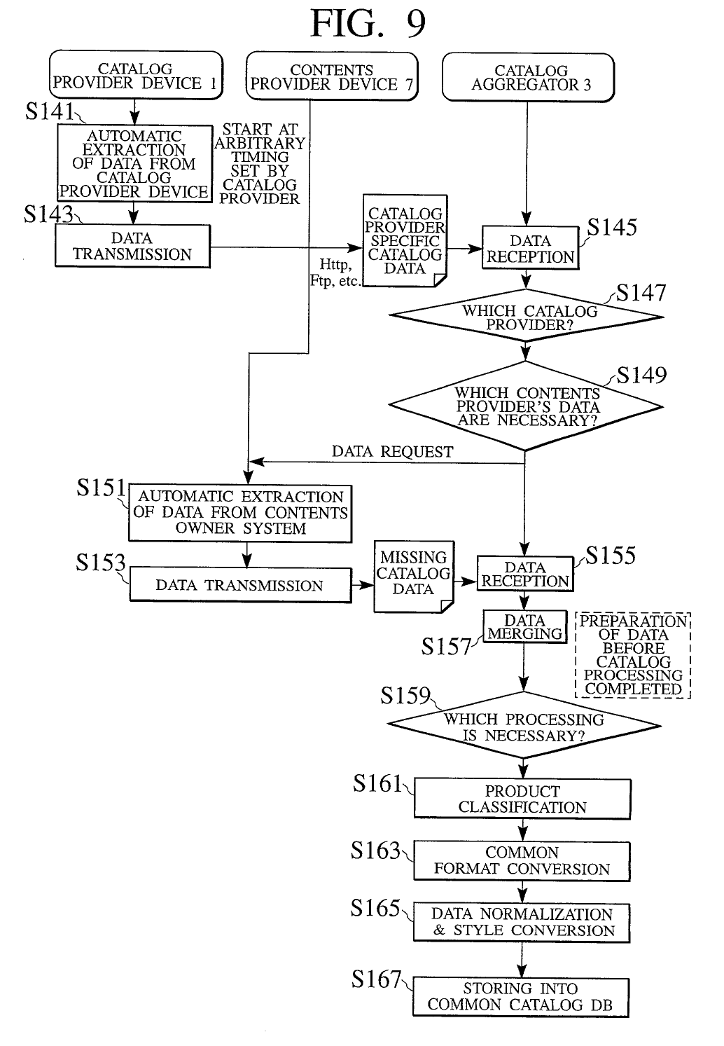

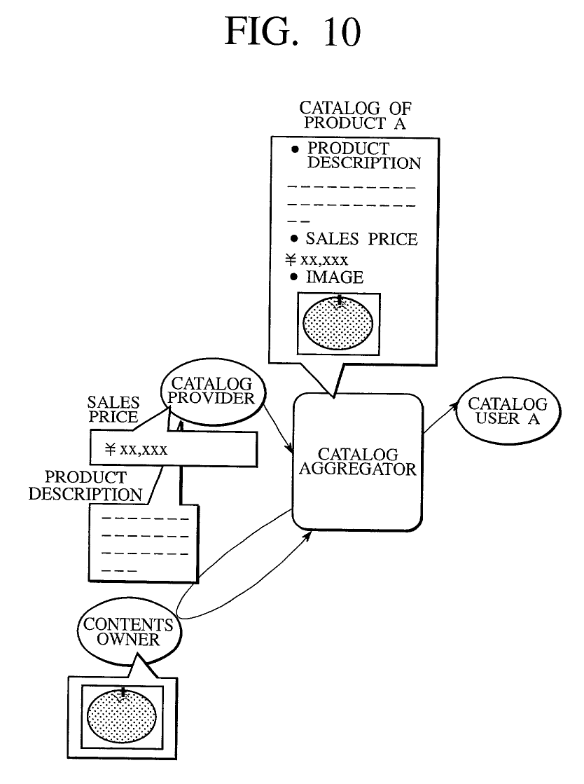

Next, with reference to FIG. 9, the processing for acquiring a missing catalog data from the contents provider device 7 as the missing catalog data is found as a result of analyzing the catalog data provided from the catalog provider will be described. First, this processing is briefly described with reference to FIG. 10.

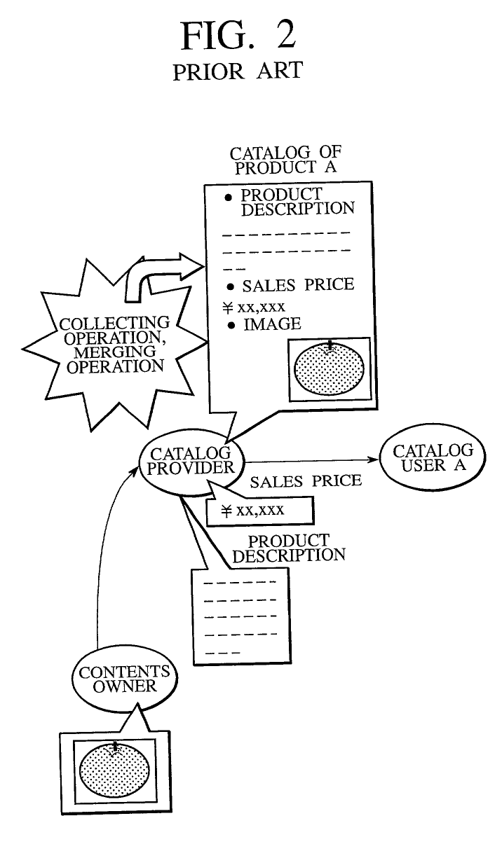

In the case where a plurality of sources are scattered for the catalog data of some product requested by the catalog user, there has been a need for the catalog provider to collect the catalog data from the plurality of sources and merge them. Namely, as shown in FIG. 10, in the case where the catalog provider provides the catalog information of a product A to the catalog user A, if the catalog provider owns the product description information and the sales price information for the product A but the contents information such as image is owned by the contents owner, it has conventionally been necessary for the catalog provider to collect the catalog data as already explained with reference to FIG. 2. In contrast, in this embodiment, the catalog data from the contents owner can be collected by the catalog aggregator 3. Namely, the catalog aggregator 3 collects the product description information and the sales price information of the product A from the catalog provider while also directly collecting the contents information such as image information from the contents owner, merges a plurality of the collected information to produce the electronic catalog of the product A, and provides this electronic catalog to the catalog user A. As a result, the contents information collecting and merging operations that are conventionally required to the catalog provider can be eliminated.

In the processing of FIG. 9, the catalog data of the catalog provider is automatically extracted from the catalog provider device group 1 (step S141), and this extracted catalog data is transmitted to the catalog aggregator 3 (step S143) and received by the catalog aggregator 3 (step S145).

Upon receiving the catalog data, the catalog aggregator 3 analyzes this catalog data in order to analyze the catalog provider of this catalog data (step S147). Then, the catalog aggregator 3 analyzes this catalog data in order to detect any missing information, i.e., missing catalog data, and searches for the contents owner who owns information for complementing this missing catalog data, i.e., the contents provider device 7 in FIG. 3 (step S149). Namely, which contents provider's data are necessary is judged (step S149). When the contents provider device 7 is ascertained as a result, the missing catalog data is requested to this contents provider device 7 and this data is automatically extracted from the contents provider device 7 (step S151).

This extracted missing catalog data is transmitted from the contents provider device 7 to the catalog aggregator 3 (step S153), and upon receiving this missing catalog data (step S155), the catalog aggregator 3 merges this missing catalog data with the catalog data collected from the catalog provider earlier (step S157). This completes the data preparation before the catalog processing.

Next, at a time of storing this merged catalog data into the common catalog database 35, the catalog aggregator 3 analyzes this catalog data in order to analyze which processing, i.e., what kind of conversion processing, is necessary (step S159). When the necessary processing is ascertained as a result of this analysis, the product classification of a product to which this catalog data is directed is judged and the common product classification code is assigned to the judged product classification (step S161).

Then, appropriate processing is automatically executed with respect to a portion that requires processing by referring to the processing rules suitable for the ascertained catalog provider so as to realize the conversion into the prescribed common format determined by the catalog aggregator 3 (step S163). Note that this conversion includes the file format conversion, the item conversion, the item attribute conversion, and the item structure conversion. Then, the catalog data normalization processing is carried out to realize the style conversion (step S165). This conversion includes the character code conversion and the notation coordination. After being converted into the electronic catalog in the prescribed common format in this way, it is stored into the common catalog database 35 (step S167).

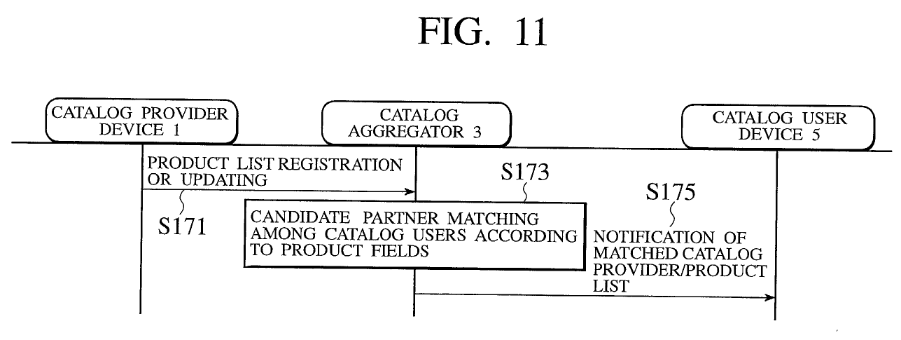

FIG. 11 shows the product list registration and update processing. As shown in FIG. 11, when a need to register a list of products to be provided or to make a change in the already registered product list, the catalog provider carries out the updating of the product list with respect to the catalog aggregator 3 (step S171). In response to this, the catalog aggregator 3 carries out matching of the candidate partners among the catalog users in fields of the products (step S173), and notifies the matched catalog provider/product list to the catalog user device group 5 (step S175).

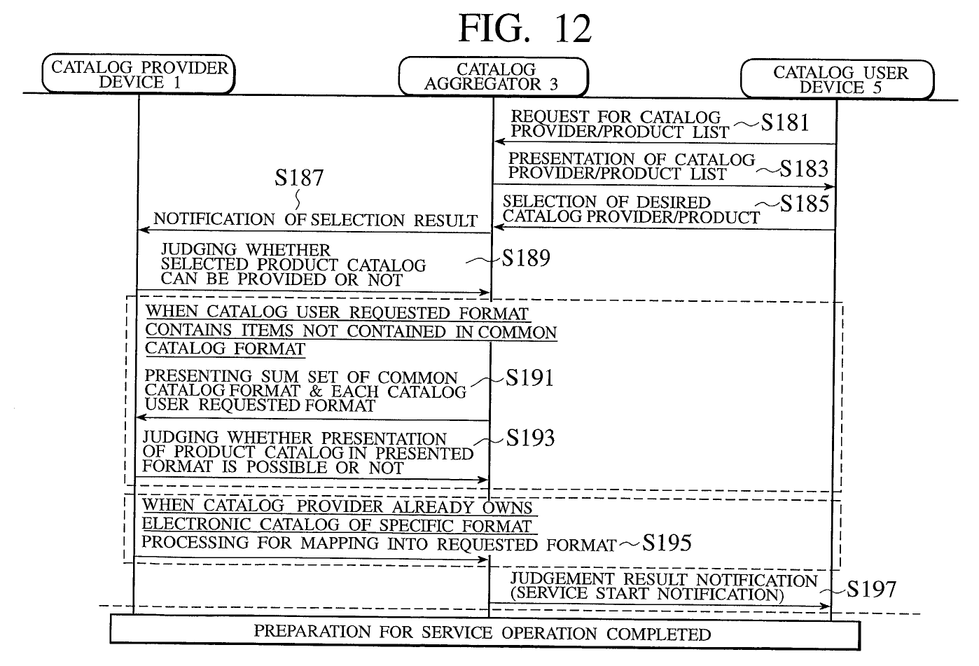

FIG. 12 shows the processing in the case where the catalog user selects the catalog provider for handling the catalog and the product. As shown in FIG. 12, the catalog user requests a catalog provider/product list to the catalog aggregator 3 through the catalog user device group (step S181). Note that normally a product to be sold is already determined between the catalog user and the purchaser before this processing so that the catalog provider/product to be selected here is determined in advance.

The catalog aggregator 3 presents the catalog provider/product list in response to the catalog provider/product list request from the catalog user (step S183). The catalog user views this presentation, selects the desired catalog provider/product for trading the catalog, and notifies it to the catalog aggregator 3 (step S185). Upon receiving this notification, the catalog aggregator 3 notifies the selection result of the catalog user to the corresponding catalog provider (step S187). The catalog provider then judges whether the selected product catalog can be provided or not (OK/NG) in response to this notification (step S189).

Here, when the requested format of the catalog user who carries out the catalog trading contains items not contained in the prescribed common catalog format, the catalog aggregator 3 presents a sum set of the catalog user requested format and the prescribed common catalog format to the catalog provider device group 1 (step S191). Then, the catalog provider device group 1 judges whether the catalog can be provided in this presented format or not (step S193). Also, when the catalog provider already owns the electronic catalog of the specific format, the processing for mapping from this format to the requested format is carried out (step S195). The catalog aggregator 3 notifies a judgement result according to a content received from the catalog provider device group 1 to the catalog user device group 5 (step S197). This completes the preparation for the service operation so that the start of the service is notified to the catalog user device group 5.

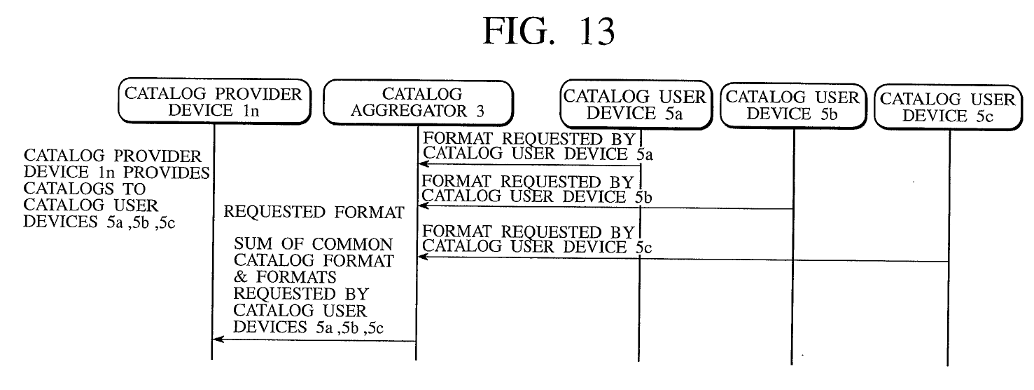

FIG. 13 shows the processing for presenting a sum set of the catalog user requested format and the prescribed common catalog format to the catalog provider device group 1 by the catalog aggregator 3 at the step S191 described above in further detail. In such a case, as shown in FIG. 13, the catalog aggregator 3 receives the respective requested formats from the catalog user devices 5a, 5b and 5c of a plurality of catalog users A, B and C, and the catalog provider device 1n acquires a sum set of these requested formats and the prescribed common catalog format. The catalog provider device 1n will then provide the catalog to the catalog users A, B and C.

As described, according to the first embodiment, the catalog aggregator processes the electronic catalog data from the catalog provider into the prescribed common format and stores it in the electronic catalog database, and extracts from the electronic catalog database the electronic catalog data corresponding to the catalog request information from the catalog user, converts it into the electronic catalog in a format specified by the catalog request information and delivers it to the catalog user through a network, so that the catalog extraction operation, the operation for editing into the catalog user requested format and the delivery operation in the catalog user requested scheme that are conventionally required to be carried out by the catalog provider with respect to each catalog user can be eliminated, while the catalog receiving operation and the operation for accounting the catalog in the catalog user system that are conventionally required to be carried out by the catalog user with respect to each catalog provider can be eliminated, so that it is possible to realize a fast and efficient electronic catalog system.

Also, according to the first embodiment, the catalog aggregator judges whether the catalog provider is admissible or not upon receiving a prescribed admission request information from the catalog provider, registers the catalog provider as an electronic catalog distribution source when the catalog provider is admissible as a result of the judgement, and manages charging data for the processing of the electronic catalog data with respect to the catalog provider of the electronic catalog, so that the admission examination becomes automatic and the operation regarding the admission examination can be reduced, while the charging according to the quality of the catalog provided by the catalog provider becomes possible and it becomes possible to collect the charge corresponding to the cost.

Also, according to the first embodiment, the catalog aggregator judges whether the catalog user is admissible or not upon receiving a prescribed admission request information from the catalog user, registers the catalog user as an electronic catalog distribution target when the catalog provider is admissible as a result of the judgement, and manages charging data for the conversion of the electronic catalog data with respect to the catalog user of the electronic catalog data, so that the admission examination becomes automatic and the operation regarding the admission examination can be reduced, while the charging according to the processing for conversion into the electronic catalog utilization format used by the catalog user becomes possible and it becomes possible to collect the charge corresponding to the cost.

Also, according to the first embodiment, the common format is defined and managed for each product classification, and the electronic catalog data is processed into the prescribed common format corresponding to the product classification of a product to which the electronic catalog data is directed, so that the electronic catalog data can be processed into the common format defined for each product classification that retains some features of the product classification and that can be handled relatively easily.

Also, according to the first embodiment, the catalog utilization format is stored for each catalog user and the electronic catalog data is converted into the electronic catalog according to the catalog utilization format corresponding to the catalog user, so that the catalog user can receive the electronic catalog as converted in a desired catalog utilization format requested by the catalog user, so that the electronic catalog can be made easier to view for the catalog user and the convenience of the electronic catalog system can be improved.

Also, according to the first embodiment, the catalog aggregator detects missing catalog data items, and collects these missing catalog data items from a source other than the catalog provider and stores them, so that the operation to collect the catalog information from a plurality of sources and merging them that is conventionally required for the catalog provider can be realized by the catalog aggregator automatically and efficiently.

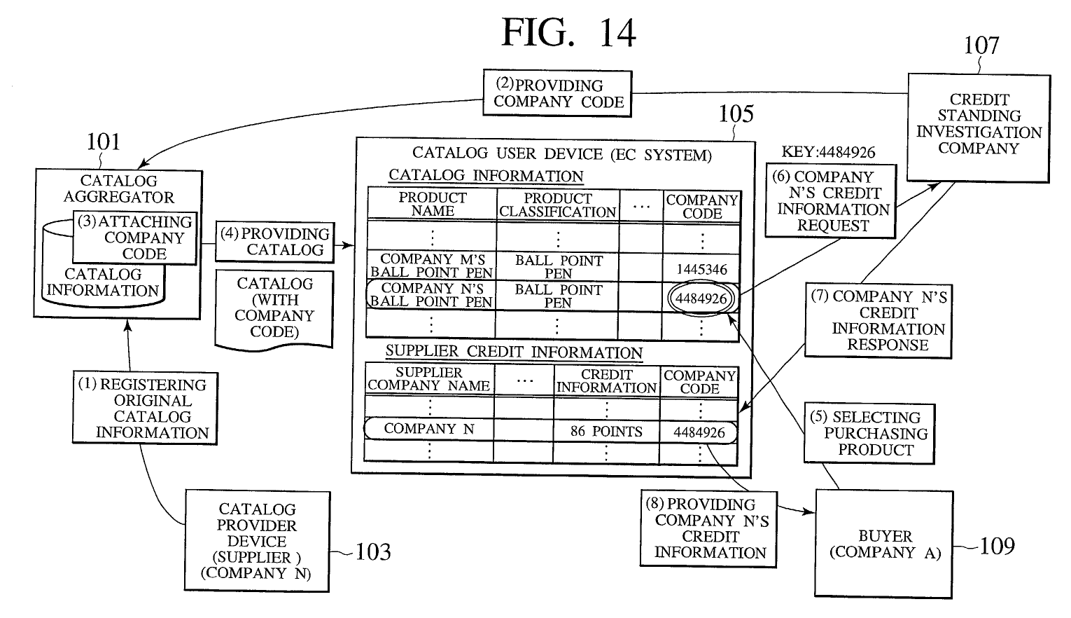

Referring now to FIG. 14 to FIG. 16, the second embodiment of an electronic catalog aggregation apparatus according to the present invention will be described in detail.

FIG. 14 shows an overall configuration of an electronic catalog system using an electronic catalog aggregation apparatus according to this embodiment. In this electronic catalog system of FIG. 14, a catalog provider who is a product provider, i.e., a supplier, registers original catalog information of a product from a catalog provider device 103 in a catalog aggregator 101 which is the electronic catalog aggregation apparatus. Then, the catalog information registered in the catalog aggregator 101 is provided to a catalog user device 105 which is an EC system, and a buyer 109 who is a product purchaser views the catalog information by accessing the catalog user device 105 and selects a product to be purchased.

In this embodiment, the catalog aggregator 101 acquires a company code of the product provider from a credit standing investigation company 107 and attaches the company code to the catalog information registered from the catalog provider device 105, and provides the catalog information with the company code attached thereon to the catalog user device 105. Then, when the buyer 109 views the catalog information and selects a product, the catalog user device 105 acquires a company credit information of the product provider corresponding to the company code attached to the catalog information of the selected product from the credit standing investigation company 107 and presents this company credit information to the buyer 109.

Note that this embodiment is directed to an exemplary case where the electronic catalog provider and the product provider are identical, but a case where they are different can be realized similarly.

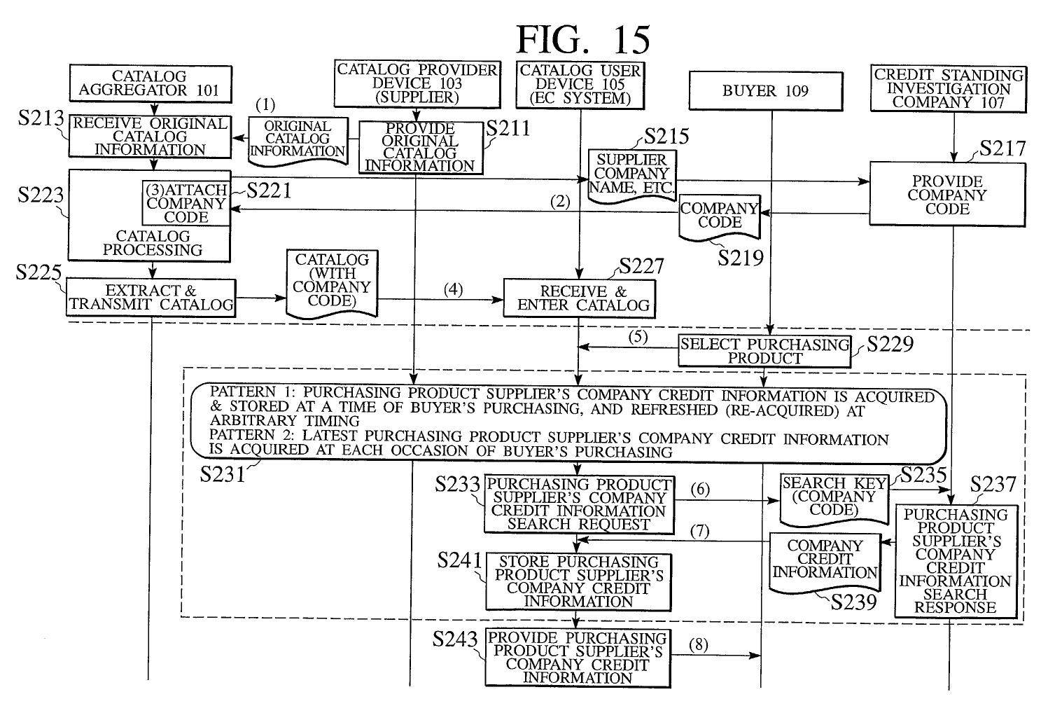

Now, the operation in this embodiment will be described in further detail with reference to FIG. 15. Note that, in FIG. 14 and FIG. 15, numbers in parentheses ( ) are sequence numbers indicating orders in the processing procedure, where the same number is given to the same processing operation in both figures.

In FIG. 14 and FIG. 15, the catalog provider device 103 provides the original catalog information to be utilized at the catalog user device 105 in order to register it (step S211). Upon receiving the original catalog information from the catalog provider device 103 (step S213), the catalog aggregator 101 sends a company name of the catalog provider device 103 which is a supplier to the credit standing investigation company 107 (step S215) and receives a company code from the credit standing investigation company 107 (steps S217, S219), and attaches this company code to the catalog information while processing the catalog information into a prescribed common format (steps S221, S223).

Then, the catalog aggregator 101 transmits the catalog information with the supplier's company code attached thereon to the catalog user device 105 (step S225), and the catalog user device 105 receives the catalog information with the company code and makes a setting convenient for the viewing by the buyer 109 (step S227).

The buyer 109 who is the product purchaser makes an access to the catalog user device 105 and selects a product to be purchased by referring to the catalog information, and transmits a product selection information to the catalog user device 105 (step S229). Upon receiving the product selection information from the buyer 109, the catalog user device 105 acquires the company credit information of the supplier of the selected product in order to present it to the buyer 109.

Here, there are two ways for realizing this company credit information processing as indicated as pattern 1 and pattern 2 in the step S231 of FIG. 15. The pattern 1 is a method in which the company credit information of the catalog provider device 103 which is a supplier of the purchasing product is acquired from the credit standing investigation company 107 at a time of a product selection and purchasing by the buyer 109 and stored, and this stored company credit information is refreshed (re-acquired) in order to keep the company credit information up-to-date at arbitrary timing such as when a pre-registered constant period of time has elapsed or a manually specified timing. The pattern 2 is a method in which the latest company credit information of the supplier of the purchasing product is acquired at each occasion of the product selection and purchasing by the buyer 109. The step S241 enclosed by a dashed line in FIG. 15 and to be described below is carried out in the pattern 1 but skipped in the pattern 2.

Namely, when the purchasing product selection information from the buyer 109 is received, the catalog user device 105 makes a search request for the company credit information of the catalog provider who is a supplier of the purchasing product to the credit standing investigation company 107 (step S233), and the company code of the catalog provider device 103 is transmitted to the credit standing investigation company 107 as a search key (step S235). Upon receiving this search key, the credit standing investigation company 107 searches out the company credit information of the catalog provider device 103 in response (step S237) and transmits the searched out company credit information to the catalog user device 105 (step S239). When the company credit information of the catalog provider device 103 is received from the credit standing investigation company 107, the catalog user device 105 stores the received company credit information in the case of the pattern 1 described above (step S241), or this step S241 is skipped in the case of the pattern 2 described above, and then this company credit information is presented to the buyer 109 (step S243).

Note that, in the case of the pattern 1, the company credit information is stored so that a next occasion in which the same company credit information is requested can be dealt with quickly, and the number of times for acquiring the company credit information can be reduced. On the other hand, in the case of the pattern 2, it is possible to always use the latest company credit information.

As a result, the buyer 109 can view the company credit information of the catalog provider device 103 which is the supplier of the product at a time of the product selection and purchasing, so that the buyer 109 can avoid a risk of purchasing a product from a non-trustworthy supplier.

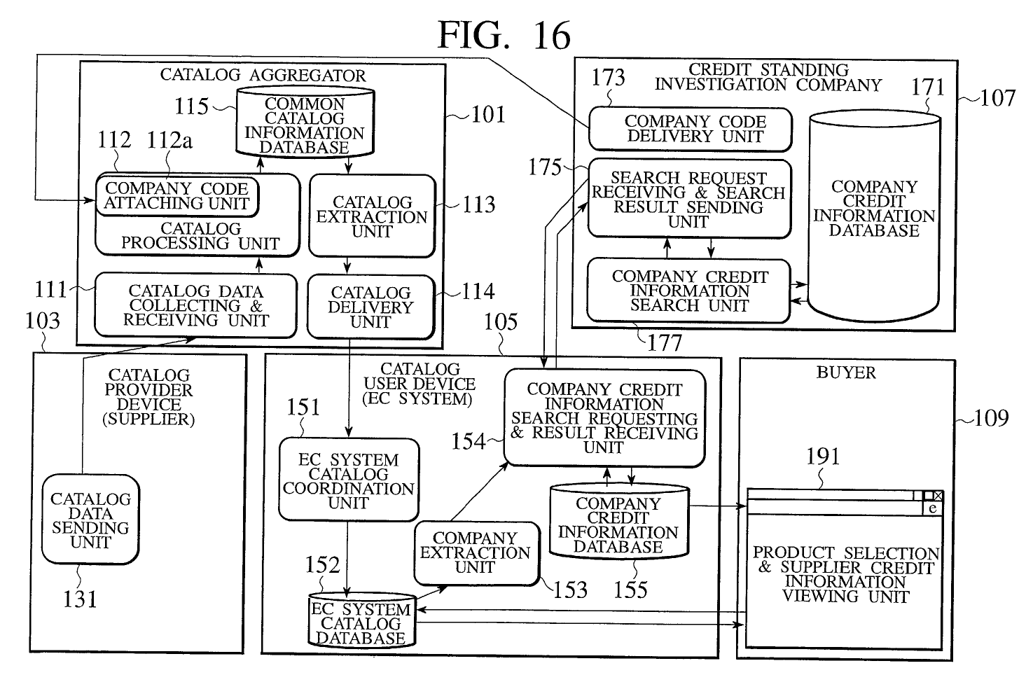

FIG. 16 shows a detailed configuration of the electronic catalog system of this embodiment. As shown in FIG. 16, the catalog provider device 103 has a catalog data sending unit 131 for sending the catalog data to the catalog aggregator 101.

The catalog aggregator 101 has a catalog data collecting and receiving unit 111 for receiving the catalog data sent from the catalog sending unit 131 of the catalog provider device 103, and a catalog processing unit 112 for processing the catalog data received at the catalog data collecting and receiving unit 111 into a prescribed common format, which contains a company code attaching unit 112a for attaching a company code to the catalog data received at the catalog data collecting and receiving unit 111 where the company code to be attached to the catalog data is received from the credit standing investigation company 107. The catalog aggregator 101 also has a common catalog information database 115 for storing the catalog data processed in the prescribed common format by the catalog processing unit 112, a catalog extraction unit 113 for extracting the catalog data stored in the common catalog information database 115, and a catalog delivery unit 115 for transmitting the extracted catalog data to the catalog user device 105.

The catalog user device 105 is an EC system having an EC system catalog coordination unit 151 for receiving the catalog data transmitted from the catalog aggregator 101 and an EC system catalog database 152 for storing the received catalog data.

The catalog user device 105 also has a company extraction unit 153 for extracting the company code from the EC system catalog database 153 upon receiving the product selection information from the buyer 109, a company credit information search requesting and result receiving unit 154 for transmitting the company code to the credit standing investigation company 107 and receiving the company credit information corresponding to the company code from the credit standing investigation company 107, and a company credit information database 155 for storing the received company credit information and transmitting it to the buyer 109.

Note that, in the case of the pattern 2 described above, the company credit information will be transmitted directly to the buyer 109 without storing it in the company credit information database 155.

The buyer 109 has a product selection and supplier credit information viewing unit 191 for transmitting the product selection information to the catalog user device 105, and receiving the company credit information from the catalog user device 105. The buyer 109 views this company credit information and judges whether the supplier is trustworthy or not at a time of the product purchasing, so as to avoid a risk of purchasing the product from a non-trustworthy supplier.

The credit standing investigation company 107 has a company code delivery unit 173 for transmitting the company code to the catalog aggregator 101, a company credit information database 171 for storing the company credit information, a company credit information search unit 177 for searching through the company credit information stored in the company credit information database 171 according to the company code received from the catalog user device 105, and a search request receiving and search result sending unit 175 for receiving a company credit information search request from the catalog user device 105 and returning a search result to the catalog user device 105.

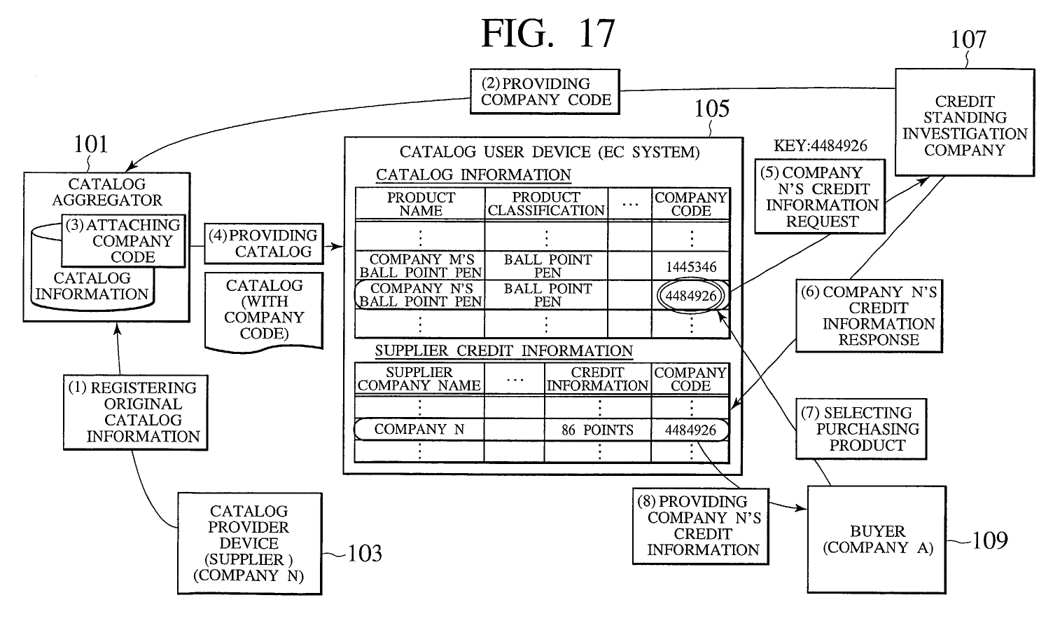

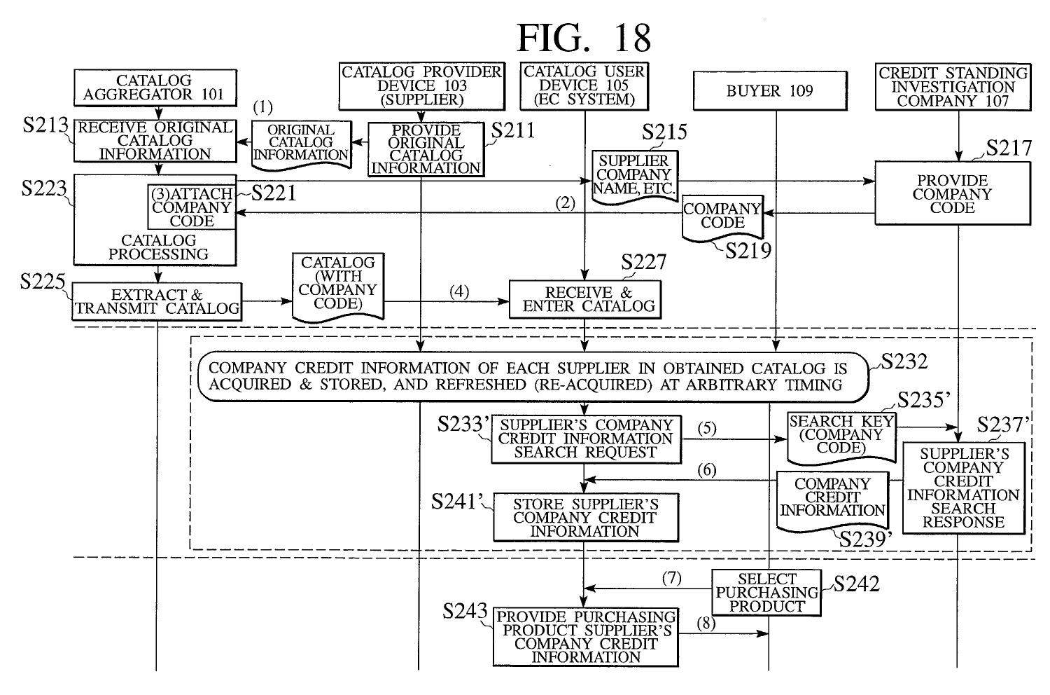

Referring now to FIG. 17 and FIG. 18, the third embodiment of an electronic catalog aggregation apparatus according to the present invention will be described in detail.

FIG. 17 shows an overall configuration of an electronic catalog system using an electronic catalog aggregation apparatus according to this embodiment. This electronic catalog system of FIG. 17 differs from that of the second embodiment only in that the catalog user device 105 requests the company credit information to the credit standing investigation company 107 before the purchasing product selection information is entered from the buyer 109 and stores it in the company credit information database 155 in advance such that the company credit information can be returned quickly when the purchasing product selection information is received from the buyer 109. The other configuration and operation are the same as in the second embodiment.

Now, the operation in this embodiment which is different from that of the second embodiment will be described in further detail with reference to FIG. 18.

The processing up to the step S227 where the catalog user device 105 receives the catalog data with the company code attached thereon from the catalog aggregator 101 is the same as in the second embodiment. In this embodiment, after that, the catalog user device 105 receives the company credit information of the supplier of the received catalog data from the credit standing investigation company 107 and stores it in the company credit information database 155, and refreshes (re-acquires) this stored company credit information in order to keep the company credit information up-to-date at arbitrary timing such as when a pre-registered constant period of time has elapsed or a manually specified timing (step S232), prior to receiving the purchasing product selection information from the buyer 109.

More specifically, in this processing, the catalog user device 105 makes a search request for the company credit information of the catalog provider device 103 which is a supplier of a product to be purchased by the buyer 109 to the credit standing investigation company 107 (step S233′), and the company code of the catalog provider device 103 is transmitted to the credit standing investigation company 107 as a search key (step S235′). Upon receiving this search key, the credit standing investigation company 107 searches out the company credit information of the catalog provider device 103 in response (step S237′) and transmits the searched out company credit information to the catalog user device 105 (step S239′). When the company credit information of the catalog provider device 103 is received from the credit standing investigation company 107, the catalog user device 105 stores the received company credit information (step S241′).

Then, after storing the company credit information as described above, the buyer 109 selects a product to be purchased and transmits this purchasing product selection information to the catalog user device 105 (step S242). When the purchasing product selection information from the buyer 109 is received, the catalog user device 105 extracts the company credit information of the catalog provider device 103 which is the supplier of this purchasing product from the company credit information database 155, and presents this company credit information to the buyer 109 (step S243).

In this way, in this embodiment, the company credit information is acquired and stored in the company credit information database 155 in advance so that it is possible to respond to a request from the buyer 109 quickly.

Note that a detailed configuration of the electronic catalog system of this embodiment is the same as that of FIG. 16 so that its description will be omitted here.

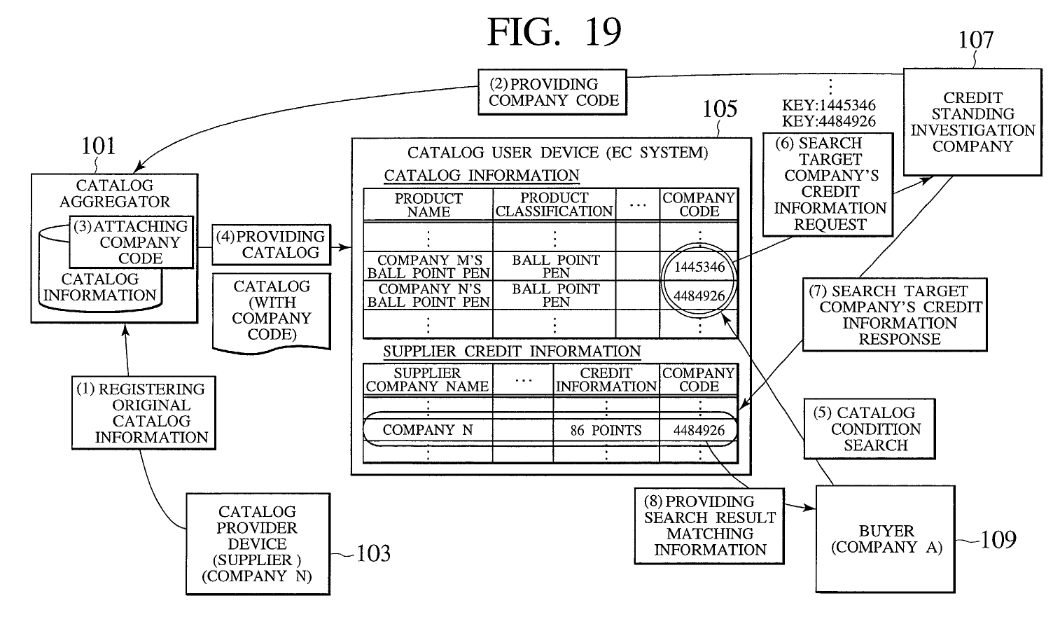

Referring now to FIG. 19 to FIG. 21, the fourth embodiment of an electronic catalog aggregation apparatus according to the present invention will be described in detail.

FIG. 19 shows an overall configuration of an electronic catalog system using an electronic catalog aggregation apparatus according to this embodiment. This electronic catalog system of FIG. 19 differs from that of the second embodiment only in that, when the buyer 109 carries out a search of a product to be purchased by viewing the catalog data of the catalog user device 105, the buyer 109 sets the company credit information of a supplier as a search condition in order to select and purchase a product of a supplier that satisfies the search condition given in terms of the company credit information. The other configuration and operation are the same as in the second embodiment.

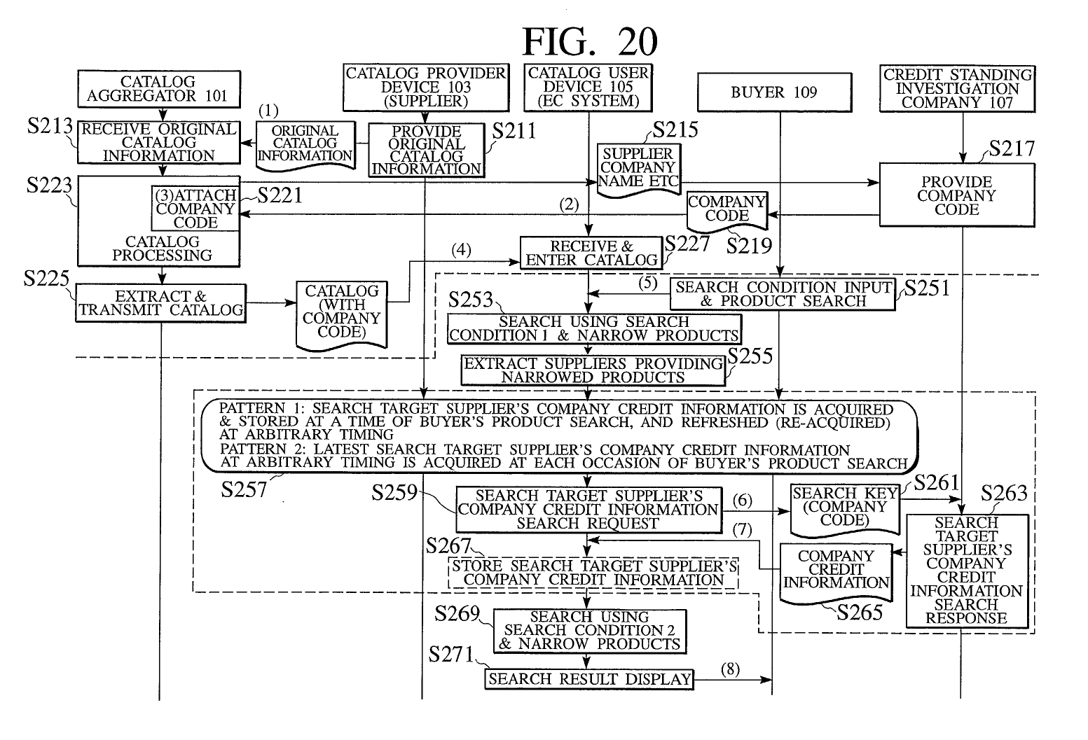

Now, the operation in this embodiment which is different from that of the second embodiment will be described in further detail with reference to FIG. 20.

The processing up to the step S227 where the catalog user device 105 receives the catalog data with the company code attached thereon from the catalog aggregator 101 is the same as in the second embodiment. In this embodiment, after that, the buyer 109 carries out a product search by entering the search condition including the company credit information of a supplier (step S251).

Note that there are plural types of the product search condition. Namely, the first search condition sets information in the product catalog existing in the catalog user device 105 such as a product name, a product specification and a maker name as the search condition, while the second search condition sets information existing in the credit standing investigation company 107 such as the company credit information of a supplier as the search condition. The first search condition is mainly utilized by the buyer 109 in narrowing down products to be purchased, and the second search condition is mainly utilized by the buyer 109 in verifying the safety of a transaction after the purchase.

In this embodiment, products are narrowed down first by carrying out a search using the first search condition (step S253) Then, the catalog provider devices 103 which are suppliers of the narrowed products are extracted (step S255). Then, the company credit information of each extracted catalog provider device 103 is acquired and stored (step S257).

Here, there are two ways for realizing this company credit information processing as indicated as pattern 1 and pattern 2 in the step S257 of FIG. 20. The pattern 1 is a method in which the company credit information of each search target supplier is acquired from the credit standing investigation company 107 at a time of a product search by the buyer 109 and stored, and this stored company credit information is refreshed (re-acquired) in order to keep the company credit information up-to-date at arbitrary timing such as when a pre-registered constant period of time has elapsed or a manually specified timing. The pattern 2 is a method in which the latest company credit information of each search target supplier is acquired at each occasion of the product search by the buyer 109.

More specifically, in this processing, the catalog user device 105 first makes a search request for the company credit information of the catalog provider device 103 which is a search target supplier to the credit standing investigation company 107 (step S259), and the company code of the catalog provider device 103 is transmitted to the credit standing investigation company 107 as a search key (step S261). Upon receiving this search key, the credit standing investigation company 107 searches out the company credit information of the catalog provider device 103 in response (step S263) and transmits the searched out company credit information to the catalog user device 105 (step S265).

When the company credit information of the catalog provider device 103 is received from the credit standing investigation company 107, the catalog user device 105 stores the received company credit information in the case of the pattern 1 described above (step S267), or this step S267 is skipped in the case of the pattern 2 described above, and then the catalog user device 105 narrows down products by carrying out the search using the company credit information as the second search condition (step S269). Namely, the company credit information of the second search condition is compared with the company credit information of each supplier and products of those suppliers that satisfy this second search condition are presented to the buyer 109 as a search result (step S271).

By searching a product by setting the company credit information of a supplier as a search condition as described above, the buyer 109 can avoid a risk of purchasing a product from a non-trustworthy supplier. It is also possible to avoid a tediousness associated with the purchasing product selection by narrowing down the candidate purchasing products in advance. In other words, the buyer 109 can eliminate products provided by non-trustworthy suppliers from candidate purchasing products at a time of the product selection.

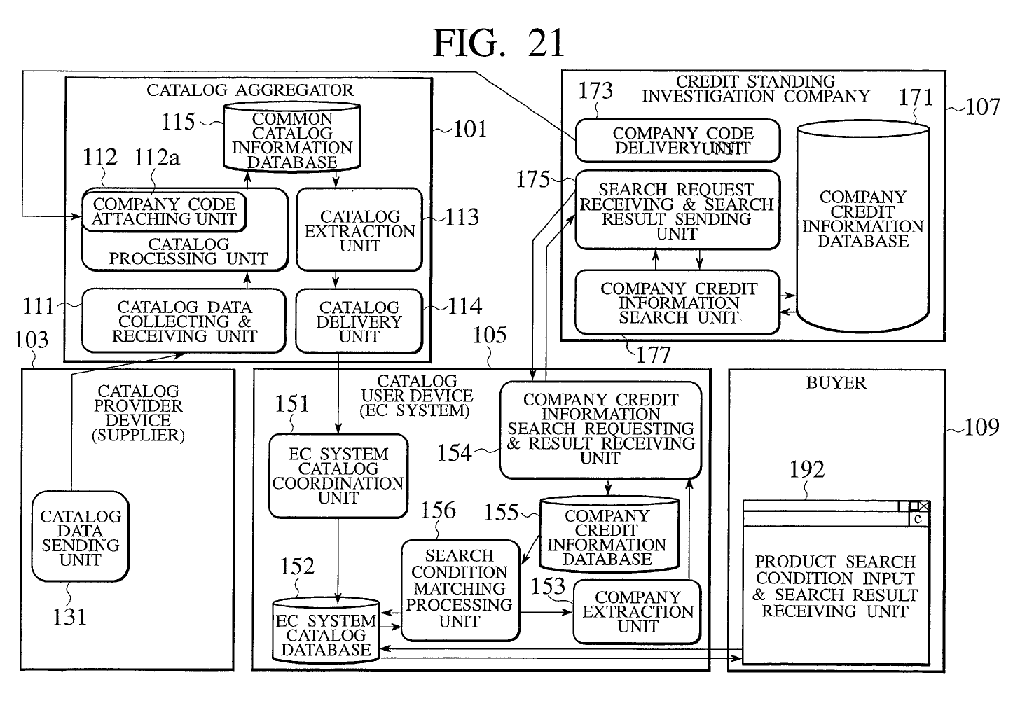

FIG. 21 shows a detailed configuration of the electronic catalog system of this embodiment. This configuration of FIG. 21 differs from that of FIG. 16 in that a product search condition input and search result receiving unit 192 for entering the product search condition and receiving the search result is provided at the buyer 109, and a search condition matching processing unit 156 for receiving the search condition from the product search condition input and search result receiving unit 192 of the buyer 109 and carrying out matching using this search condition is provided at the catalog user device 105. The other configuration and operation are the same as those of FIG. 16 and the same reference numerals are given for the same elements in the figures so that their description will be omitted here.

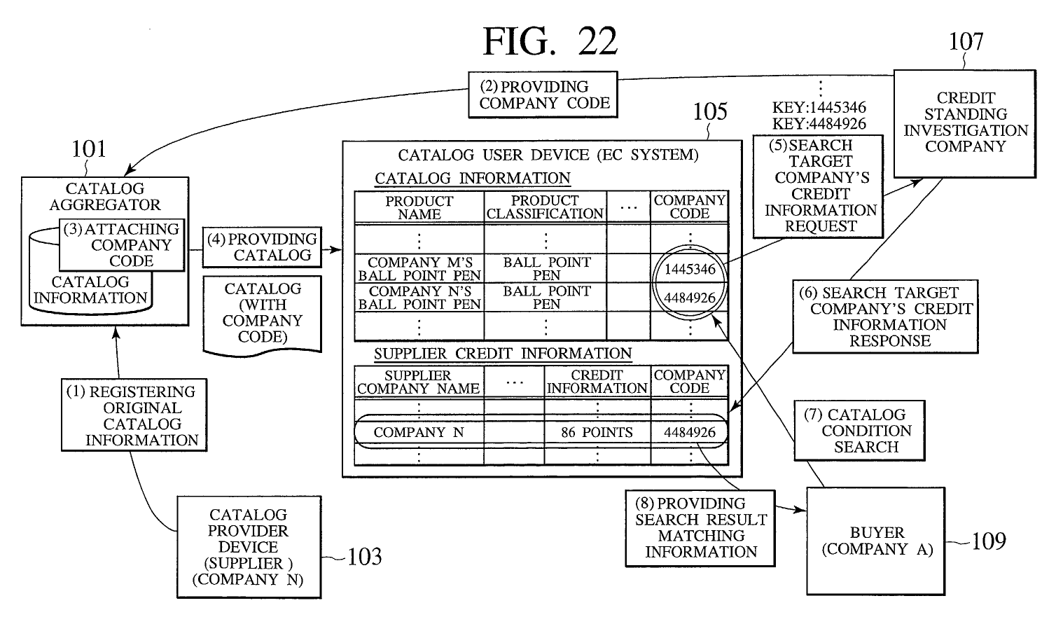

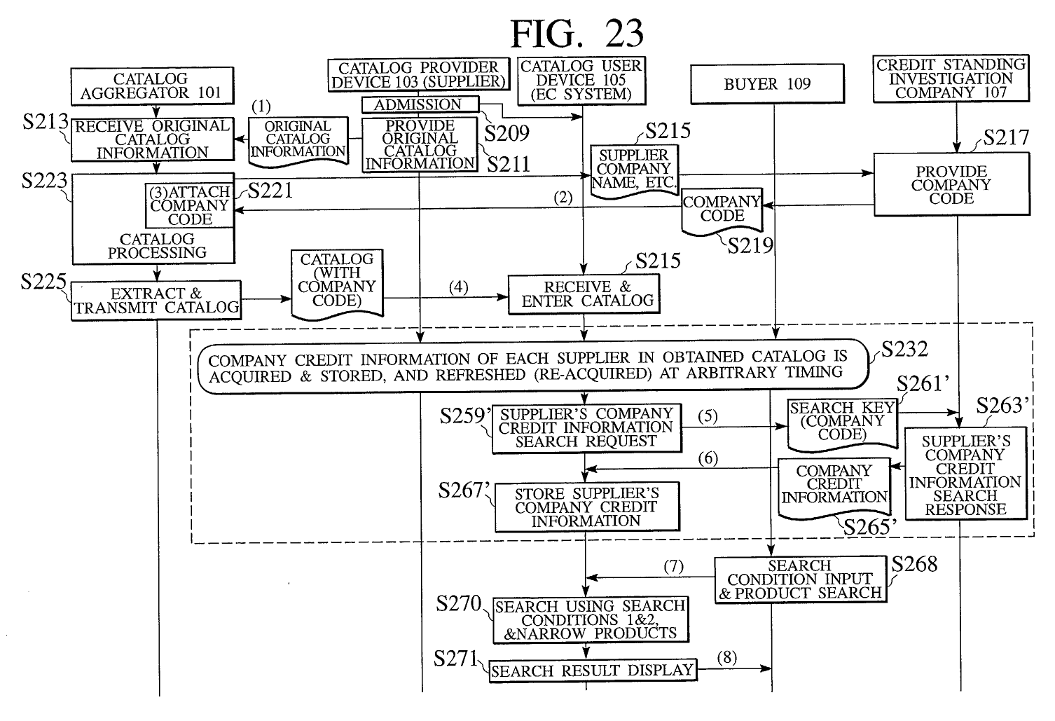

Referring now to FIG. 22 and FIG. 23, the fifth embodiment of an electronic catalog aggregation apparatus according to the present invention will be described in detail.

FIG. 22 shows an overall configuration of an electronic catalog system using an electronic catalog aggregation apparatus according to this embodiment. This electronic catalog system of FIG. 22 differs from that of the fourth embodiment only in that the catalog user device 105 requests the company credit information to the credit standing investigation company 107 before the search condition is entered from the buyer 109 and stores it in the company credit information database 155 in advance such that the search result can be returned quickly when the search condition is received from the buyer 109. The other configuration and operation are the same as in the fourth embodiment.

Now, the operation in this embodiment which is different from that of the fourth embodiment will be described in further detail with reference to FIG. 23.

In this embodiment, the catalog provider device 103 which is a supplier is admitted to this system first (step S209), and then the processing from the step S211 where the catalog provider device 103 provides the original catalog information to be utilized by the catalog user device 105 to the catalog aggregator 101 until the step S227 where the catalog user device 105 receives the catalog data with the company code attached thereon from the catalog aggregator 101 is the same as in the fourth embodiment. In this embodiment, after that, the catalog user device 105 receives the company credit information of the supplier of the received catalog data from the credit standing investigation company 107 and stores it in the company credit information database 155, and refreshes (re-acquires) this stored company credit information in order to keep the company credit information up-to-date at arbitrary timing such as when a pre-registered constant period of time has elapsed or a manually specified timing (step S232), prior to carrying out the product search by receiving the search condition from the buyer 109.

More specifically, in this processing, the catalog user device 105 makes a search request for the company credit information of the catalog provider device 103 which is a supplier of a product to be purchased by the buyer 109 to the credit standing investigation company 107 (step S259′), and the company code of the catalog provider device 103 is transmitted to the credit standing investigation company 107 as a search key (step S261′). Upon receiving this search key, the credit standing investigation company 107 searches out the company credit information of the catalog provider device 103 in response (step S263′) and transmits the searched out company credit information to the catalog user device 105 (step S265′). When the company credit information of the catalog provider device 103 is received from the credit standing investigation company 107, the catalog user device 105 stores the received company credit information (step S267′).

Then, after storing the company credit information as described above, the buyer 109 makes a product search request by entering the search condition to the catalog user device 105 (step S268).

Note that there are plural types of the product search condition. Namely, the first search condition sets information in the product catalog existing in the catalog user device 105 such as a product name, a product specification and a maker name as the search condition, while the second search condition sets information existing in the credit standing investigation company 107 such as the company credit information of a supplier as the search condition. The first search condition is mainly utilized by the buyer 109 in narrowing down products to be purchased, and the second search condition is mainly utilized by the buyer 109 in verifying the safety of a transaction after the purchase.

Upon receiving the first and second search conditions from the buyer 109, the catalog user device 105 narrows down products by carrying out the search using the first and second search conditions (step S270). Namely, the company credit information of the second search condition is compared with the company credit information of each supplier and products of those suppliers that satisfies this second search condition are presented to the buyer 109 as a search result (step S271).

By searching a product by setting the company credit information of a supplier as a search condition as described above, the buyer 109 can avoid a risk of purchasing a product from a non-trustworthy supplier. It is also possible to avoid a tediousness associated with the purchasing product selection by narrowing down the candidate purchasing products in advance. In other words, the buyer 109 can eliminate products provided by non-trustworthy suppliers from candidate purchasing products at a time of the product selection.

Note that a detailed configuration of the electronic catalog system of this embodiment is the same as that of FIG. 21 so that its description will be omitted here.

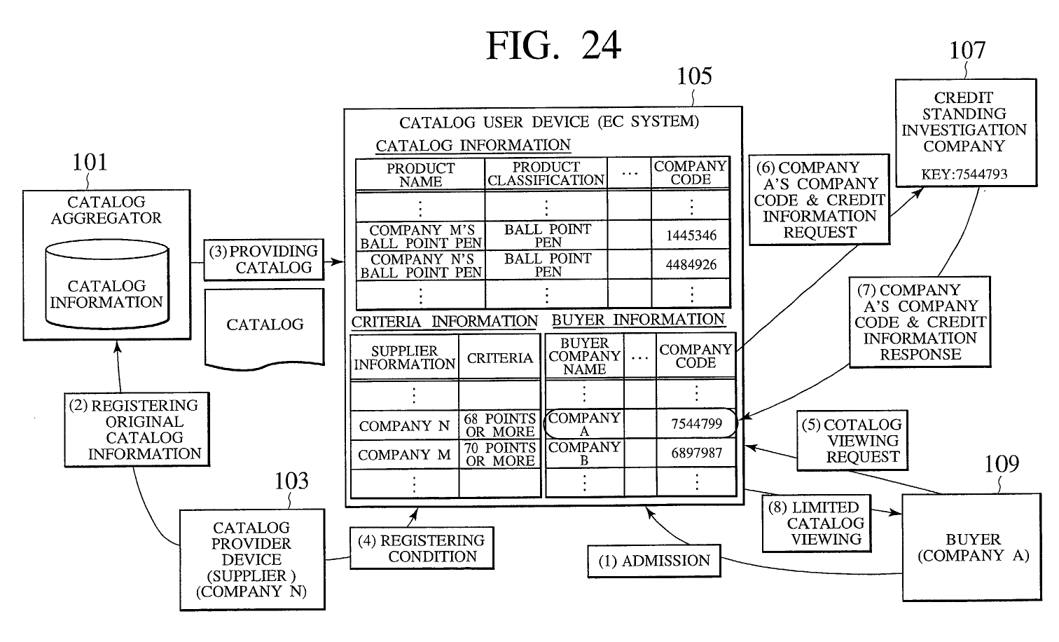

Referring now to FIG. 24 to FIG. 26, the sixth embodiment of an electronic catalog aggregation apparatus according to the present invention will be described in detail.

FIG. 24 shows an overall configuration of an electronic catalog system using an electronic catalog aggregation apparatus according to this embodiment. This electronic catalog system of FIG. 24 differs from that of the second embodiment in that the catalog provider device 103 which is a supplier can limit the buyer 109 who can view the catalog of the catalog provider device 103 by registering a condition with respect to the company credit information of the buyer 109 in advance such that only the buyer 109 who satisfies this condition is allowed to view the catalog of the catalog provider device 103. The other configuration and operation are basically the same as in the second embodiment and the same reference numerals are given to the same elements in the figures.

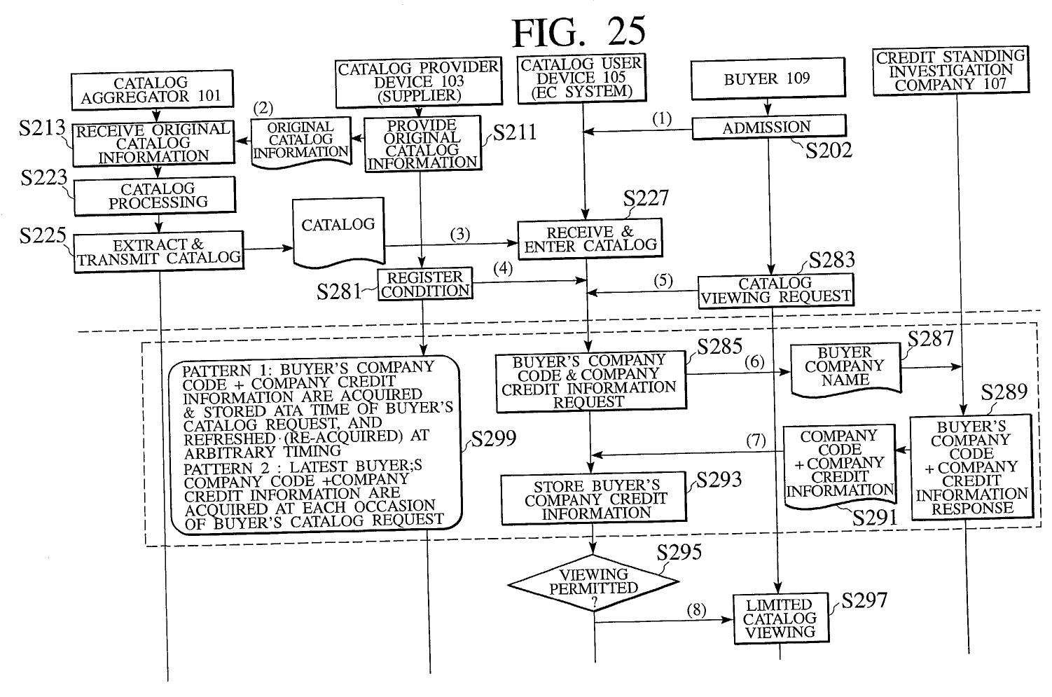

Now, the operation in this embodiment will be described in further detail with reference to FIG. 25.

In this embodiment, the buyer 109 is admitted to this system at the catalog user device 105 first (step S202). Then, the catalog provider device 103 provides the original catalog information to the catalog aggregator 101 (step S211). Upon receiving the original catalog information from the catalog provider device 103 (step S213), the catalog aggregator 101 processes this original catalog information into a prescribed common format (steps S223) and transmits the processed catalog information to the catalog user device 105 (step S225), and the catalog user device 105 receives the catalog information from the catalog aggregator 101 (step S227).

Next, the catalog provider device 103 registers a condition with respect to the buyer 109 for allowing viewing of the catalog provided by the catalog provider device 103, in the catalog user device 105 (step S281). After the catalog provider device 103 registered the condition on the company credit information or the like of the buyer 109 in the catalog user device 105 in this way, when the buyer 109 makes a catalog viewing request to the catalog user device 105 (step S283), the catalog user device 105 requests the company code and the company credit information of the buyer 109 to the credit standing investigation company 107, by using a key given by data such as a company name of the buyer 109 obtained at a time of the admission (steps S285, S287). In response to this request, the credit standing investigation company 107 returns the company code and the company credit information of the buyer 109 to the catalog user device 105 (steps S289, S291).

The catalog user device 105 then receives the company code and the company credit information of the buyer 109 from the credit standing investigation company 107. Here, there are two ways for realizing this processing for receiving the company code and the company credit information as indicated as pattern 1 and pattern 2 in the step S299 of FIG. 25. The pattern 1 is a method in which the catalog user device 105 stores the company code and the company credit information of the buyer 109 in the company credit information database 155 upon receiving these information, and the stored company code and company credit information are refreshed (re-acquired) in order to keep the company credit information up-to-date at arbitrary timing such as when a pre-registered constant period of time has elapsed or a manually specified timing. The pattern 2 is a method in which the latest company credit information of the buyer 109 is acquired at each occasion of the catalog viewing request by the buyer 109.

Namely, the catalog user device 105 stores the company code and the company credit information of the buyer 109 in the company credit information database 155 upon receiving these information from the credit standing investigation company 107 in the case of the pattern 1 (step S293), or this step S293 is skipped in the case of the pattern 2. Then, the received company credit information of the buyer 109 is compared with the condition on the company credit information or the like of the buyer 109 registered in the catalog user device 105 by the catalog provider device 103 at the step S281, to judge whether the viewing of the catalog is to be permitted to the buyer 109 or not (step S295). If the buyer 109 satisfies this condition, the viewing of the catalog of the catalog provider device 103 is permitted to the buyer 109, so that the buyer 109 can view the catalog of the catalog provider device 103 (step S297).

As described, in this embodiment, the catalog provider device 103 can limit the catalog viewing by the buyer 109 by registering the condition with respect to the buyer 109 in advance, such that the catalog provider device 103 can prevent receiving an order from a non-trustworthy buyer.

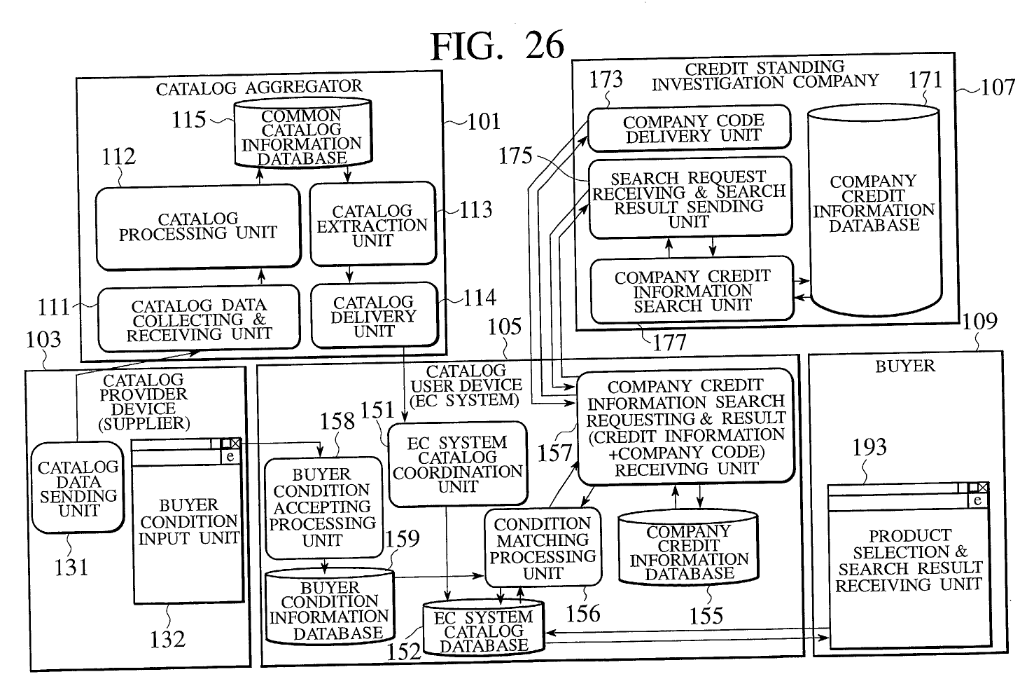

FIG. 26 shows a detailed configuration of the electronic catalog system of this embodiment. This configuration of FIG. 26 differs from that of FIG. 21 in that a buyer condition input unit 132 for entering the condition on buyers is provided at the catalog provider device 103, a buyer condition accepting processing unit 158 for accepting and processing this buyer condition and a buyer condition information database 159 for storing this buyer condition are provided in the catalog user device 105, and a product selection and search result receiving unit 193 is provided at the buyer 109. The other configuration and operation are the same as those of FIG. 21 and the same reference numerals are given for the same elements in the figures so that their description will be omitted here.

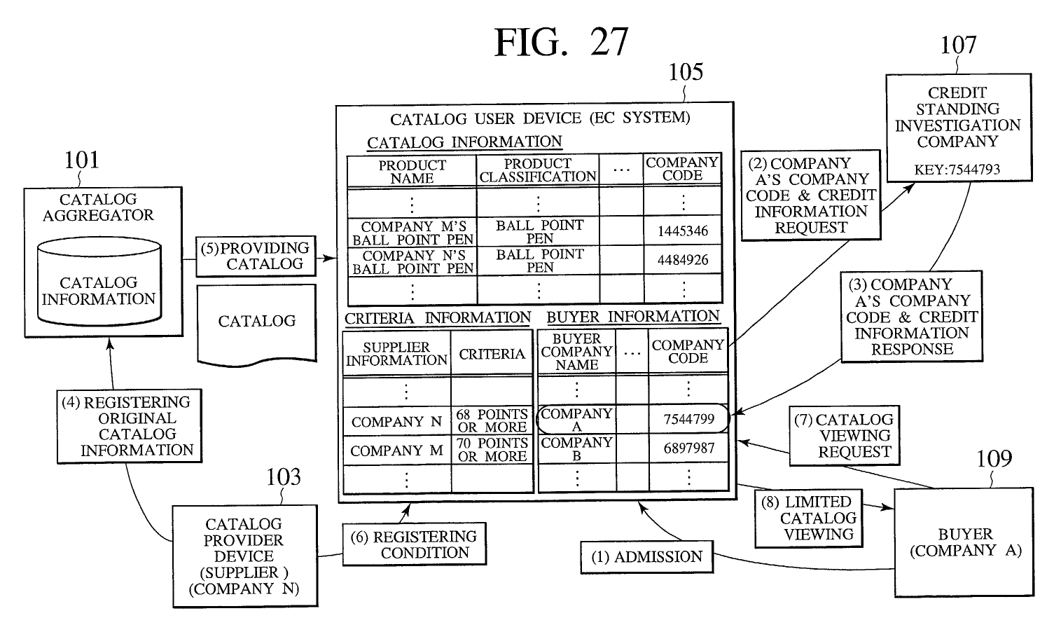

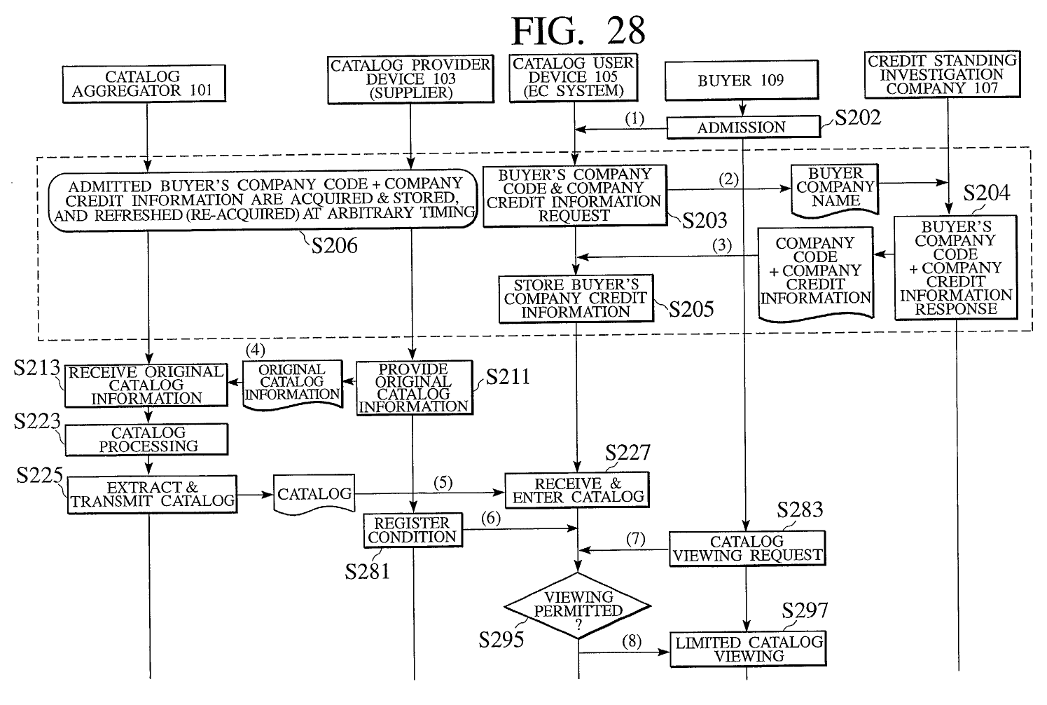

Referring now to FIG. 27 and FIG. 28, the seventh embodiment of an electronic catalog aggregation apparatus according to the present invention will be described in detail.

FIG. 27 shows an overall configuration of an electronic catalog system using an electronic catalog aggregation apparatus according to this embodiment. This electronic catalog system of FIG. 27 differs from that of the sixth embodiment in that the catalog user device 105 acquires the company code and the company credit information of the buyer 109 from the credit standing investigation company 107 immediately when the buyer 109 is admitted to this system at the catalog user device 105 and stores them in the company credit information database 155, and then the catalog provider device 103 registers the condition on the company credit information or the like of the buyer in the catalog user device 105. The other configuration and operation are the same as in the sixth embodiment.

Now, the operation in this embodiment will be described in further detail with reference to FIG. 28.

In this embodiment, when the buyer 109 is admitted to this system at the catalog user device 105 (step S202). the catalog user device 105 requests the company code and the company credit information of the buyer 109 to the credit standing investigation company 107 (step S203). In response to this request from the catalog user device 105, the credit standing investigation company 107 searches out and returns the company code and the company credit information of the buyer 109 to the catalog user device 105 (step S204). The catalog user device 105 then receives the company code and the company credit information of the buyer 109 from the credit standing investigation company 107, and stores them in the company credit information database 155 (step S205), and the stored company code and company credit information are refreshed (re-acquired) in order to keep the company credit information up-to-date at arbitrary timing as described above (step S206).

Then, the catalog provider device 103 provides the original catalog information to the catalog aggregator 101 (step S211). Upon receiving the original catalog information from the catalog provider device 103 (step S213), the catalog aggregator 101 processes the original catalog information into a prescribed common format (steps S223) and transmits this processed catalog information to the catalog user device 105 (step S225), and the catalog user device 105 receives the catalog information from the catalog aggregator 101 (step S227).

Next, the catalog provider device 103 registers a condition on the company credit information or the like of the buyer 109 in the catalog user device 105 (step S281). After the catalog provider device 103 registered the condition on the company credit information or the like of the buyer 109 in the catalog user device 105 in this way, when the buyer 109 makes a catalog viewing request to the catalog user device 105 (step S283), the catalog user device 105 compares the company credit information of the buyer 109 stored in advance in the company credit information database 155 with the condition on the company credit information or the like of the buyer 109 registered in the catalog user device 105 by the catalog provider device 103 at the step S281, to judge whether the viewing of the catalog is to be permitted to the buyer 109 or not (step S295). If the buyer 109 satisfies this condition, the viewing of the catalog of the catalog provider device 103 is permitted to the buyer 109, so that the buyer 109 can view the catalog of the catalog provider device 103 (step S297).

As described, in this embodiment, the catalog provider device 103 can limit the catalog viewing by the buyer 109 by registering the condition with respect to the buyer 109 in advance, such that the catalog provider device 103 can prevent receiving an order from a non-trustworthy buyer.

Note that a detailed configuration of the electronic catalog system of this embodiment is the same as that of FIG. 26 so that its description will be omitted here.

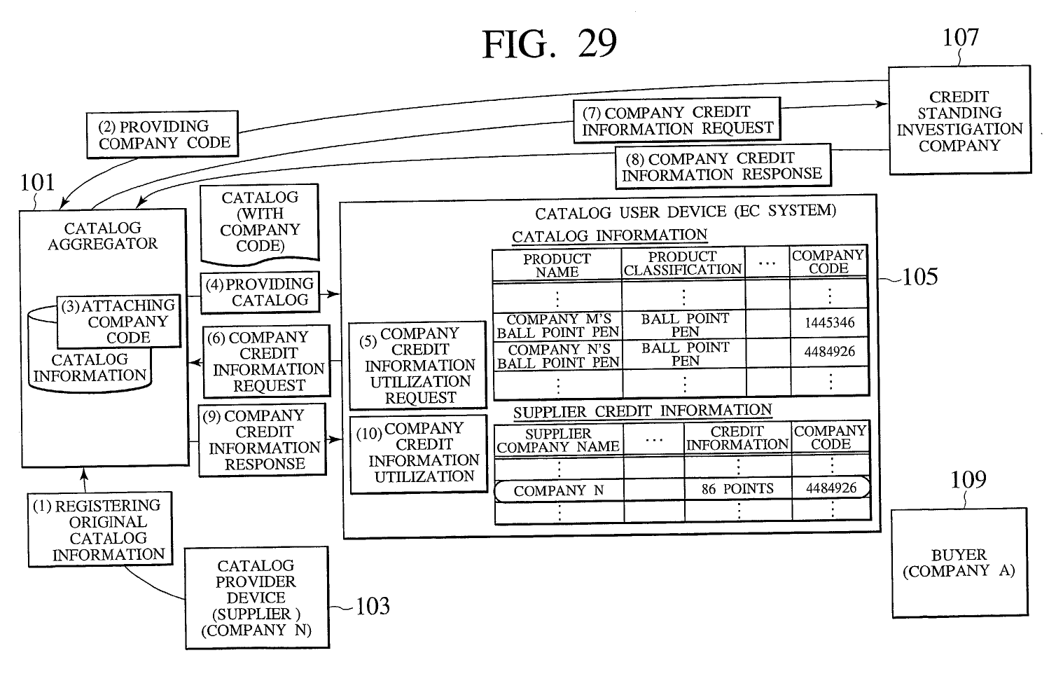

Referring now to FIG. 29 to FIG. 31, the eighth embodiment of an electronic catalog aggregation apparatus according to the present invention will be described in detail.

FIG. 29 shows an overall configuration of an electronic catalog system using an electronic catalog aggregation apparatus according to this embodiment. This electronic catalog system of FIG. 29 differs from those of the second to fifth embodiments in that the catalog aggregator 101 acquires the company credit information from the credit standing investigation company 107 instead of the catalog user device 105. The other configuration is basically the same as in the second to fifth embodiments.

Namely, in this embodiment, the catalog aggregator 101 attaches the company code to the catalog information provided from the catalog provider device 103, and requests and acquires the company credit information to be utilized by the catalog user device 105 on behalf of the catalog user device 105, such that the catalog user device 105 acquires the company credit information via the catalog aggregator 101. In this way, it becomes unnecessary for the catalog user device 105 to carry out a preparation of an interface with respect to the credit standing investigation company 107, a fee payment, and a contract. In addition, it becomes unnecessary for the credit standing investigation company 107 to manage a plurality of catalog user devices 105 to which the information is to be provided, so that fees can be collected collectively. Moreover, it is also possible to share the fees for collecting information from the credit standing investigation company 107 among a plurality of catalog user devices 105.

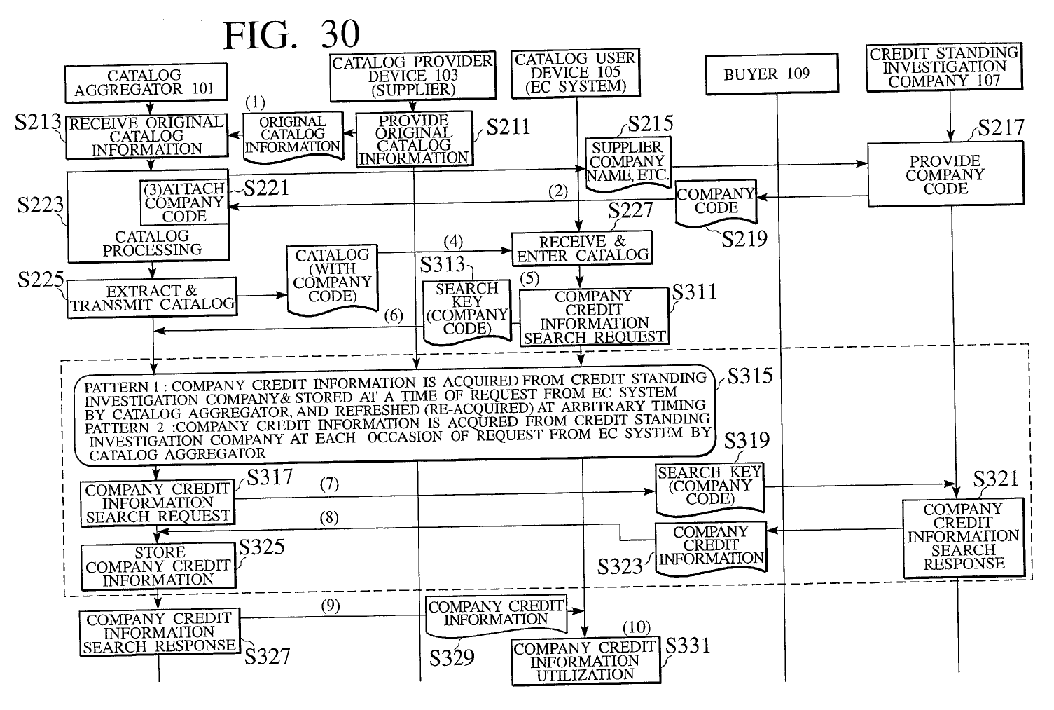

Now, the operation in this embodiment will be described in further detail with reference to FIG. 30.

In this embodiment, the catalog provider device 103 provides the original catalog information to be utilized at the catalog user device 105 to the catalog aggregator 101 (step S211). Upon receiving the original catalog information from the catalog provider device 103 (step S213), the catalog aggregator 101 sends a company name of the catalog provider device 103 which is a supplier to the credit standing investigation company 107 (step S215) and receives a company code from the credit standing investigation company 107 (steps S217, S219), and attaches this company code to the catalog information while processing the catalog information into a prescribed common format (steps S221, S223).

Then, the catalog aggregator 101 transmits the catalog information with the supplier's company code attached thereon to the catalog user device 105 (step S225), and the catalog user device 105 receives the catalog information with the company code and makes a setting convenient for the viewing by the buyer 109 (step S227).

Next, when a processing utilizing the company credit information occurs at the catalog user device 105, the catalog user device 105 makes a search request for the company credit information to the catalog aggregator 101 (step S311). and transmits the company code to the catalog aggregator 101 as a search key (step S313). Upon receiving the company code from the catalog user device 105, the catalog aggregator 101 acquires the company credit information from the credit standing investigation company 107 by using this company code and stores it (step S315).

Here, there are two ways for realizing this company credit information processing as indicated as pattern 1 and pattern 2 in the step S315 of FIG. 30. The pattern 1 is a method in which the catalog aggregator 101 acquires the company credit information from the credit standing investigation company 107 at a time of a request from the catalog user device 105 and stores it, and this stored company credit information is refreshed (re-acquired) in order to keep the company credit information up-to-date at arbitrary timing such as when a pre-registered constant period of time has elapsed or a manually specified timing. The pattern 2 is a method in which the latest company credit information is acquired at each occasion of the request from the catalog user device 105.

Namely, in this processing, the catalog aggregator 101 makes a search request for the company credit information requested from the catalog user device 105, to the credit standing investigation company 107 (step S317), and the company code is transmitted to the credit standing investigation company 107 as a search key (step S319). In response to this search request for the company credit information from the catalog aggregator 101, the credit standing investigation company 107 searches out the company credit information and transmits the searched out company credit information to the catalog aggregator 101 (steps S321, S323).

When the company credit information is received from the credit standing investigation company 107, the catalog aggregator 101 stores the received company credit information in the case of the pattern 1 described above (step S325), or this step S325 is skipped in the case of the pattern 2 described above, and the catalog aggregator 101 makes a response of the company credit information of the requested company to the catalog user device 105 and transmits this company credit information to the catalog user device 105 (steps S327, S329). Upon receiving the company credit information of the requested company from the catalog aggregator 101, the catalog user device 105 carries out the processing utilizing this company credit information (step S331).

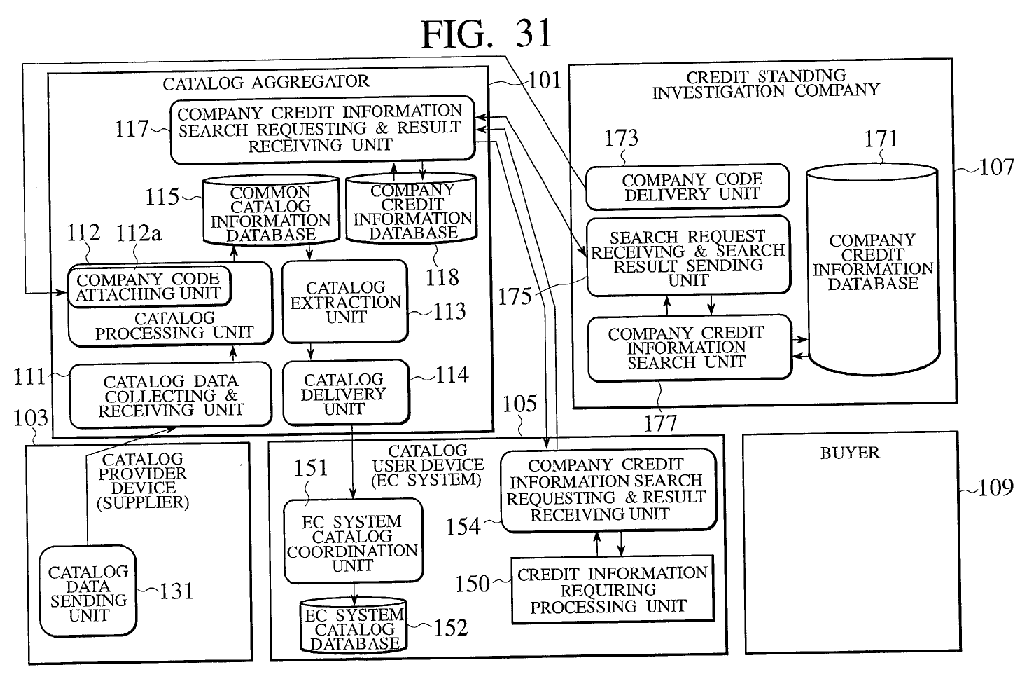

FIG. 31 shows a detailed configuration of the electronic catalog system of this embodiment. This configuration of FIG. 31 differs from that of FIG. 16 in that a company credit information search requesting and result receiving unit 117 for making the search request for the company credit information to the credit standing investigation company 107 and receiving the search result and a company credit information database 118 for storing the company credit information are provided in the catalog aggregator 101, and a credit information requiring processing unit 150 for carrying out a processing that requires the company credit information is provided in the catalog user device 105. The other configuration and operation are the same as those of FIG. 16 and the same reference numerals are given for the same elements in the figures so that their description will be omitted here.

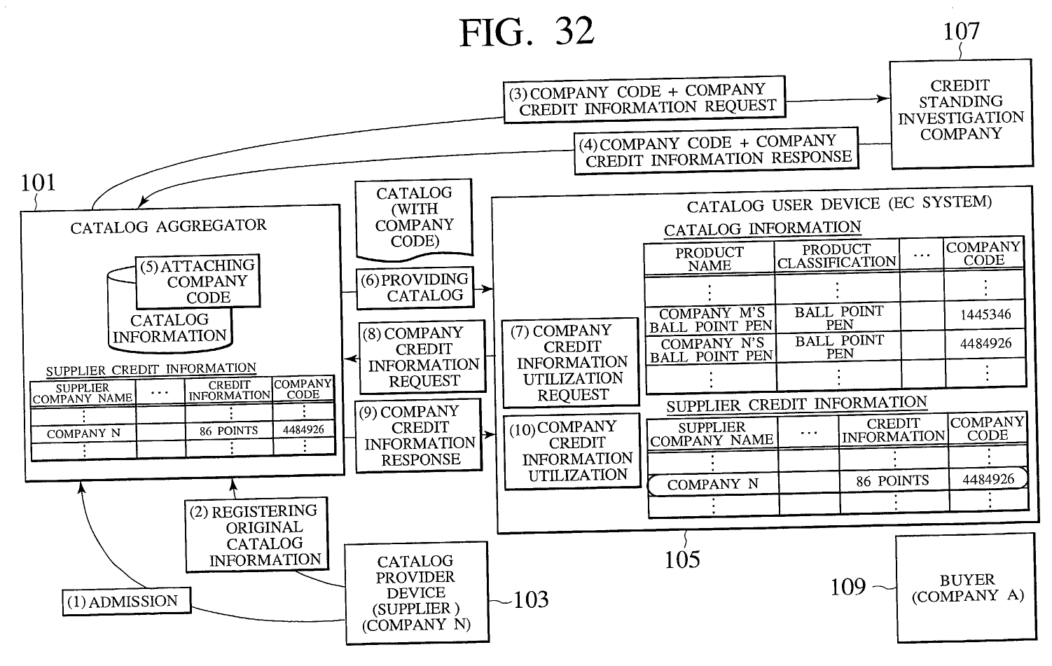

Referring now to FIG. 32 to FIG. 34, the ninth embodiment of an electronic catalog aggregation apparatus according to the present invention will be described in detail.

FIG. 32 shows an overall configuration of an electronic catalog system using an electronic catalog aggregation apparatus according to this embodiment. This electronic catalog system of FIG. 32 differs from that of the eighth embodiment in that the catalog aggregator 101 acquires the company credit information from the credit standing investigation company 107 and stores it before the company credit information is requested from the catalog user device 105 such that the catalog aggregator 101 immediately provides the stored company credit information to the catalog user device 105 when a request for the company credit information is received from the catalog user device 105. The other configuration and operation are the same as in the eighth embodiment.

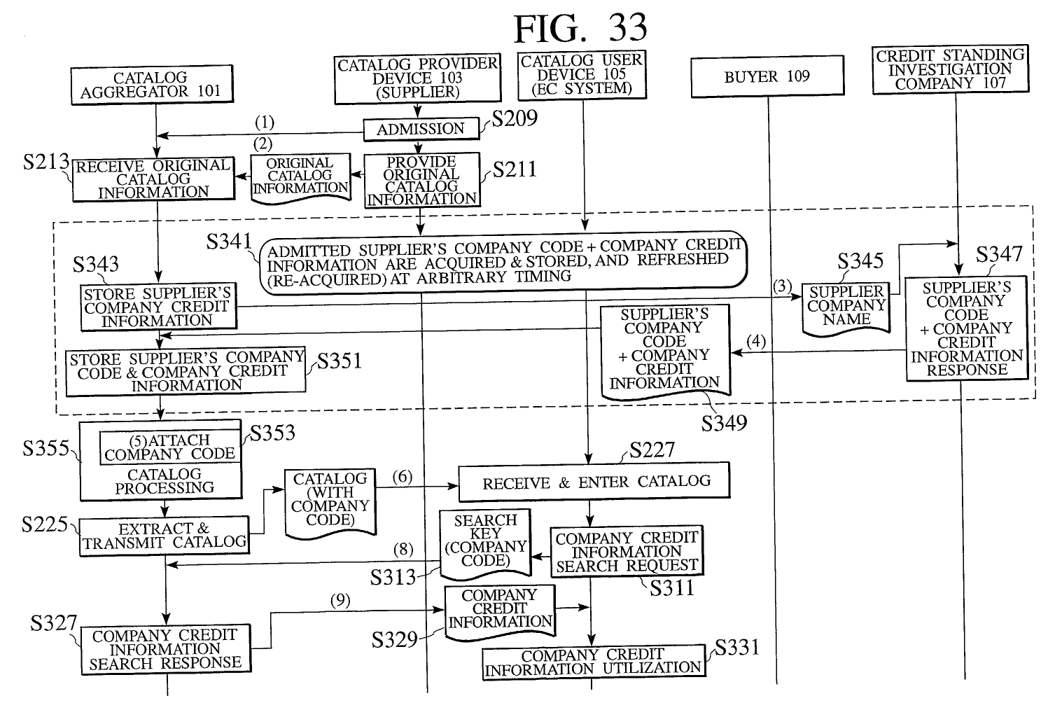

Now, the operation in this embodiment will be described in further detail with reference to FIG. 33.

In this embodiment, the catalog provider device 103 which is a supplier is admitted to this system first (step S209), and then the catalog provider device 103 provides the original catalog information to the catalog aggregator 101 (step S211) and the catalog aggregator 101 receives the original catalog information from the catalog provider device 103 (step S213).

Next, the catalog aggregator 101 acquires the company code and the company credit information of the admitted catalog provider device 103 from the credit standing investigation company 107 and stores them, and refreshes (re-acquires) the stored company code and company credit information at arbitrary timing (step S341).

More specifically, in this processing, the catalog aggregator 101 makes a request for the company code and the company credit information by using a company name of the catalog provider device 103 which is a supplier to the credit standing investigation company 107 (steps S343, S345). In response to the request from the catalog aggregator 101, the credit standing investigation company 107 returns the supplier's company code and company credit information to the catalog aggregator 101 (steps S347, S349).

When the supplier's company code and company credit information are received from the credit standing investigation company 107, the catalog aggregator 101 stores them (step S351).

Next, the catalog aggregator 101 attaches the company code to the catalog information received from the catalog provider device 103 earlier (step S353), processes this catalog information with the company code into a prescribed common format (step S355), and transmits it to the catalog user device 105 (step S225). The catalog user device 105 receives the catalog information with the company code transmitted from the catalog aggregator 101 (step S227).

Next, when a processing utilizing the company credit information occurs at the catalog user device 105, the catalog user device 105 makes a search request for the company credit information to the catalog aggregator 101 (step S311). and transmits the company code to the catalog aggregator 101 as a search key (step S313). In response to the search request for the company credit information from the catalog user device 105, the catalog aggregator 101 extracts the stored company credit information and returns this company credit information to the catalog user device 105 (steps S327, S329). Upon receiving the company credit information of the requested company from the catalog aggregator 101, the catalog user device 105 carries out the processing utilizing this company credit information (step S331).

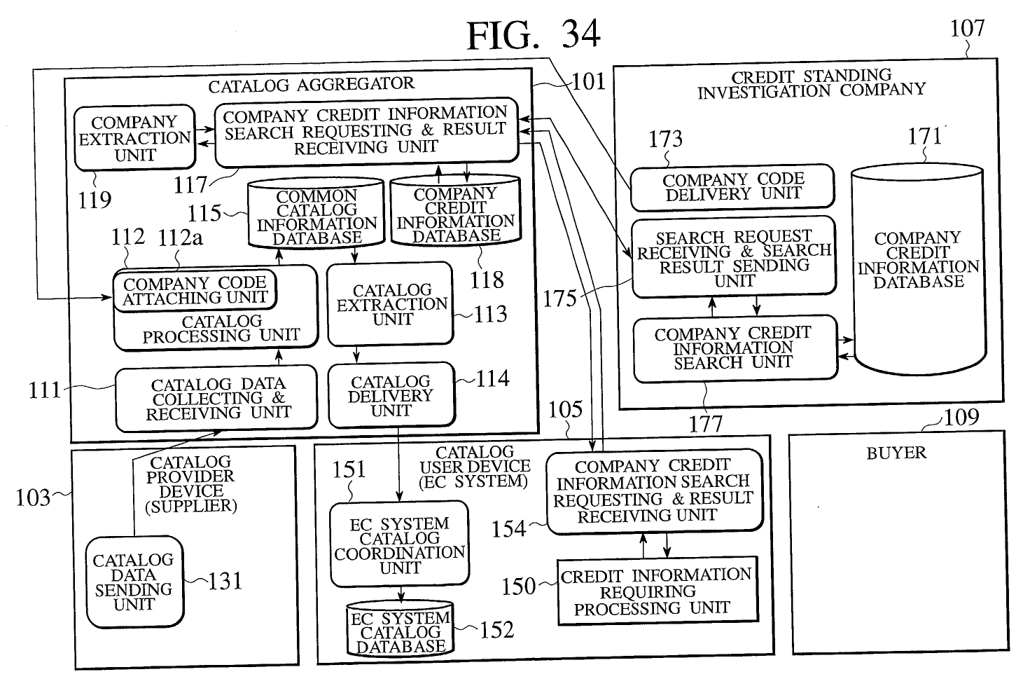

FIG. 34 shows a detailed configuration of the electronic catalog system of this embodiment. This configuration of FIG. 34 differs from that of FIG. 31 in that a company extraction unit 119 for carrying out a processing to extract a company whose company credit information is required is provided in the catalog aggregator 101. The other configuration and operation are the same as those of FIG. 31 and the same reference numerals are given for the same elements in the figures so that their description will be omitted here.

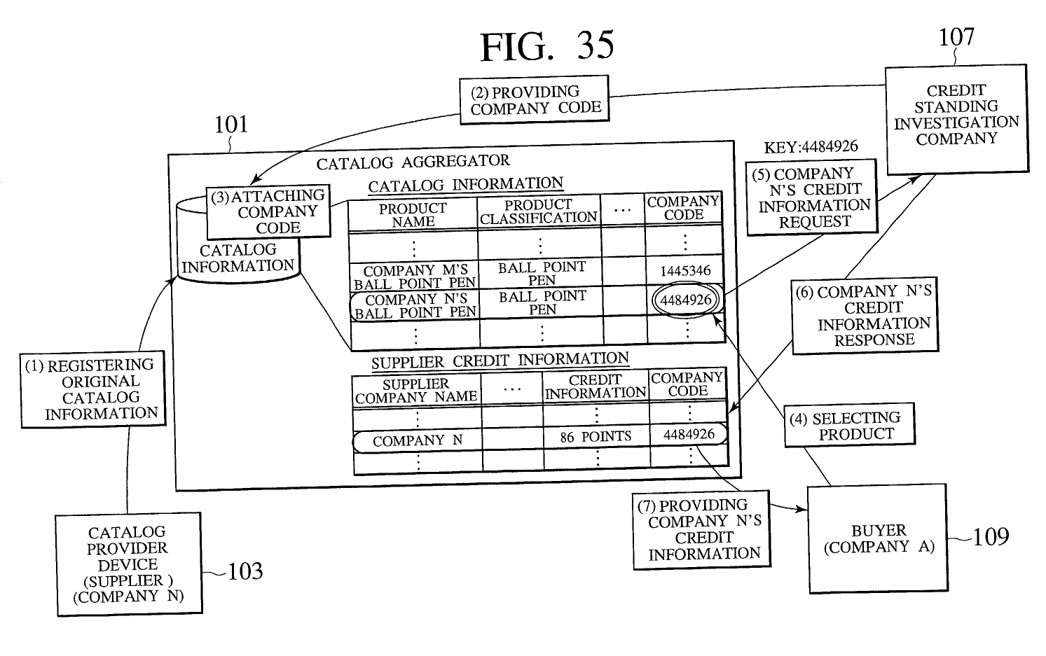

Referring now to FIG. 35 to FIG. 37, the tenth embodiment of an electronic catalog aggregation apparatus according to the present invention will be described in detail.

FIG. 35 shows an overall configuration of an electronic catalog system using an electronic catalog aggregation apparatus according to this embodiment. In this electronic catalog system of FIG. 35, a catalog aggregator 101 collects catalog information of a product from a catalog provider device 103 which is a supplier, and a buyer 109 views the catalog information collected at the catalog aggregator 101 by accessing the catalog aggregator 101 and selects a product to be purchased, where the catalog aggregator 101 attaches a company code of a product provider to the collected catalog information and enables the buyer 109 to view a company credit information of the catalog provider device 103 which is a product provider corresponding to the company code attached to the catalog information of a product to be selected and purchased by the buyer 109 when the buyer 109 views the catalog information on the catalog aggregator 101.

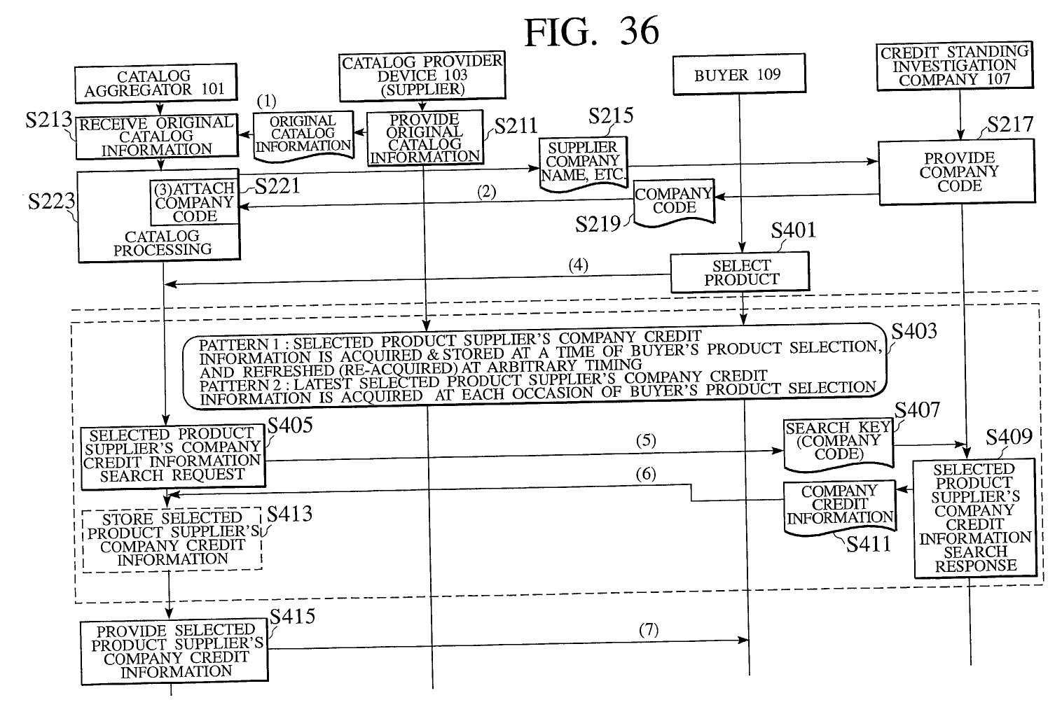

Now, the operation in this embodiment will be described in further detail with reference to FIG. 36.

In this embodiment, the catalog provider device 103 which is a supplier provides the original catalog information to the catalog aggregator 101 (step S211). Upon receiving the original catalog information from the catalog provider device 103 (step S213), the catalog aggregator 101 requests a company code of the supplier to the credit standing investigation company 107 by using a company name of the supplier or the like (step S215). In response to the request from the catalog aggregator 101, the credit standing investigation company 107 provides the company code (steps S217, S219). Upon receiving the company code from the credit standing investigation company 107, the catalog aggregator 101 attaches this company code to the catalog information received from the catalog provider device 103 (step S221) while processing the catalog information into a prescribed common format (step S223).

When the buyer 109 selects a product by referring to the catalog information on the catalog aggregator 101 (step S401), The catalog aggregator 101 acquires the company credit information of a supplier of the selected product from the credit standing investigation company 107 (step S403).

Here, there are two ways for realizing this company credit information processing as indicated as pattern 1 and pattern 2 in the step S403 of FIG. 36. The pattern 1 is a method in which the company credit information of the supplier of the selected product is acquired from the credit standing investigation company 107 at a time of a product selection by the buyer 109 and stored, and this stored company credit information is refreshed (re-acquired) at arbitrary timing. The pattern 2 is a method in which the latest company credit information of the supplier of the selected product is acquired at each occasion of the product selection by the buyer 109.

Namely, when the buyer 109 selects a product, the catalog aggregator 101 makes a search request for the company credit information of the supplier to the credit standing investigation company 107 by using the company code of the supplier attached to the catalog of the product selected by the buyer 109 as a search key (steps S405, S407). In response to the search request for the company credit information from the catalog aggregator 101, the credit standing investigation company 107 searches out the company credit information and transmits it to the catalog aggregator 101 (steps S409, S411).

When the company credit information of the supplier is received from the credit standing investigation company 107, the catalog aggregator 101 stores the received company credit information in the case of the pattern 1 described above (step S413), or this step S413 is skipped in the case of the pattern 2 described above, and then this company credit information of the supplier of the product selected by the buyer 109 is presented to the buyer 109 (step S415).

As a result, the buyer 109 can view the company credit information presented from the catalog aggregator 101 at a time of purchasing the product, so that the buyer 109 can avoid a risk of purchasing a product from a non-trustworthy supplier.

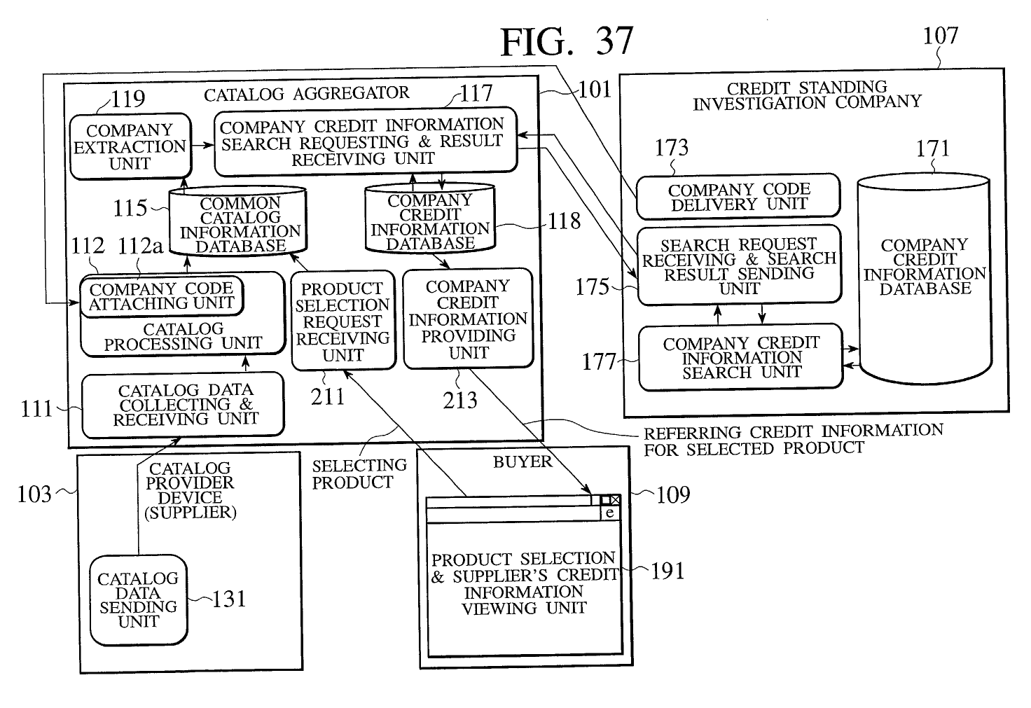

FIG. 37 shows a detailed configuration of the electronic catalog system of this embodiment. As shown in FIG. 37, this electronic catalog system comprises the catalog aggregator 101, the catalog provider device 103, the buyer 109 and the credit standing investigation company 107, where the catalog provider device 103, the buyer 109 and the credit standing investigation company 107 are the same as those of FIG. 16 and only the catalog aggregator 101 is different. Namely, in the catalog aggregator 101, the catalog extraction unit 113 and the catalog delivery unit 114 shown in FIG. 34 are removed while the catalog data collecting and receiving unit 111, the catalog processing unit 112, the common catalog information database 115, the company credit information search requesting and result receiving unit 117, the company credit information database 118 and the company extraction unit 119 are retained, and a product selection request receiving unit 211 for receiving a product selection request from the buyer 109 and a company credit information providing unit 213 for providing the company credit information to the buyer 109 are also provided.

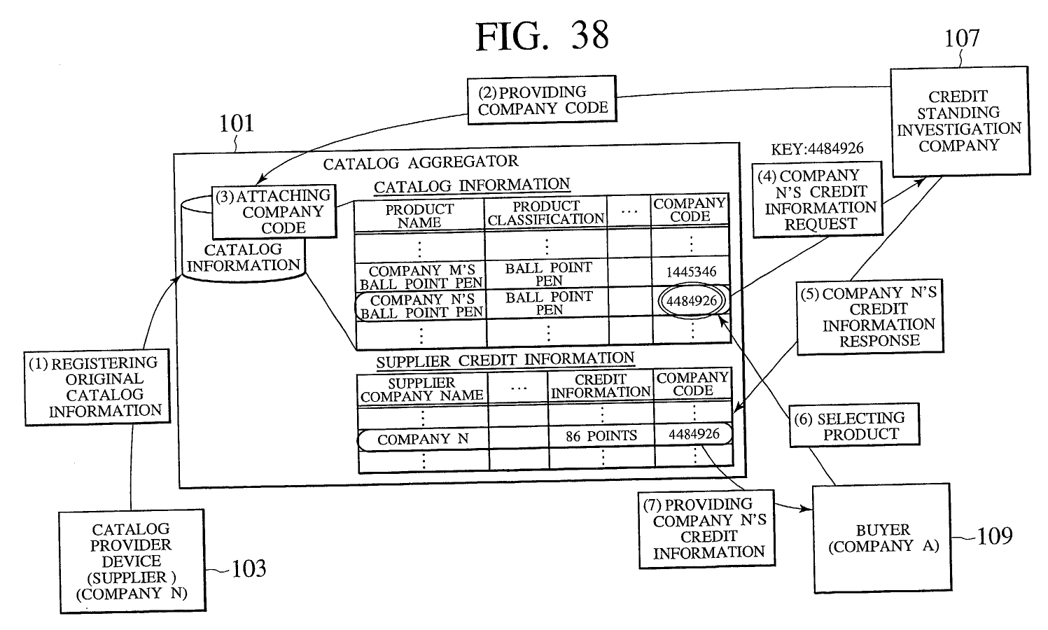

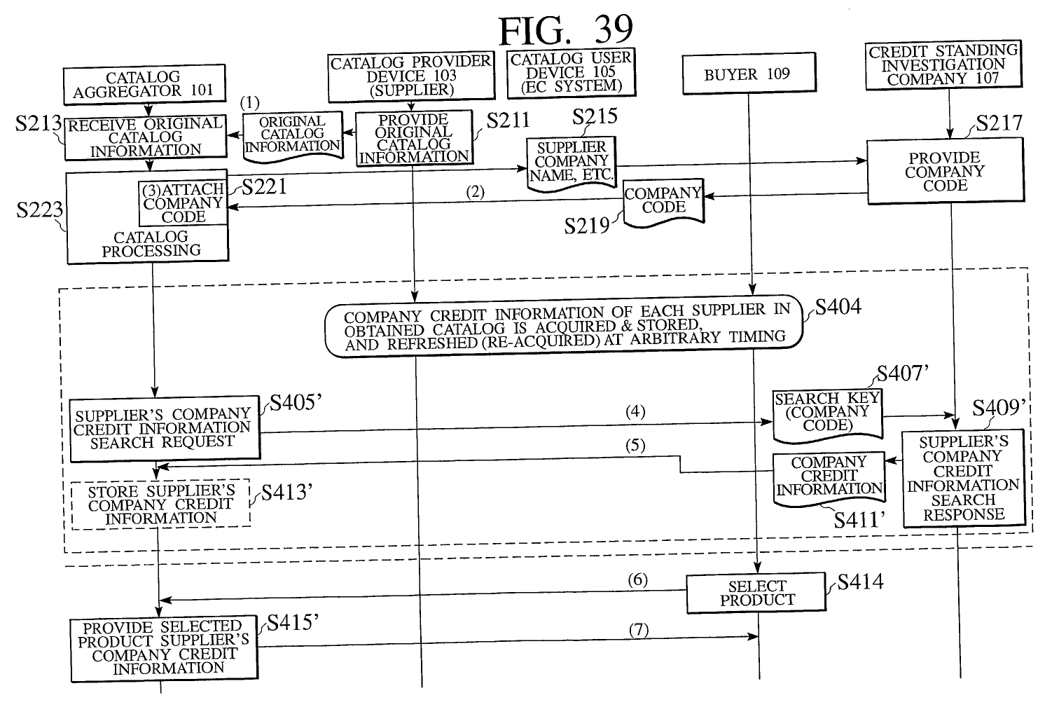

Referring now to FIG. 38 and FIG. 39, the eleventh embodiment of an electronic catalog aggregation apparatus according to the present invention will be described in detail.

FIG. 38 shows an overall configuration of an electronic catalog system using an electronic catalog aggregation apparatus according to this embodiment. This electronic catalog system of FIG. 38 differs from that of the tenth embodiment only in that the catalog aggregator 101 requests the company credit information of the supplier to the credit standing investigation company 107 and acquires it before the product selection by the buyer 109. The other configuration and operation are the same as in the tenth embodiment.

Now, the operation in this embodiment will be described in further detail with reference to FIG. 39.

In this embodiment, the catalog provider device 103 which is a supplier provides the original catalog information to the catalog aggregator 101 (step S211). Upon receiving the original catalog information from the catalog provider device 103 (step S213), the catalog aggregator 101 requests a company code of the supplier to the credit standing investigation company 107 by using a company name of the supplier or the like (step S215). In response to the request from the catalog aggregator 101, the credit standing investigation company 107 provides the company code (steps S217, S219). Upon receiving the company code from the credit standing investigation company 107, the catalog aggregator 101 attaches this company code to the catalog information received from the catalog provider device 103 (step S221) while processing the catalog information into a prescribed common format (step S223).

Next, the catalog aggregator 101 acquires the company credit information of the supplier in the obtained catalog from the credit standing investigation company 107 and stores it, and this stored company credit information is refreshed (re-acquired) at arbitrary timing (step S404). More specifically, the catalog aggregator 101 makes a search request for the company credit information of the supplier by using the company code attached to the catalog information as a search key (steps S405′, S407′). Upon receiving the search request for the company credit information from the catalog aggregator 101, the credit standing investigation company 107 returns the company credit information of the supplier to the catalog aggregator 101 in response to this request (steps S409′, S411′). The catalog aggregator 101 receives the company credit information of the supplier returned from the credit standing investigation company 107 and stores it (step S413′).

Next, when the buyer 109 selects a product by referring to the catalog information on the catalog aggregator 101 (step S414), the catalog aggregator 101 presents the company credit information of the supplier of the product selected by the buyer 109 to the buyer 109 (step S415).

As a result, the buyer 109 can view the company credit information presented from the catalog aggregator 101 at a time of purchasing the product, so that the buyer 109 can avoid a risk of purchasing a product from a non-trustworthy supplier.

Note that a detailed configuration of the electronic catalog system of this embodiment is the same as that of FIG. 37 so that its description will be omitted here.

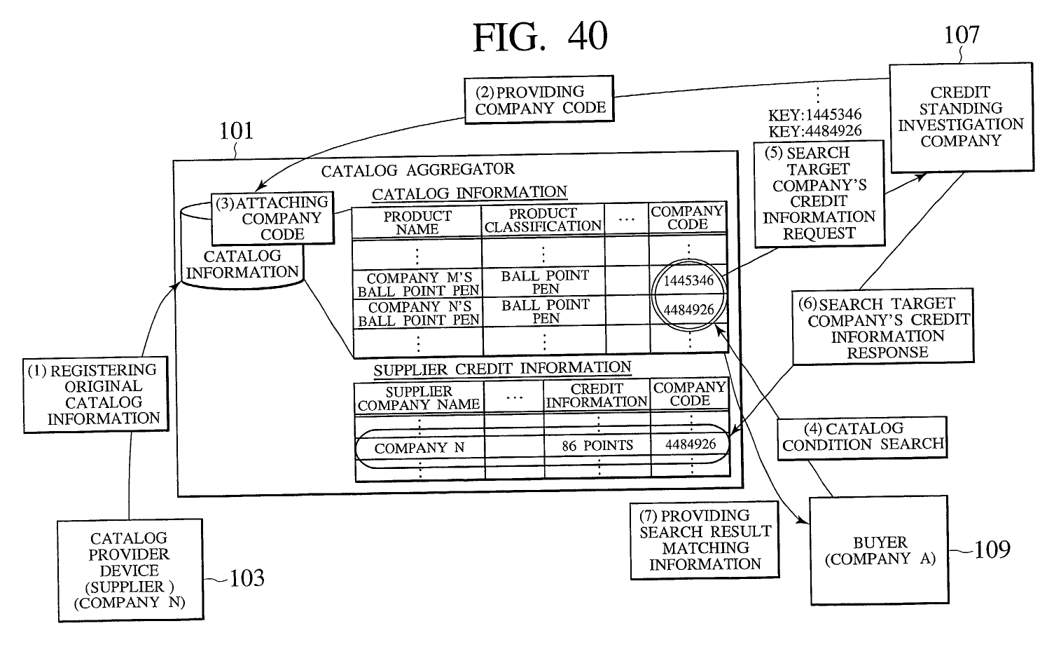

Referring now to FIG. 40 to FIG. 42, the twelfth embodiment of an electronic catalog aggregation apparatus according to the present invention will be described in detail.

FIG. 40 shows an overall configuration of an electronic catalog system using an electronic catalog aggregation apparatus according to this embodiment. In this electronic catalog system of FIG. 40, when the buyer 109 selects a product by viewing the catalog information on the catalog aggregator 101, the buyer 109 makes the selection by using a search condition that contains the company credit information of the supplier. In this case, a product matching with the search condition is searched according to the company credit information of the supplier corresponding to the company code attached to the catalog information, and this search result is presented to the buyer 109.

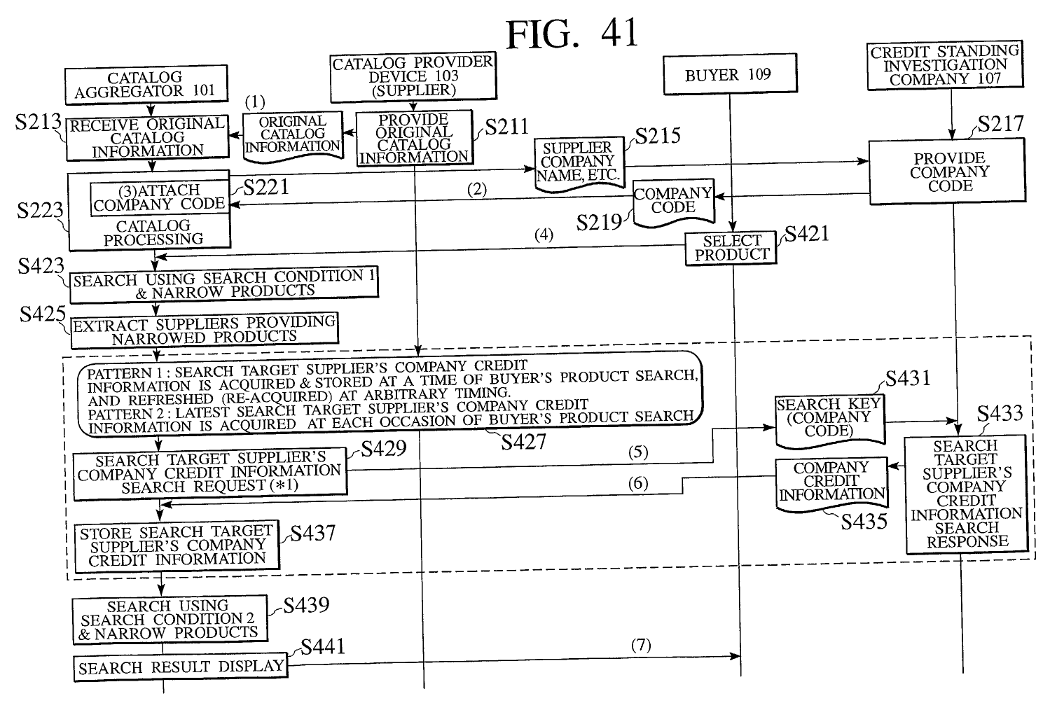

Now, the operation in this embodiment will be described in further detail with reference to FIG. 41.

In this embodiment, the catalog provider device 103 provides the original catalog information to the catalog aggregator 101 (step S211). Upon receiving the original catalog information from the catalog provider device 103 (step S213), the catalog aggregator 101 requests a company code of the supplier to the credit standing investigation company 107 by using a company name of the supplier or the like (step S215). In response to the request from the catalog aggregator 101, the credit standing investigation company 107 provides the company code (steps S217, S219). Upon receiving the company code from the credit standing investigation company 107, the catalog aggregator 101 attaches this company code to the catalog information received from the catalog provider device 103 (step S221) while processing the catalog information into a prescribed common format (step S223).

Next, the buyer 109 carries out a product search on the catalog aggregator 101 by entering the search condition into the catalog aggregator 101 (step S421).

Note that there are two types of the product search condition. Namely, the first search condition sets information in the product catalog existing in the catalog aggregator 101 such as a product name, a product specification and a maker name as the search condition, while the second search condition sets information existing in the credit standing investigation company 107 such as the company credit information of a supplier as the search condition. The first search condition is mainly utilized by the buyer 109 in narrowing down products to be purchased, and the second search condition is mainly utilized by the buyer 109 in verifying the safety of a transaction after the purchase.

In this embodiment, products are narrowed down first by carrying out a search using the first search condition (step S423) Then, the catalog provider devices 103 which are suppliers of the narrowed products are extracted (step S425). Then, the company credit information of each extracted catalog provider device 103 is acquired from the credit standing investigation company 107 and stored (step S427).

Here, there are two ways for realizing this company credit information processing as indicated as pattern 1 and pattern 2 in the step S427 of FIG. 41. The pattern 1 is a method in which the company credit information of each search target supplier is acquired from the credit standing investigation company 107 at a time of a product search by the buyer 109 and stored, and this stored company credit information is refreshed (re-acquired) in order to keep the company credit information up-to-date at arbitrary timing such as when a pre-registered constant period of time has elapsed or a manually specified timing. The pattern 2 is a method in which the latest company credit information of each search target supplier is acquired at each occasion of the product search by the buyer 109.

More specifically, in this processing, the catalog aggregator 101 first makes a search request for the company credit information of the catalog provider device 103 which is a search target supplier to the credit standing investigation company 107 (step S429), and the company code of the catalog provider device 103 is transmitted to the credit standing investigation company 107 as a search key (step S431). Upon receiving this search request, the credit standing investigation company 107 searches out the company credit information of the search target supplier and returns it to the catalog aggregator 101 (steps S433, S435). When the company credit information is received from the credit standing investigation company 107, the catalog aggregator 101 stores the received company credit information in the case of the pattern 1 described above (step S437), or this step S437 is skipped in the case of the pattern 2 described above, and then the catalog aggregator 101 narrows down products by carrying out the search using the company credit information as the second search condition (step S439). Namely, the company credit information of the second search condition is compared with the company credit information of each supplier and products of those suppliers that satisfy this second search condition are presented to the buyer 109 as a search result (step S441).

By searching a product by setting the company credit information of a supplier as a search condition as described above, the buyer 109 can avoid a risk of purchasing a product from a non-trustworthy supplier. It is also possible to avoid a tediousness associated with the purchasing product selection by narrowing down the candidate purchasing products in advance. In other words, the buyer 109 can eliminate products provided by non-trustworthy suppliers from candidate purchasing products at a time of the product selection.

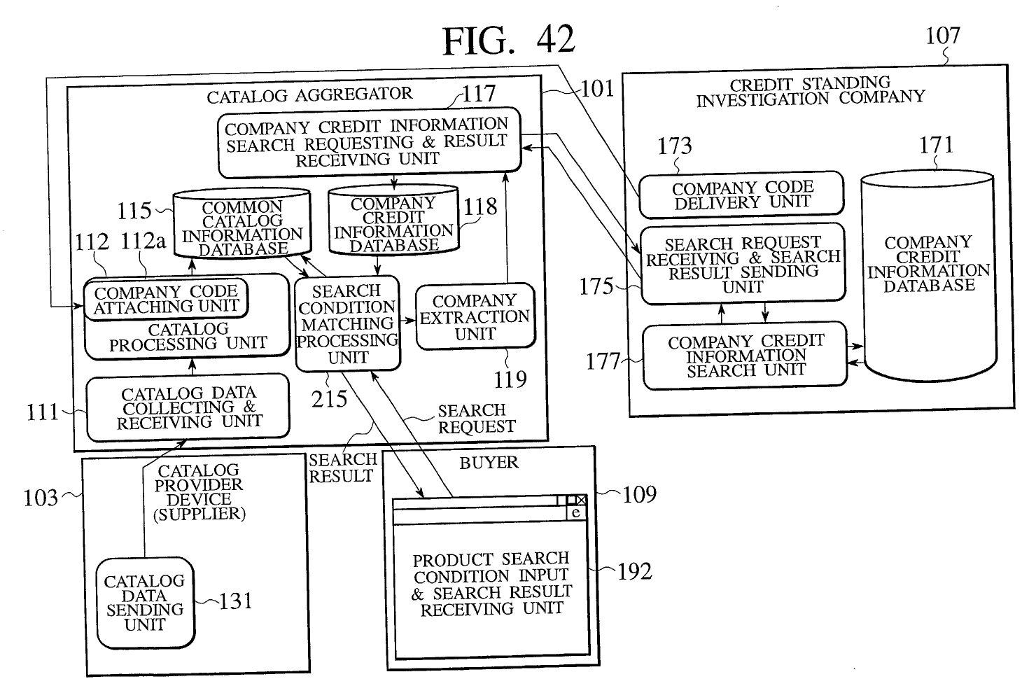

FIG. 42 shows a detailed configuration of the electronic catalog system of this embodiment. In this configuration of FIG. 42, the catalog aggregator 101 differs from that of FIG. 37 in that the product selection request receiving unit 211 and the company credit information providing unit 213 are removed while a search condition matching processing unit 215 is added instead, and the buyer 109 differs from that of FIG. 37 in that the product selection and supplier's credit information viewing unit 191 is removed and a product search condition input and search result receiving unit 192 is added instead. The other configuration and operation are the same as those of FIG. 37 and the same reference numerals are given for the same elements in the figures so that their description will be omitted here.

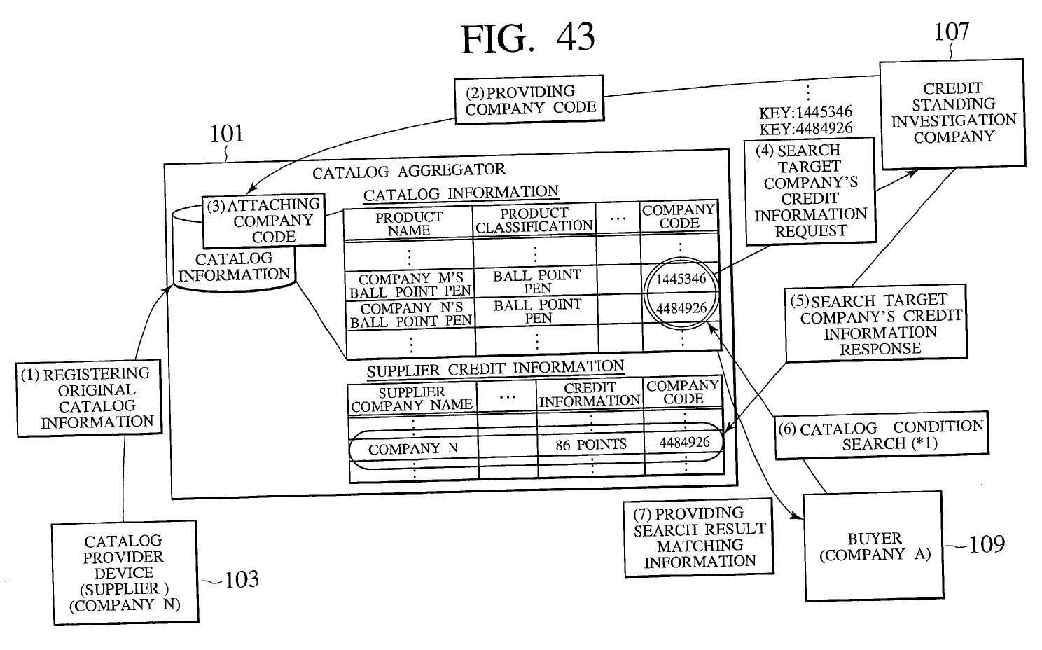

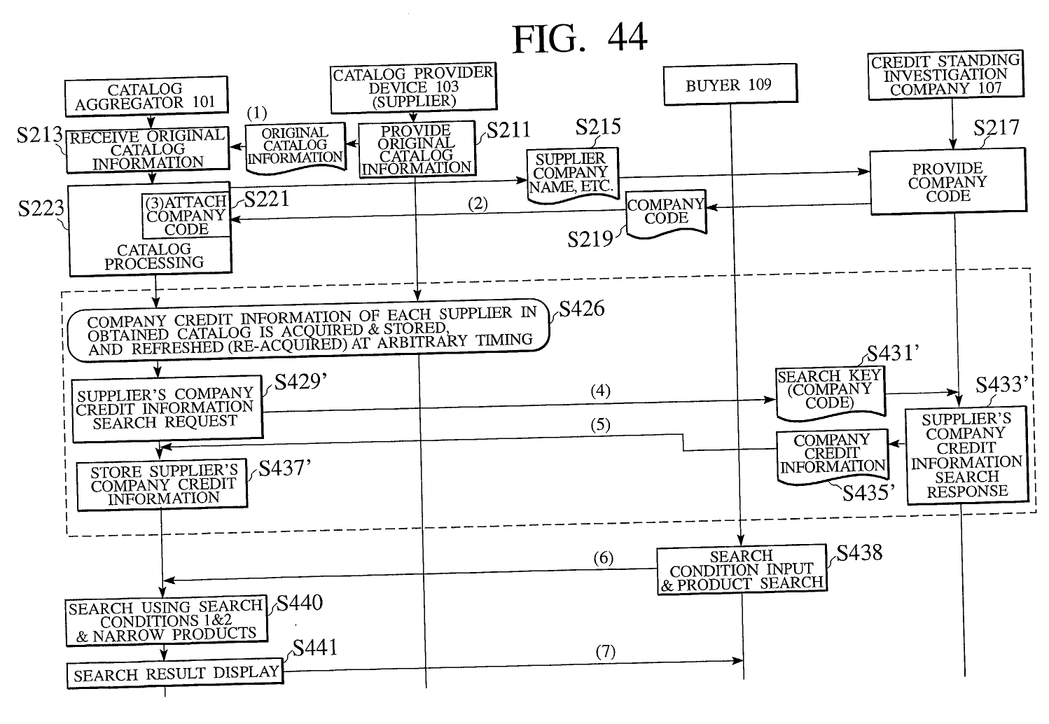

Referring now to FIG. 43 and FIG. 44, the thirteenth embodiment of an electronic catalog aggregation apparatus according to the present invention will be described in detail.

FIG. 43 shows an overall configuration of an electronic catalog system using an electronic catalog aggregation apparatus according to this embodiment. This electronic catalog system of FIG. 43 differs from that of the twelfth embodiment in that the catalog aggregator 101 acquires the company credit information of the supplier which is a search target company from the credit standing investigation company 107 in advance, before the buyer 109 carries out the product search on the catalog aggregator 101 by entering the search condition containing the company credit information of the supplier into the catalog aggregator 101, such that the search is carried out by obtaining the company credit information quickly in response to the input of the search condition containing the company credit information from the buyer 109.

Now, the operation in this embodiment will be described in further detail with reference to FIG. 44.

In this embodiment, the catalog provider device 103 provides the original catalog information to the catalog aggregator 101 (step S211). Upon receiving the original catalog information from the catalog provider device 103 (step S213), the catalog aggregator 101 requests a company code of the supplier to the credit standing investigation company 107 by using a company name of the supplier or the like (step S215). In response to the request from the catalog aggregator 101, the credit standing investigation company 107 provides the company code (steps S217, S219). Upon receiving the company code from the credit standing investigation company 107, the catalog aggregator 101 attaches this company code to the catalog information received from the catalog provider device 103 (step S221) while processing the catalog information into a prescribed common format (step S223).

Next, the catalog aggregator 101 acquires the company credit information of the supplier in the obtained catalog from the credit standing investigation company 107 and stores it, and this stored company credit information is refreshed (re-acquired) at arbitrary timing (step S426).

More specifically, the catalog aggregator 101 makes a search request for the company credit information of the supplier to the credit standing investigation company 107 by using the company code as a search key (steps S429′, S431′). Upon receiving the search request for the company credit information from the catalog aggregator 101, the credit standing investigation company 107 searches out the company credit information of the supplier in response to this search request and returns this company credit information to the catalog aggregator 101 (steps S433′, S435′). Upon receiving the company credit information of the supplier from the credit standing investigation company 107, the catalog aggregator 101 stores this company credit information (step S437′).

After the company credit information of the supplier is acquired from the credit standing investigation company 107 and stored at the catalog aggregator 101 as described above, the buyer 109 carries out a product search on the catalog aggregator 101 by entering the search condition into the catalog aggregator 101 (step S438).

Here there are two types of the product search condition. Namely, the first search condition sets information in the product catalog existing in the catalog aggregator 101 such as a product name, a product specification and a maker name as the search condition, while the second search condition sets information existing in the credit standing investigation company 107 such as the company credit information of a supplier as the search condition.

Upon receiving the search condition from the buyer 109, the catalog aggregator 101 narrows down products by carrying out the search using the first and second search conditions (step S440). Namely, the search conditions entered from the buyer 109 are compared with each stored company credit information and products of those suppliers that satisfy these search conditions are presented to the buyer 109 as a search result (step S441).

By searching a product by setting the company credit information of a supplier as a search condition as described above, the buyer 109 can avoid a risk of purchasing a product from a non-trustworthy supplier.

Note that a detailed configuration of the electronic catalog system of this embodiment is the same as that of FIG. 42 so that its description will be omitted here.

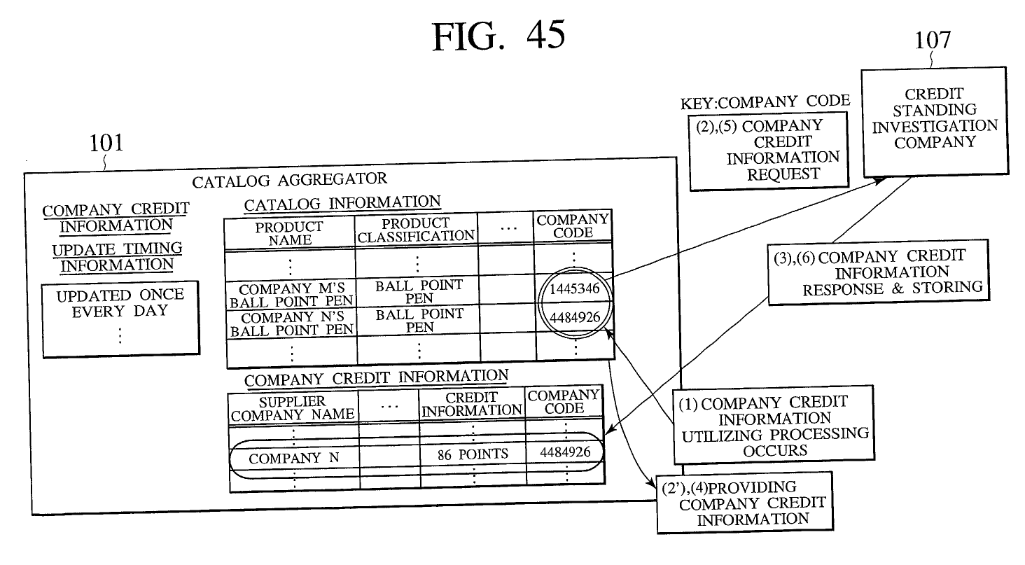

Referring now to FIG. 45 to FIG. 47, the fourteenth embodiment of an electronic catalog aggregation apparatus according to the present invention will be described in detail.

FIG. 45 shows an overall configuration of an electronic catalog system using an electronic catalog aggregation apparatus according to this embodiment. This electronic catalog system of FIG. 45 differs from that of the thirteenth embodiment in that the catalog aggregator 101 acquires the company credit information from the credit standing investigation company 107 by using the company code as a key and stores it in advance, and when a request for the company credit information occurs, the stored company credit information is read out and provided quickly in response to the request, such that the company credit information utilization fee to be paid to the credit standing investigation company 107 can be reduced.

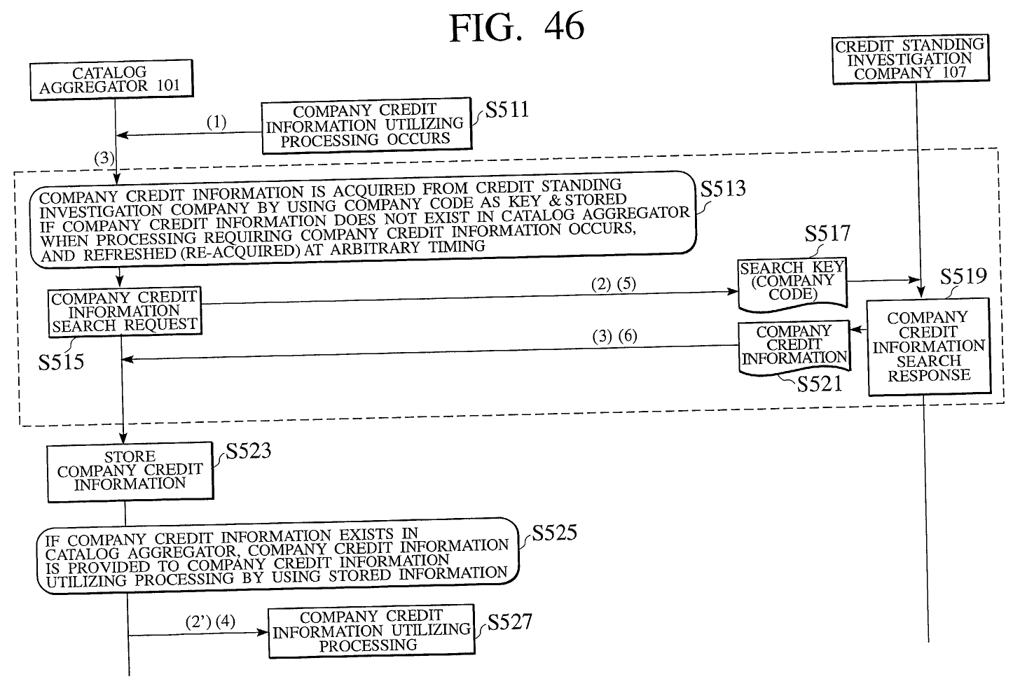

Now, the operation in this embodiment will be described in further detail with reference to FIG. 46.

In this embodiment, when a processing utilizing the company credit information occurs (step S511), if the company credit information does not exist in the catalog aggregator 101, the catalog aggregator 101 acquires the company credit information from the credit standing investigation company 107 and stores it, and this stored company credit information is refreshed (re-acquired) at arbitrary timing (step S513).

More specifically, in response to the occurrence of the company credit information utilizing processing, the catalog aggregator 101 makes a search request for the company credit information to the credit standing investigation company 107 by using the company code as a search key (steps S515, S517). In response to the search request for the company credit information from the catalog aggregator 101, the credit standing investigation company 107 searches out the company credit information and returns this company credit information to the catalog aggregator 101 (steps S519, S521). Upon receiving the company credit information from the credit standing investigation company 107, the catalog aggregator 101 stores this company credit information and provides this company credit information to the company credit information utilizing processing (step S523, S527).

Also, in the case where the company credit information is already stored in the catalog aggregator 101, this stored company credit information is provided to the company credit information utilizing processing (step S525, S527). Note that there can be cases where the company credit information utilizing processing occurs as an internal processing within the catalog aggregator 101, as well as the other cases.

By storing the company credit information in the catalog aggregator 101 and re-utilizing it in this way, it becomes possible to respond to the company credit information utilizing processing quickly, and the company credit information utilization fees to be paid to the credit standing investigation company 107 can be reduced. In addition, it is possible to avoid acquiring the unnecessary company credit information, compared with the case of providing the company credit information off-line.

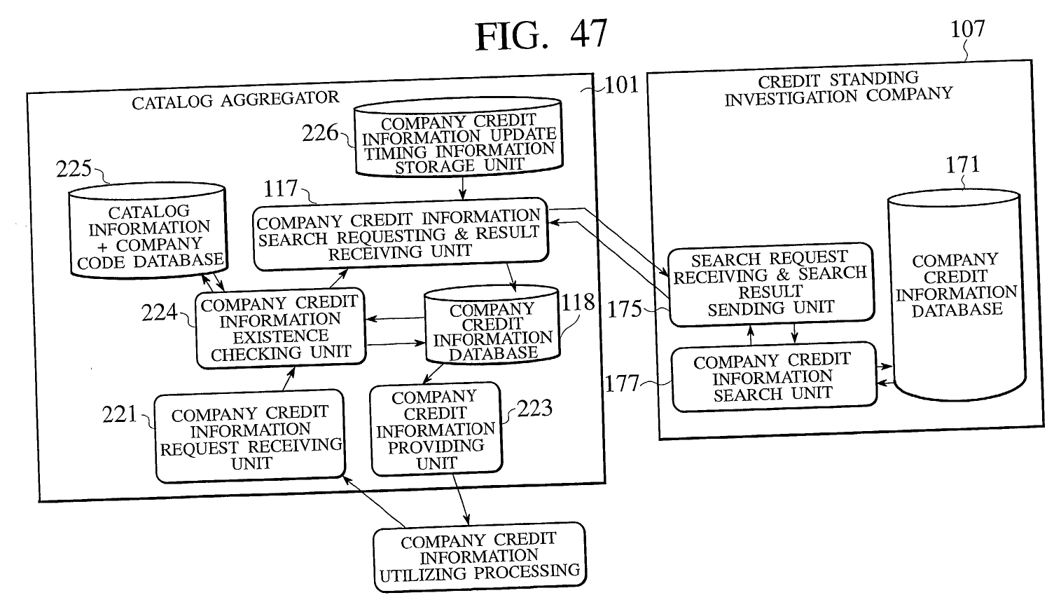

FIG. 47 shows a detailed configuration of the electronic catalog system of this embodiment. In this electronic catalog system of FIG. 47, the catalog aggregator 101 has, in addition to the company credit information search requesting and result receiving unit 117 and the company credit information database 118, a company credit information request receiving unit 221 for receiving a request for the company credit information, a company credit information providing unit 223 for providing the company credit information to the company credit information utilizing processing, a company credit information existence checking unit 224 for checking whether the company credit information exists in the company credit information database 118 or not, a catalog information with company code database 225 for storing the catalog information and the company code, and a company credit information update timing information storage unit 226 for setting a company credit information update timing indicating that the company credit information should be updated per how many accesses or in how many hours in order to update the company credit information stored in the company credit information database 118. Also, the credit standing investigation company 107 has the company credit information database 171, the search request receiving and search result sending unit 175, and the company credit information search unit 177.

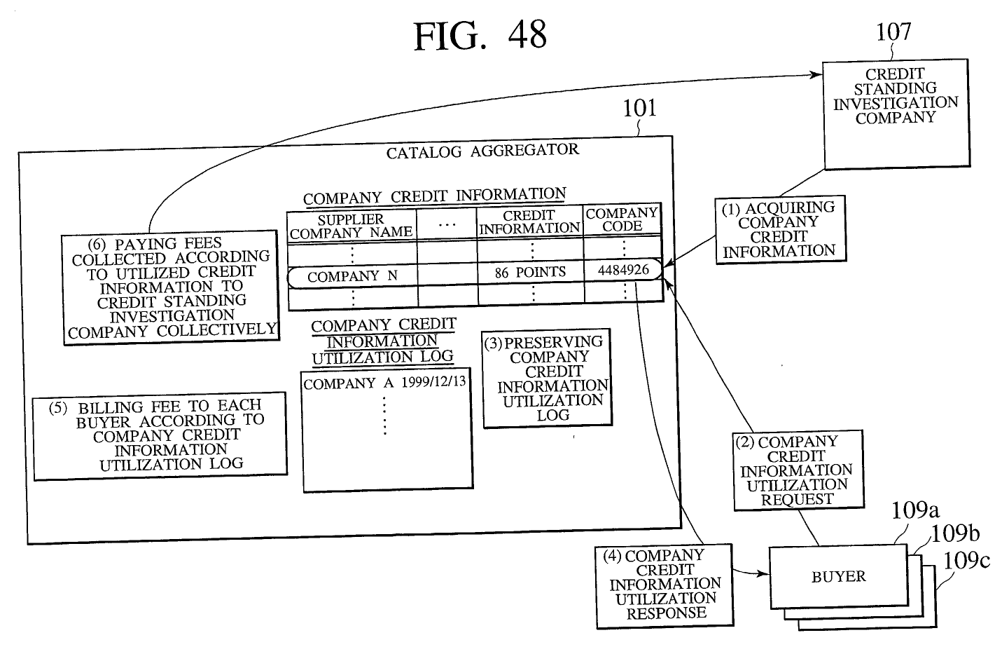

Referring now to FIG. 48 to FIG. 50, the fifteenth embodiment of an electronic catalog aggregation apparatus according to the present invention will be described in detail.

FIG. 48 shows an overall configuration of an electronic catalog system using an electronic catalog aggregation apparatus according to this embodiment. In this electronic catalog system of FIG. 48, the catalog aggregator 101 acquires the company credit information from the credit standing investigation company 107 and stores it in advance, and in response to a request for the company credit information from the buyer 109, the stored company credit information is read out and provided while a log of the request for the company credit information is preserved for each buyer 109, such that the company credit information utilization fee is billed to the buyer 109 according to the preserved log information while the company credit information utilization fees to be paid to the credit standing investigation company 107 are paid collectively.

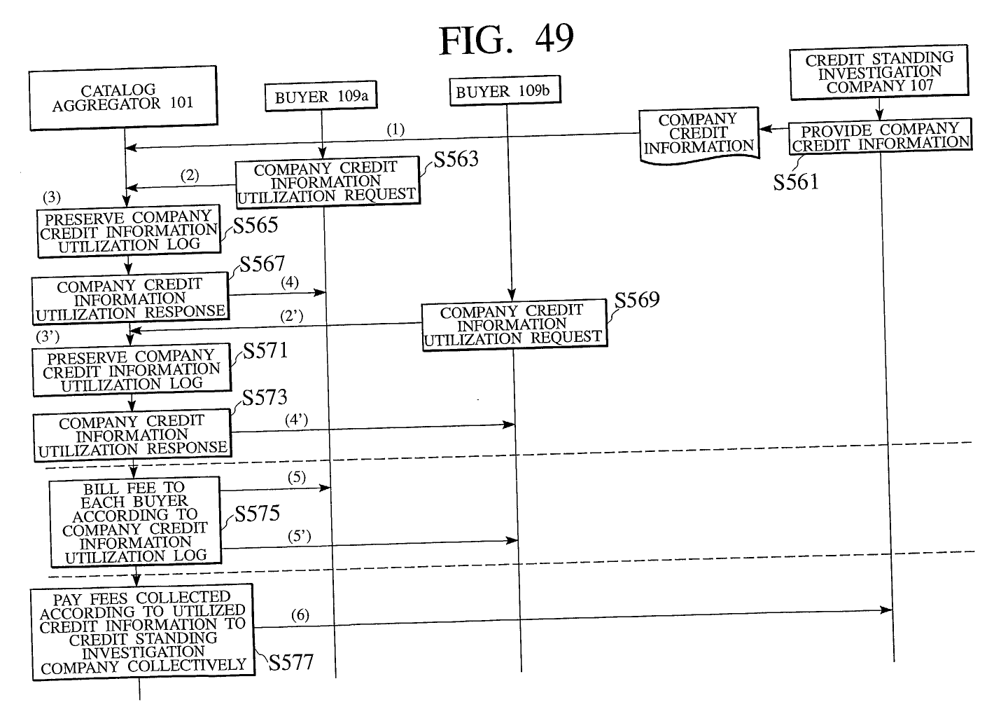

Now, the operation in this embodiment will be described in further detail with reference to FIG. 49.

In this embodiment, the catalog aggregator 101 acquires the company credit information from the credit standing investigation company 107 (step S561), and one buyer 109a transmits the company credit information utilization request to the catalog aggregator 101 (step S563). Note that a requestor is assumed to be the buyer 109 here, but a requester is not necessarily limited to the buyer 109 and can be any entity which utilizes the company credit information.

Here, in the operation of charge billing to a product provider, the charge billing processing settlement can be made at each occurrence of an access to the company credit information database, or a permitted number of accesses can be determined in advance according to an amount prepaid by a product provider such that the permitted number is decreased whenever an access is made.

Also, in the operation of charge billing to a viewing requestor, the charge billing processing settlement can be made at each occurrence of an access to the company credit information database. or a permitted number of accesses can be determined in advance according to an amount prepaid by a viewing requestor such that the permitted number is decreased whenever an access is made.

The catalog aggregator 101 preserves the company credit information utilization log of the buyer 109a (step S565), and transmits the company credit information stored in the catalog aggregator 101 to the buyer 109a (step S567).

Also, another buyer 109b transmits a company credit information utilization request to the catalog aggregator 101 (step S569). In response, the catalog aggregator 101 similarly preserves the company credit information utilization log of the buyer 109b (step S571), and transmits the company credit information stored in the catalog aggregator 101 to the buyer 109b (step S573).

Next, the catalog aggregator 101 bills the company credit information utilization fee to each buyer 109 according to the company credit information utilization log (step S575). Also, the catalog aggregator 101 pays the information utilization fees according to the amount of the company credit information utilized to the credit standing investigation company 107 collectively (step S577). As a result, it becomes unnecessary for the credit standing investigation company 107 to collect fees individually, so that the electronic catalog system can be made more efficient.

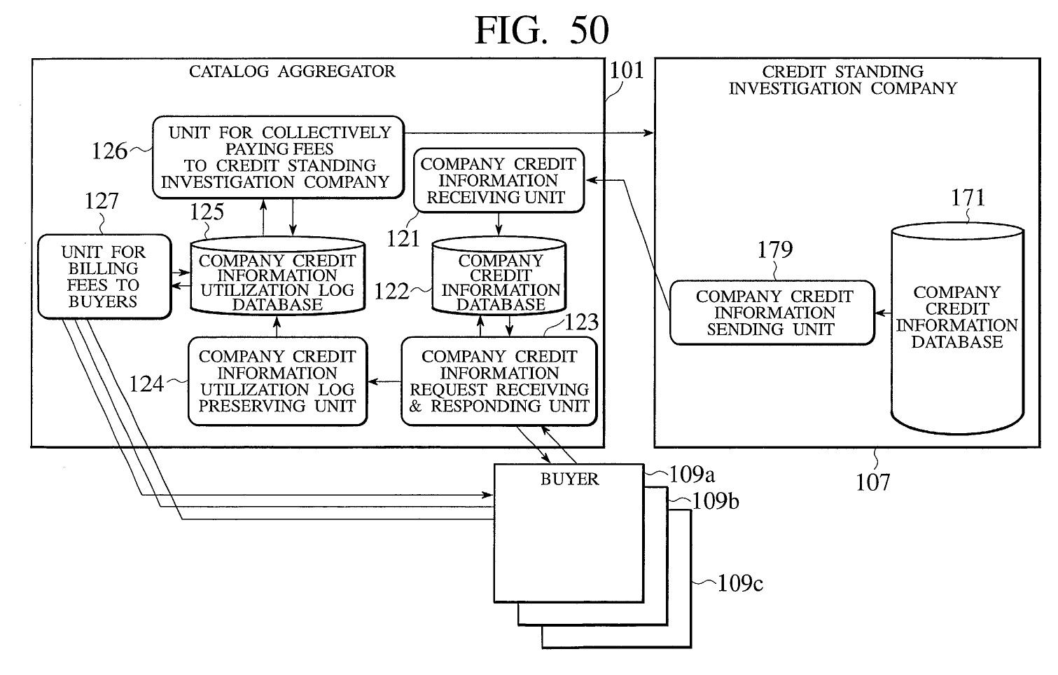

FIG. 50 shows a detailed configuration of the electronic catalog system of this embodiment. In this electronic catalog system of FIG. 50, the catalog aggregator 101 has a company credit information receiving unit 121 for receiving the company credit information from the credit standing investigation company 107, a company credit information database 122 for storing the received company credit information, a company credit information request receiving and responding unit 123 for receiving a request for the company credit information from the buyer 109 and responding by transmitting the company credit information to the buyer 109, a company credit information utilization log preserving unit 124 for preserving the company credit information utilization log, a company credit information utilization log database 125 for storing the company credit information utilization log, a unit 126 for collectively paying fees to the credit standing investigation company. and a unit 127 for billing fees to the buyers 109. Also, the credit standing investigation company 107 has the company credit information database 171 and a company credit information sending unit 179 for sending the company credit information to the catalog aggregator 101.

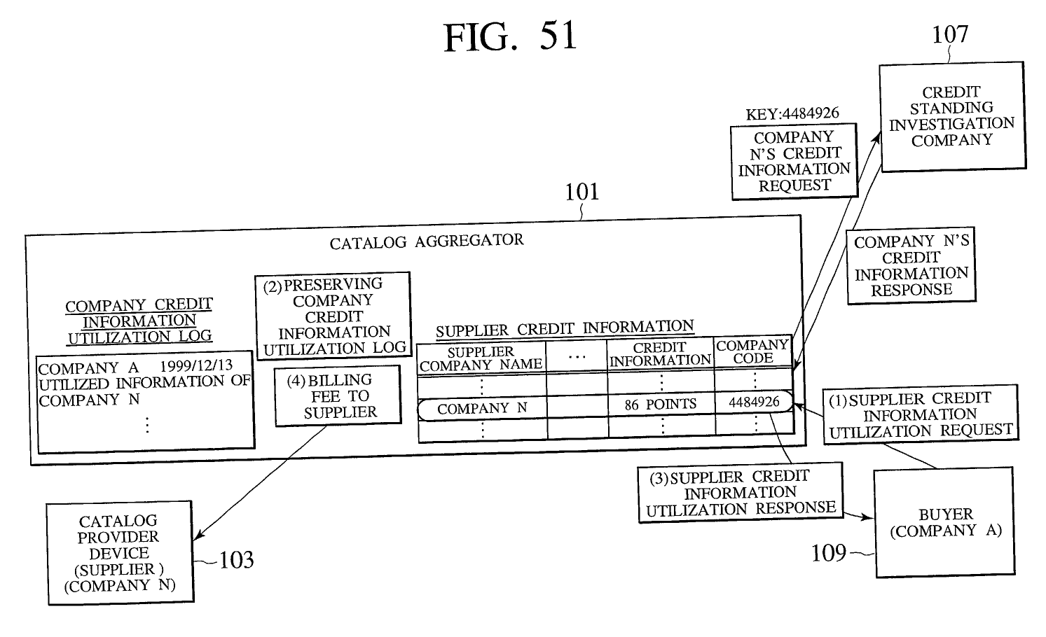

Referring now to FIG. 51 to FIG. 53, the sixteenth embodiment of an electronic catalog aggregation apparatus according to the present invention will be described in detail.

FIG. 51 shows an overall configuration of an electronic catalog system using an electronic catalog aggregation apparatus according to this embodiment. In this electronic catalog system of FIG. 51, the catalog aggregator 101 acquires the company credit information of the catalog provider device 103 requested by the buyer 109 from the credit standing investigation company 107 and provides it to the buyer 109, while a company credit information acquisition log is preserved for each buyer 109, such that the utilization fee of the company credit information utilized by the buyer 109 is billed to the catalog provider device 103 according to the preserved log information. In other words, the when the buyer 109 purchases a product of the catalog provider device 103 which is a supplier as a result of referring to the company credit information, the company credit information utilization fee is billed to this supplier.

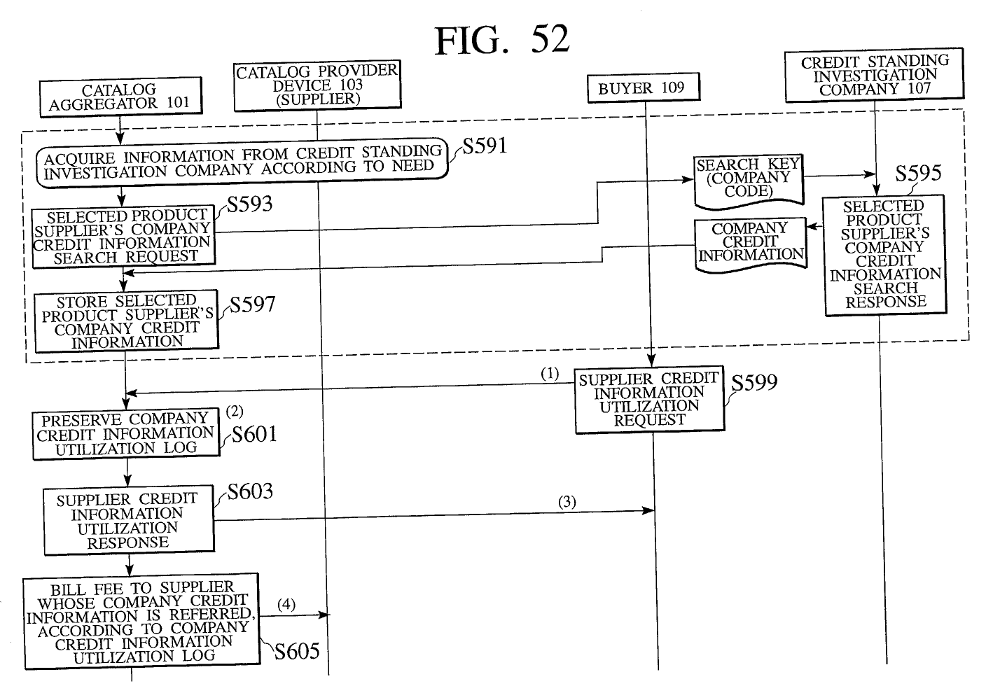

Now, the operation in this embodiment will be described in further detail with reference to FIG. 52.

In this embodiment, the catalog aggregator 101 acquires the company credit information from the credit standing investigation company 107 according to the need (step S591). More specifically, the catalog aggregator 101 makes a search request for the company credit information of the catalog provider device 103 which is a supplier of a product selected by the buyer 109 to the credit standing investigation company 107 (step S593). This search request is made by using the company code of the catalog provider device 103 as a search key. Upon receiving the search request from the catalog aggregator 101, the credit standing investigation company 107 searches out the company credit information of the catalog provider device 103 and transmits it to the catalog aggregator 101 in response to this request (step S595). The catalog aggregator 101 stores the company credit information of the catalog provider device 103 received from the credit standing investigation company 107 (step S597).

Next, when the buyer 109 makes a utilization request for the company credit information of the catalog provider device 103 to the catalog aggregator 101 (step S599), the catalog aggregator 101 preserves the utilization log of the company credit information utilized by the buyer 109a (step S601), and transmits the company credit information to the buyer 109 in response to the company credit information utilization request made by the buyer 109 (step S603). Then, the catalog aggregator 101 refers to the utilization log of the company credit information utilized by the buyer 109, and bills the utilization fee of the company credit information to the catalog provider device 103 which is a supplier whose company credit information was requested by the buyer 109 (step S605).

As a result, it becomes possible to bill the information utilization fee not only to the buyer 109 who requested the company credit information but also to the catalog provider device 103 which is a supplier whose company credit information was requested by the buyer 109.

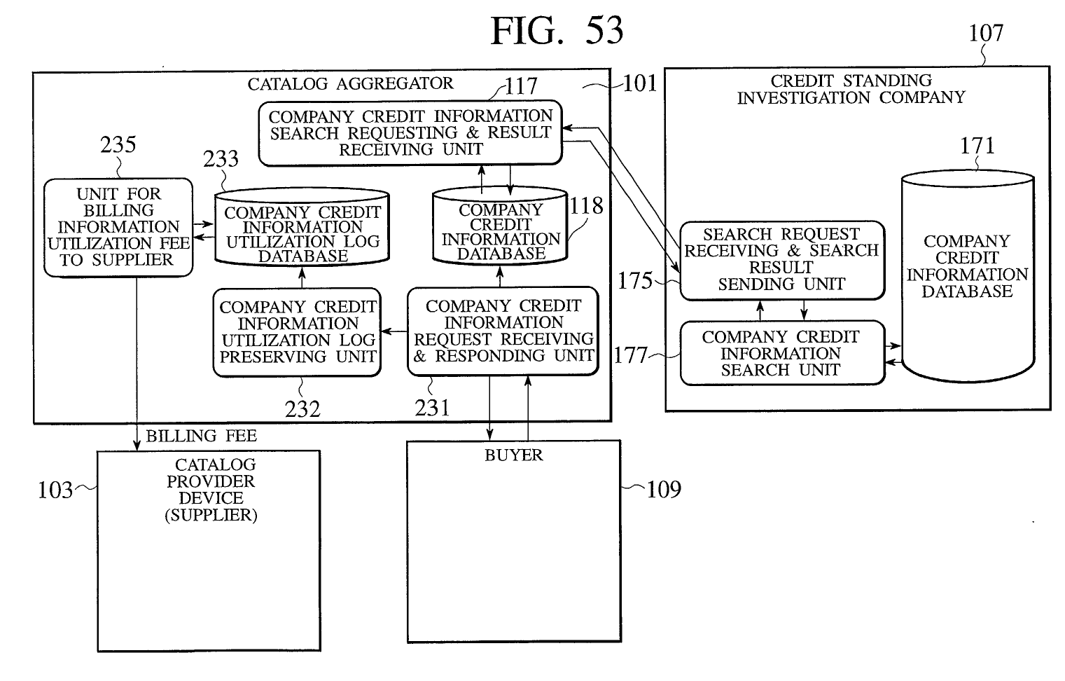

FIG. 53 shows a detailed configuration of the electronic catalog system of this embodiment. In this electronic catalog system of FIG. 53, the catalog aggregator 101 has, in addition to the company credit information search requesting and result receiving unit 117 and the company credit information database 118, a company credit information request receiving and responding unit 231 for receiving a request for the company credit information from the buyer 109 and responding to that request, a company credit information utilization log preserving unit 232 for preserving the company credit information utilization log, a company credit information utilization log database 233 for storing the company credit information utilization log, and a unit 235 for billing the information utilization fee to the the catalog provider which is the supplier. Also, the credit standing investigation company 107 has the company credit information database 171, the search request receiving and search result sending unit 175, and the company credit information search unit 177.

As described, according to the present invention, the company code of a product provider is attached to the catalog information, and when a product purchaser selects a product by viewing the catalog information, the company credit information of the product provider corresponding to the company code attached to the catalog information of the selected product is presented to the product purchaser so that, by viewing this company credit information, the product purchaser can avoid a risk of purchasing a product from a non-trustworthy supplier.

Also, according to the present invention, the company code of a product provider is attached to the catalog information, and when a product purchaser selects a product by viewing the catalog information and this selection is made by using a search condition containing the company credit information of the product provider, a product matching with the search condition is searched according to the company credit information of the product provider corresponding to the company code attached to the catalog information of the product, so that the product purchaser can eliminate products of non-trustworthy product providers from candidate purchasing products at a time of the product search and thereby avoid a risk of selecting products of non-trustworthy product providers, while also avoiding a tediousness associated with a product selection as the product providers are narrowed down by using the company credit information.

Also, according to the present invention, a product provider registers a condition regarding the credit information of a product purchaser, and this condition regarding the credit information of a product purchaser is compared with the company credit information of a product purchaser and the viewing of the catalog information is allowed only when the company credit information of the product purchaser satisfies the condition regarding the credit information of the product purchaser registered by the product provider, so that the product provider can prevent receiving an order from a non-trustworthy product purchaser.

Also, according to the present invention, the catalog aggregator attaches the company code of a product provider to the catalog information, acquires and stores the company credit information of the product provider corresponding to the company code, and returns the company credit information of the product provider corresponding to the company code to the catalog user device in response to a request for the company credit information from the catalog user device, so that it becomes unnecessary for the catalog user device to carry out a preparation of an interface with respect to the credit standing investigation company, a fee payment and a contract, it becomes unnecessary for the credit standing investigation company to manage a plurality of catalog user devices, and it becomes possible to collect fees collectively. In addition, it is also possible to share the fees for collecting information from the credit standing investigation company among a plurality of catalog user devices.

Also, according to the present invention, the company code of a product provider is attached to the catalog information and a product purchaser can view the company credit information of the product provider corresponding to the company code while viewing the catalog information, so that the product purchaser can avoid a risk of purchasing a product from a non-trustworthy product provider.

Also, according to the present invention, the catalog aggregator stores the company credit information and provides the stored company credit information in response to a request for the company credit information, so that it is possible to respond to the request for the company credit information quickly, and the company credit information utilization fees to be paid to the credit standing investigation company can be reduced.

Also, according to the present invention, the catalog aggregator acquires and stores the company credit information, reads out and provides the stored company credit information in response to a request for the company credit information, preserves a log of the company credit information request for each requestor, and bills the company credit information utilization fee to the requestor according to this log information, while paying the company credit information utilization fees to the credit standing investigation company, so that it is possible to provide the company credit information quickly in response to the request for the company credit information, the information utilization fee can be billed accurately according to the request log information of the requestor, and the fees for the utilized information can be paid collectively to the credit standing investigation company.

Also, according to the present invention, the company credit information acquisition log for a product purchaser is preserved and the utilization fee for the company credit information utilized by the product purchaser is billed to a product provider according to this log information, so that it is possible to bill the information utilization fee not only to the product purchaser who requested the company credit information but also to the product provider whose company credit information was requested by the product purchaser.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the catalog aggregator and the catalog user device of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An electronic catalog aggregation apparatus provided between catalog provider devices and catalog user devices in an electronic catalog system, the apparatus comprising:
a processing unit configured to process electronic catalog data received from registered catalog providers through networks into a prescribed common format;
an electronic catalog database configured to store the electronic catalog data as processed by the processing unit;
an extraction and conversion unit configured to extract at least one of the electronic catalog data corresponding to a catalog request received from each registered catalog user, from the electronic catalog database, and convert each extracted electronic catalog data into an electronic catalog in a format specified by the catalog request; and
a delivery unit configured to deliver electronic catalogs as extracted and converted by the extraction and conversion unit to respective registered catalog users through networks.

2. The electronic catalog aggregation apparatus of claim 1, further comprising:
a management unit configured to carry out an admission examination by judging whether an admission examination information contained in a prescribed admission request received from a catalog provider matches with a prescribed admission condition or not, register the catalog provider as an electronic catalog distribution source with respect to catalog users when the catalog provider is admitted by the admission examination, and manage charge data for each registered catalog provider according to a processing of electronic catalog data provided by each registered catalog provider at the processing unit.

3. The electronic catalog aggregation apparatus of claim 1, further comprising:
a management unit configured to carry out an admission examination by judging whether an admission examination information contained in a prescribed admission request received from a catalog user matches with a prescribed admission condition or not, register the catalog user as an electronic catalog distribution target with respect to the catalog providers when the catalog user is admitted by the admission examination, and manage charge data for each registered catalog user according to a conversion of electronic catalog data requested by each registered catalog user at the processing unit.

4. The electronic catalog aggregation apparatus of claim 1, further comprising:
a management unit configured to define and manage the prescribed common format for each product classification;
wherein the processing unit processes each electronic catalog data into the prescribed common format corresponding to a product classification of a product to which each electronic catalog data is directed, as defined and managed by the managment unit.

5. The electronic catalog aggregation apparatus of claim 1, further comprising:
a management unit configured to store and manage a catalog utilization format of each registered catalog user;
wherein the extraction and conversion unit converts each extracted electronic catalog data according to the catalog utilization format corresponding to a registered catalog user who made the catalog request, as stored and managed by the management unit.

6. The electronic catalog aggregation apparatus of claim 1, further comprising:
a data collecting and receiving unit configured to receive each electronic catalog data provided by a registered catalog provider, detect missing catalog data items in each received electronic catalog data, and collect the missing catalog data items from a contents provider other than the registered catalog provider.

7. The electronic catalog aggregation apparatus of claim 1, further comprising:
a company code attaching unit configured to attach to each electronic catalog data a company code of a product provider of a product to which each electronic catalog data is directed, such that the delivery unit delivers each electronic catalog with the company code attached thereon.

8. The electronic catalog aggregation apparatus of claim 7, further comprising:
a company credit information acquisition unit configured to acquire a company credit information of the product provider corresponding to the company code, and provide the company credit information to a catalog user in response to a request from the catalog user based on the company code attached to the electronic catalog provided to the catalog user.

9. The electronic catalog aggregation apparatus of claim 7, further comprising:
a company credit information providing unit configured to enable a product purchaser to view a company credit information of the product provider corresponding to the company code attached to the electronic catalog of a product selected by the product purchaser by viewing the electronic catalog.

10. The electronic catalog aggregation apparatus of claim 7, further comprising:
a product search unit configured to carry out a search of a product matching with a search condition indicating a company credit information of a desired product provider as specified by a product purchaser in order to select a product by viewing the electronic catalog, according to the company credit information of the product provider corresponding to the company code attached to the electronic catalog.

11. The electronic catalog aggregation apparatus of claim 1, further comprising:
a company credit information storage unit configured to acquire company credit information from a credit standing investigation company and store acquired company credit information; and
a company credit information providing unit configured to read out a company credit information of a requested company from the company credit information storage unit and provide the company credit information of the requested company in response to a company credit information request received at the electronic catalog aggregation apparatus.

12. The electronic catalog aggregation apparatus of claim 11, further comprising:
a log preserving unit configured to preserve a log of the company credit information request for each requestor; and
a billing unit configured to bill an information utilization fee to each requester according to the log of the company credit information request for each requester preserved by the log preserving unit.

13. The electronic catalog aggregation apparatus of claim 12, further comprising:
a payment unit configured to pay company credit information utilization fees to the credit standing investigation company.

14. The electronic catalog aggregation apparatus of claim 11, wherein the company credit information providing unit provides the company credit information of a product provider in response to the company credit information request from a product purchaser, and the electronic catalog aggregation apparatus further comprises:
a log preserving unit configured to preserve a log of the company credit information request for each product purchaser; and
a billing unit configured to bill an information utilization fee for the company credit information of the product provider that is utilized by each product purchaser to the product provider according to the log of the company credit information request for each requester preserved by the log preserving unit.

15. A method of electronic catalog aggregation between catalog provider devices and catalog user devices in an electronic catalog system, the method comprising the steps of:
processing electronic catalog data received from registered catalog providers through networks into a prescribed common format;
storing the electronic catalog data as processed by the processing step in an electronic catalog database;
extracting at least one of the electronic catalog data corresponding to a catalog request received from each registered catalog user, from the electronic catalog database, and converting each extracted electronic catalog data into an electronic catalog in a format specified by the catalog request; and
delivering electronic catalogs as extracted and converted by the extracting step to respective registered catalog users through networks.

16. A computer usable medium having computer readable program codes embodied therein for causing a computer to function as an electronic catalog aggregation apparatus provided between catalog provider devices and catalog user devices in an electronic catalog system, the computer readable program codes include:
a first computer readable program code for causing said computer to process electronic catalog data received from registered catalog providers through networks into a prescribed common format;
a second computer readable program code for causing said computer to store the electronic catalog data as processed by the first computer readable program code in an electronic catalog database;
a third computer readable program code for causing said computer to extract at least one of the electronic catalog data corresponding to a catalog request received from each registered catalog user, from the electronic catalog database, and convert each extracted electronic catalog data into an electronic catalog in a format specified by the catalog request; and
a fourth computer readable program code for causing said computer to deliver electronic catalogs as extracted and converted by the third computer readable program code to respective registered catalog users through networks.

17. A catalog user device in an electronic catalog system, the device comprising:
a catalog unit configured to store electronic catalogs with company codes of product providers attached thereto, and provide an electronic catalog to a product purchaser in response to a catalog viewing request from the product purchaser; and
a company credit information providing unit configured to enable the product purchaser to view a company credit information of a product provider corresponding to a company code attached to the electronic catalog of a product selected by the product purchaser by viewing the electronic catalog.

18. A catalog user device in an electronic catalog system, the device comprising:
a catalog unit configured to store electronic catalogs with company codes of product providers attached thereto, and provide an electronic catalog to a product purchaser in response to a catalog viewing request from the product purchaser; and
a product search unit configured to carry out a search of a product matching with a search condition indicating a company credit information of a desired product provider as specified by the product purchaser in order to select a product by viewing the electronic catalog, according to a company credit information of a product provider corresponding to a company code attached to the electronic catalog.

19. A catalog user device in an electronic catalog system, the device comprising:
a catalog unit configured to store electronic catalogs with company codes of product providers attached thereto, and provide an electronic catalog to a product purchaser in response to a catalog viewing request from the product purchaser;
a product purchaser condition registration unit configured to register a condition on credit information of a desired product purchaser as specified by a product provider in order to limit product purchasers who are permitted to view the electronic catalog provided by the product provider; and
a catalog viewing permission unit configured to permit viewing of the electronic catalog of the product provider by the product purchaser in response to a catalog viewing request from the product purchaser only when credit information of the product purchaser satisfies the condition on credit information of a desired product purchaser registered by the product purchaser condition registration unit.

20. A method for operating a catalog user device in an electronic catalog system, the method comprising the steps of:
storing electronic catalogs with company codes of product providers attached thereto, and providing an electronic catalog to a product purchaser in response to a catalog viewing request from the product purchaser; and
enabling the product purchaser to view a company credit information of a product provider corresponding to a company code attached to the electronic catalog of a product selected by the product purchaser by viewing the electronic catalog.

21. A method for operating a catalog user device in an electronic catalog system, the method comprising the steps of:
storing electronic catalogs with company codes of product providers attached thereto, and providing an electronic catalog to a product purchaser in response to a catalog viewing request from the product purchaser; and
carrying out a search of a product matching with a search condition indicating a company credit information of a desired product provider as specified by the product purchaser in order to select a product by viewing the electronic catalog, according to a company credit information of a product provider corresponding to a company code attached to the electronic catalog.

22. A method for operating a catalog user device in an electronic catalog system, the method comprising the steps of:
storing electronic catalogs with company codes of product providers attached thereto, and providing an electronic catalog to a product purchaser in response to a catalog viewing request from the product purchaser;
registering a condition on credit information of a desired product purchaser as specified by a product provider in order to limit product purchasers who are permitted to view the electronic catalog provided by the product provider; and
permitting viewing of the electronic catalog of the product provider by the product purchaser in response to a catalog viewing request from the product purchaser only when credit information of the product purchaser satisfies the condition on credit information of a desired product purchaser registered by the registering step.

23. A computer usable medium having computer readable program codes embodied therein for causing a computer to function as a catalog user device in an electronic catalog system, the computer readable program codes include:
a first computer readable program code for causing said computer to store electronic catalogs with company codes of product providers attached thereto, and provide an electronic catalog to a product purchaser in response to a catalog viewing request from the product purchaser; and
a second computer readable program code for causing said computer to enable the product purchaser to view a company credit information of a product provider corresponding to a company code attached to the electronic catalog of a product selected by the product purchaser by viewing the electronic catalog.

24. A computer usable medium having computer readable program codes embodied therein for causing a computer to function as a catalog user device in an electronic catalog system, the computer readable program codes include:
a first computer readable program code for causing said computer to store electronic catalogs with company codes of product providers attached thereto, and provide an electronic catalog to a product purchaser in response to a catalog viewing request from the product purchaser; and
a second computer readable program code for causing said computer to carry out a search of a product matching with a search condition indicating a company credit information of a desired product provider as specified by the product purchaser in order to select a product by viewing the electronic catalog, according to a company credit information of a product provider corresponding to a company code attached to the electronic catalog.

25. A computer usable medium having computer readable program codes embodied therein for causing a computer to function as a catalog user device in an electronic catalog system, the computer readable program codes include:
a first computer readable program code for causing said computer to store electronic catalogs with company codes of product providers attached thereto, and provide an electronic catalog to a product purchaser in response to a catalog viewing request from the product purchaser;
a second computer readable program code for causing said computer to register a condition on credit information of a desired product purchaser as specified by a product provider in order to limit product purchasers who are permitted to view the electronic catalog provided by the product provider; and
a third computer readable program code for causing said computer to permit viewing of the electronic catalog of the product provider by the product purchaser in response to a catalog viewing request from the product purchaser only when credit information of the product purchaser satisfies the condition on credit information of a desired product purchaser registered by the second computer readable program code.
